(19) United States
(12) Patent Application Publication
(10) Pub. No.: US 2014/0025573 A1
(43) Pub. Date: Jan. 23, 2014

(54) Distributed Electronic Commerce System, Method and Apparatus

(71) Applicant: Mobile Technology Holdings Limited, Douglas (IM)

(72) Inventors: Seppo Reino Keronen, New South Wales (AU); Michael Man Ho Mak, New South Wales (AU)

(73) Assignee: Mobile Technology Holdings Limited, Douglas (IM)

(21) Appl. No.: 13/955,044

(22) Filed: Jul. 31, 2013

Related U.S. Application Data
(63) Continuation of application No. 12/310,721, filed on Oct. 16, 2009, now abandoned.

(51) Int. Cl. G06Q 20/32

(52) U.S. Cl. CPC G06Q 20/322
USPC 705/41; 705/39

(57) ABSTRACT

A method for constructing electronic commerce services and conducting electronic commerce transactions is disclosed. The method is illustrated by instantiating and storing the electronic contract on a server; issuing and transmitting a token message to one or more contracting party's client device. Using a processor to intercept the token message and contact the server to retrieve the electronic contract associated with the token message; and downloading or uploading digital media as instructed by the electronic contract. The method is based on the uniform, highly expressive representation of electronic contracts as digital objects. A system based on a distributed object architecture that implements the method is also described. The architecture enables the execution of the promises encoded as part of an electronic contract to be executed on any device that implements an electronic contract interpreter mechanism.

### CROSS-REFERENCE TO RELATED APPLICATIONS

The present application is a continuation of U.S. Ser. No. 12/310,721, filed Mar. 5, 2009, which is the National Phase application of International Application No. PCT/AU2007/001307, filed Sep. 5, 2007, which designates the United States and was published in English and which claims the benefit of U.S. Provisional Application No. 60/842,356, filed Sep. 6, 2006, which is related to International Application PCT/AU2005/001799 entitled ELECTRONIC COMMERCE SYSTEM, METHOD AND APPARATUS, filed on Nov. 29, 2005 and published on Jun. 15, 2006 as WO 2006/060849, which claimed priority to Australian Provisional Application AU2004906982, filed on Dec. 7, 2004. Each of these applications are incorporated herein by reference in their entirety.

### BACKGROUND OF THE INVENTION

1. Field of the Invention

The present invention relates generally to an electronic commerce system, method, and apparatus. More specifically, the present invention relates to an electronic commerce system, method, and apparatus capable of servicing and/or providing a wide range of possible transactions.

2. Description of Related Art

Electronic commerce transactions that employ a mobile wireless communications device, for example a cellular telephone handset, are recognized as a commercially valuable opportunity for new services. Barcodes of various symbologies, encoded and transmitted as messages and displayed on the device screen, have been employed to represent electronic tokens. Such tokens have entitled the bearer to products and services of various types. Such token systems had limitations on there usefulness in a variety of contexts.

For example, these tokens were limited to providing a single service and were often limited to being used in environments where network coverage was acceptable. Additionally, many of the previous systems were not user friendly and could be cumbersome to use.

Further, prior systems were generally limited to very specific implementations. That is, systems were implemented for specific services and not capable of general mobile commerce.

E-commerce is currently at a very early stage of evolution and lacking many convenient, accepted patterns of practice and forms of expression. This lack of structures and platforms has inhibited the growth of electronic commerce, particularly when consumers are involved.

### SUMMARY OF THE INVENTION

The invention described in PCT/AU2005/001799 discloses an electronic token, called bToken, for use for mobile electronic transactions. The invention also teaches the construction of self-executing electronic contracts, called bContracts, underlying such transactions.

The present invention improves the previous inventions disclosed by teaching the construction of additional bContract representations, enabling additional services to be constructed. Such additional services include the composition of multiple services as a single service, the inclusion of embedded and external digital media and more efficient execution of bContracts.

The present invention discloses a distributed object method, which enables the execution of bContracts themselves on mobile handsets, scanning devices and any other device capable of interpreting a bContract language. The present invention provides for more efficient execution of electronic contracts, a better, more responsive user experience, the ability to execute electronic contracts on small devices even when network coverage is poor or absent and scalability and lower cost of the electronic commerce platform.

Accordingly, embodiments of the present invention disclose the construction of a novel electronic commerce system referred to herein as a distributed bPlatform. In embodiments, the platform may provide a ways to conduct electronic commerce transactions in a way that is convenient, natural and provides a rich consumer experience. The rich consumer experience includes the presentation, composition and capture of digital media, fast response to consumer input and changes in the local context of the experience. The platform may also provide a way to conduct more general mobile commerce and electronic commerce transactions in a more efficient manner and in a more convenient form than is currently possible.

Electronic commerce is based on contracts, agreements, and promises. The essential constituent of a contract is a promise by one party (promisor) to cause specified actions to be performed, generally for the benefit of another party (promisee). The bPlatform employs a digital encoding to express, and a mechanism to give effect to contracts, agreements, and promises. A bContract defines the aforementioned expression and mechanism.

In embodiments, the present invention enables the expression of electronic contracts that contain other electronic contracts (subcontracts) as parts. Such a mechanism, enabling the composition of electronic contracts, is required for the construction of bundled services consisting of a number of separately contracted parts. A bContract can express a list of explicit or implicit bContracts as being subcontracts or super-contracts. Other relationships between electronic contracts, such as the succession of one bContract by another may be useful and readily implemented using this method pattern.

In embodiments, the distributed bPlatform implements a bEngine component that may be incorporated as part of any computing device, such as a cellular mobile telephone, personal digital assistant (PDA) device, digital camera, music player or other consumer appliance. The bEngine is able to interpret a bContract locally on the embedding device. The bEngine enables bContract operations to be performed in the case of poor or absent network connectivity to server computers. The local execution of bContracts may provide a better user experience than remote execution. The ability to execute bContracts on client devices makes the scaling of the bPlatform to deal with large numbers of bContracts less costly.

In embodiments, the bEngine incorporates one or more digital security certificates and a digital signing mechanism that ensures that bContracts that are altered by unauthorized parties are detected as fakes by examining a digital signature generated by the bEngine.

In embodiments the bEngine provides a representation of the local context of execution of the bContract. The local context enables the bContract to respond to the geographic location, date and time, executing and nearby device characteristics, user identity and other contextual parameters and changes in those parameters. In embodiments this mechanism may be used to provide a different user experience prior to redeeming a ticket or voucher, compared to after redemption; A different user experience depending on the user's current location and so on. For example, digital media may be made available to the user at a specific location, such as a retail outlet for example.

In embodiments, the distributed bCode platform provides services such as cinema and event ticketing, retail vouchers and loyalty schemes, digital rights tokens and other services that are based on contractual abstractions and needing to provide a convenient rich user experience for consumers of the service.

In embodiments the distributed bCode platform provides a service that enables consumers to pre-purchase items of value, such as meals and drinks, and nominate one or more persons to receive tokens that entitle the bearer or specific person to the pre-purchased product or service.

Additionally, in embodiments the platform may provide a service that enables a consumer to challenge others to a bet, or other form of wager or challenge. The parties being challenged receive tokens that they may use to accept or reject the challenge and claim a prize in the case of the winner.

### BRIEF DESCRIPTION OF THE DRAWINGS

Additional objects, features, and advantages of the present invention will become apparent from the following detailed description of embodiments of the invention in conjunction with the accompanying drawings where like reference numerals indicate like features, in which:

FIG. 1 is an embodiment of the distributed bContract platform;

FIG. 2 is a bContract instantiation template and consumer interface in accordance with an embodiment of the present invention;

FIG. 3 is a flowchart illustrating the construction of a mobile cellular telephone incorporating the distributed bPlatform method in accordance with an embodiment of the present invention;

FIG. 4 is an electronic token scanner in accordance with the present invention;

FIG. 5 is a flowchart illustrating the construction of a distributed bContract engine (bEngine) in accordance with an embodiment of the present invention;

FIG. 6 is a summary outline of an expression of a bContract and execution context in accordance with an embodiment of the present invention;

FIG. 7 is an expression of a composite bContract in accordance with an embodiment of the present invention;

FIG. 8 is an expression of the parties and terms of a bContract in accordance with an embodiment of the present invention;

FIG. 9 is an expression of internal and external media in accordance with an embodiment of the present invention;

FIG. 10 is an expression of the execution context in accordance with an embodiment of the present invention;

FIG. 11 is an expression of device independent execution of a bContract in accordance with an embodiment of the present invention;

FIG. 12 is an expression of mobile device specific execution of a bContract in accordance with an embodiment of the present invention;

FIG. 13 is an expression of scanner device specific execution of a bContract in accordance with an embodiment of the present invention;

FIG. 14 is a bContract and associated bTokens in accordance with an embodiment of the present invention;

FIG. 15 is a bContract and associated bTokens in accordance with an embodiment of the present invention;

FIG. 16 is a bToken, a bCode and a bToken message in accordance with an embodiment of the present invention;

FIG. 17 is a flowchart illustrating the relationship between a bToken and other bPlatform components in accordance with the present invention;

FIG. 18 is a bContract Engine in accordance with an embodiment of the present invention;

FIG. 19 is a bContract Engine in accordance with an embodiment of the present invention;

FIG. 20 is an expression of a bContract in accordance with an embodiment of the present invention;

FIG. 21 illustrates request and reply protocol units that may be employed for a bContract Service Interface in accordance with an embodiment of the present invention;

FIG. 22 is a bContract in accordance with an embodiment of the present invention;

FIG. 23 is a bContract in accordance with an embodiment of the present invention;

FIG. 24 is a meta-bContract in accordance with an embodiment of the present invention;

FIG. 25 is a bWallet Engine in accordance with an embodiment of the present invention;

FIG. 26 is a bClient Engine in accordance with an embodiment of the present invention;

FIG. 27 is a bWallet interface in accordance with an embodiment of the present invention;

FIG. 28 is a bScanner Apparatus, bScanner Engine and bToken presentation protocol in accordance with an embodiment of the present invention;

FIG. 29 is a bPlatform configuration in accordance with an embodiment of the present invention;

FIG. 30 is a bPlatform configuration in accordance with an embodiment of the present invention;

FIG. 31 is a bPlatform configuration in accordance with an embodiment of the present invention;

FIG. 32 is a bPlatform configuration in accordance with an embodiment of the present invention;

FIG. 33 is an exemplary game system in accordance with an embodiment of the present invention;

FIG. 34 is a bMarket system in accordance with an embodiment of the present invention;

FIG. 35 is a bMarket system in accordance with an embodiment of the present invention;

FIG. 36 is a conventional commerce system;

FIG. 37 is a conventional commerce system;

FIG. 38 is a bMarket system in accordance with an embodiment of the present invention;

FIG. 39 is a bMarket system in accordance with an embodiment of the present invention;

FIG. 40 is an exemplary movie ticketing system in accordance with an embodiment of the present invention;

FIG. 41 is an exemplary transit system in accordance with an embodiment of the present invention;

FIG. 42 is an exemplary derivatives contract system in accordance with an embodiment of the present invention;

FIG. 43 is an exemplary bWallet system in accordance with an embodiment of the present invention;

FIG. 44 is an exemplary bWallet system in accordance with an embodiment of the present invention;

FIG. 45 is a bMarket system in accordance with an embodiment of the present invention; and

FIG. 46 is an exemplary method of a personal keyword dictionary and matching process in accordance with an embodiment to the present invention.

### DETAILED DESCRIPTION OF EMBODIMENTS

Generally, commercial transactions are based on contracts, agreements, and/or promises that govern the execution of future actions. The present invention relates to a bContract, its constituent parts, its execution, and other additional parts, which make up a novel mechanism that may, in embodiments, be analogous to the conceptualization of a contract. In general, a bContract is a powerful expression of a contract in a number of ways described in PCT/AU2005/001799 (and below).

For example, a bContract may be configured to govern the execution of future actions, and may also contain an executable specification of actions. The expression that specifies actions is referred to herein as a bFunction. The actions specified by a bFunction may be logical operations executed by digital computers, communication operations, and/or physical actions executed by digitally controlled mechanisms. A bFunction, in certain embodiments, may specify constraints on the order in which the operations that constitute an action are performed. Additionally, a bFunction may, in certain embodiments, have the expressive power to specify conditional (contingent) actions. Examples of conditions, or contingencies, that can be expressed include conditions on time and location, observable state and relationships of physical objects, state of the bContract or other information bearing structure, and/or knowledge (or lack of knowledge) of information. Of course, the above listings are only examples of some of the expressive powers of the bFunction.

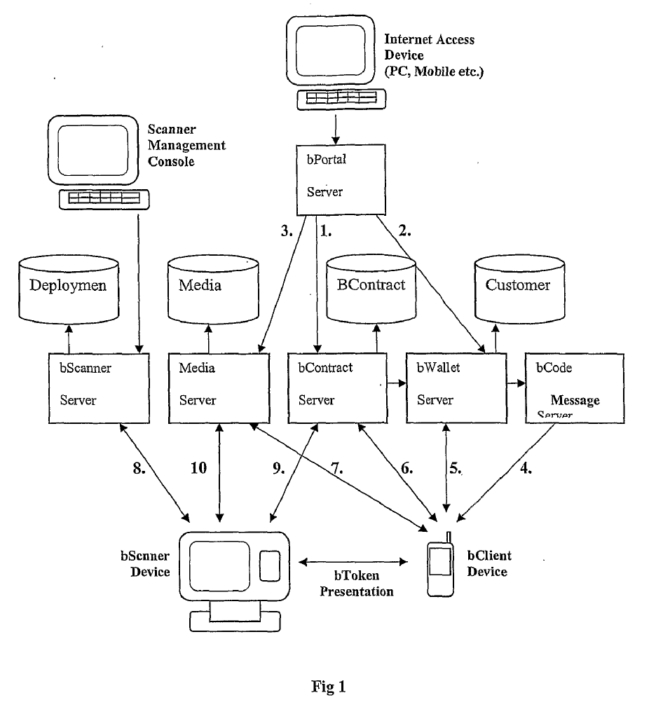

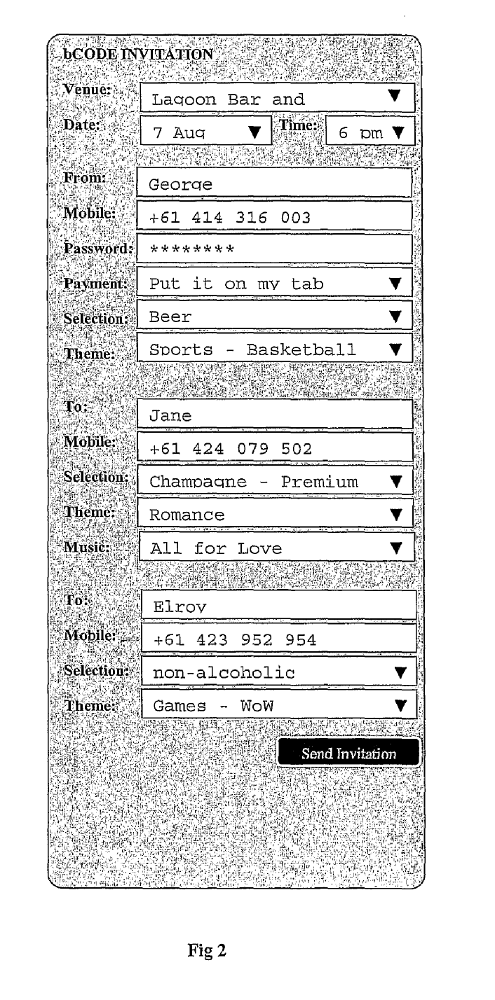

FIG. 1 illustrates a distributed bContract platform in accordance with an embodiment of the present invention. The consumer of bContract services employs an internet access device, such as a personal computer, mobile smart-phone, personal digital assistant (PDA) device and so on, to discover and accept a bContract offered by another party, such as a service provider, agent or other consumer or group. FIG. 2 illustrates the form of such an acceptance and instantiation of the terms of a bContract.

As shown in FIG. 1, the consumer interaction may be implemented by an Internet bPortal server. A bPortal is the component that provides a consumer initial access to a service based on bContracts and bTokens. As an example, a bPortal server may simply be a message gateway server, such as an SMS gateway, that accepts and parses a message from a consumer, and responds by sending a bToken or error message to the consumer. Alternatively a bPortal server may employ Internet portal technologies, such as world-wide-web or mobile WAP to implement the business logic and user interaction required to locate and instantiate a bContract. Alternatively the Internet access device may implement a bEngine, such as illustrated in FIG. 5, to instantiate and execute elements of a bContract. In this case one or more meta-level-bContacts may govern and effect the construction and instantiation of the object-level-bContract, as described in PCT/AU2005/001799 (and below).

For example, a bContract that constitutes an offer by an “offerer” party to an anonymous “offeree” party. The offer contract encapsulates the partially instantiated contract being offered “offered-contract” as one of its terms. Such partially instantiated contracts may be referred to as bContract templates. These templates are instantiated by meta-level bFunctions.

The offeree may accept the offer by invoking the “accept” meta-level bFunction. This function creates the new contract instance. The system may be constructed to explicitly or implicitly save such new contracts in the bContracts database. In this embodiment an array called “contracts” is used to hold such contracts to be stored.

The “accept” function also calls on the bToken allocate, associate and issue functions to create a new bToken for the customer. These functions may be coalesced into a single function call, but as discussed above, may also be separate for didactic purposes.

The above meta-contract mechanism provides the means to express a range of instruments including, but not limited to: Offers to Sell—Partially instantiated contracts representing goods, services for sale, with a meta-contract function that instantiates the offer; Offers to Buy—Partially instantiated contracts representing requests-for-quotations (RFQs), requests-for-proposals (RFPs) and other offers and expressions of interest to acquire goods or services. In this case meta-contract functions may be provided for sellers to respond to the offer; and Derivatives—Any bContract, terms of the bContract permitting, may be manipulated by meta-contract functions to alter the terms of the contract, divide the contract, compose multiple contracts into one and similar operations.

Once the bContract is instantiated it may be stored persistently on a bContract server as illustrated in FIG. 1.1. User identification and billing information may be collected and stored on a bWallet server, as illustrated in FIG. 1.2. Media, such as text, audio, images and video may be requested and supplied by the user and uploaded and stored on a media server, as illustrated in FIG. 1.3.

Once a bContract is instantiated, a bToken may be issued to one or more of the contract parties. The relationship of bCodes to the bContract is illustrated in FIG. 8(a). The bCode may be encoded in the form of a bToken and communicated to the party concerned via a cellular short message, instant message, electronic-mail or other communication means to a bClient device. FIG. 1.4 illustrates the transmission of a bToken message to a bClient, in this case a cellular mobile telephone of a consumer, in the form of a short message. Alternatively the bClient may periodically contact a bWallet server to discover when new bCodes have been issued. Alternatively the bCode may be encoded in the form of a barcode of any symbology, RFD) token or other digital token representation.

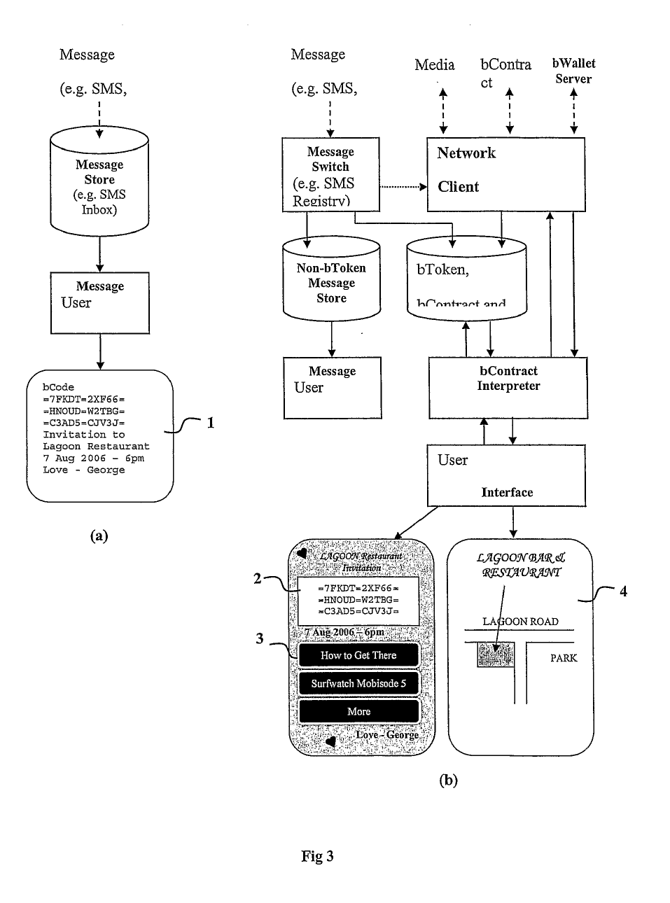

The device (bClient) receiving the abovementioned bCode message may incorporate a distributed bPlatform engine (bEngine). FIG. 3 illustrates such bClient device, in this case a cellular mobile telephone, incorporating a bEngine. The bEngine structure is illustrated in FIG. 5.

Once the bClient has received the aforementioned bToken message, the bEngine intercepts the message, and may contact a bContract server, as shown in FIG. 1.6, to retrieve all or part of the bContract associated with the bToken. The bClient may subsequently download or upload digital media, as referenced or instructed by the bContract, from a media server, as illustrated in FIG. 1.7.

The user of the bClient may invoke the bToken and associated bContract operations by operating the user interface of the bClient device. In response the bContract engine may execute bContract operations, such as providing further information about the contract, requesting postponement, cancellation, transfer or other operations provided for by the bContract. A further example of execution is the presentation of digital media or other digital service, as instructed by the bContract. FIG. 3 provides an illustration of such operations, where the bContract renders a representation of the bToken 2 and a set of user interface button widgets, such as 3, that may be operated by the user to access a service, such as the digital map 4.

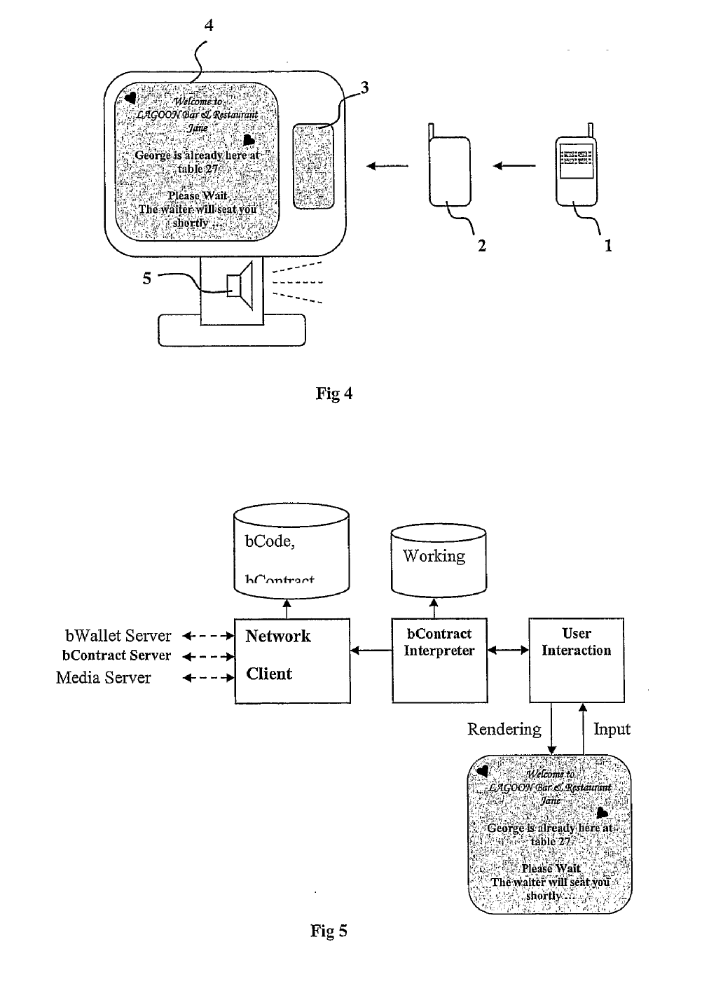

The user of the bClient may present the bToken to a bScanner device. An embodiment of a bScanner device apparatus and the presentation of a bToken is illustrated in FIG. 4.

A bScanner device may be managed by a bScanner server, as shown in FIG. 1.8. The bScanner server may provision the bScanner device with software updates, types of bContracts that the bScanner will service, field maintenance diagnostic and other such operational parameters and programs.

A bScanner may incorporate a bEngine for the purpose of interpreting bContracts. A bScanner device may download all or part of a bContract, prior or subsequent to the presentation of a bToken associated with the bContract. The bScanner may execute operations of the bContract in response to the scan of a bToken or in response to other user interaction, such as touch screen manipulation of user interface widgets, or timed events. Alternatively the bScanner may request the bContract server to execute bContract operations.

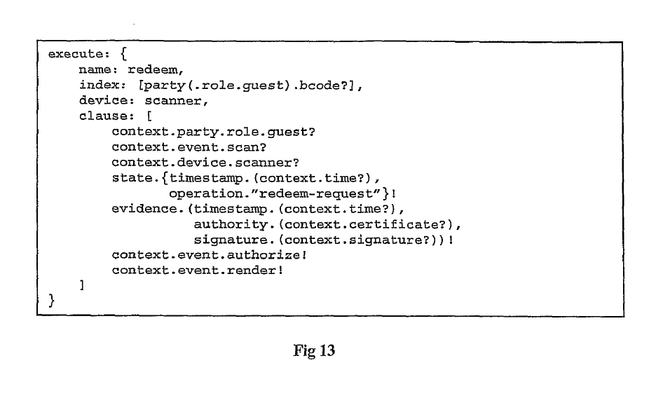

The bScanner may download or upload digital media or other resources from a media server, as referenced or instructed by a bContract. In response to a bToken scan or other operation, the bContract may instruct the presentation or capture of audio, visual or other media for the user. A bContract may instruct the bScanner to contact the user's bClient device to download or upload media to that device. In the illustration of FIG. 3, the bScanner presents a graphical theme associated with a “guest” party to a bContract and renders digital music favoured by that party. FIG. 13 illustrates how such operations may be represented as part of a bContract. The bContract is interpreted by the bContract Interpreter component of the bScanner.

FIG. 2 illustrates the form of the bContract instantiation process. The consumer has chosen a service to be instantiated as a bContract. For illustration purposes the consumer has chosen to invite friends for social drinks and meal at a bar and restaurant establishment. Other services that may be expressed as bContracts include, but are not limited to, ticket purchases, promotional vouchers, club memberships, digital media download rights, bets and wagers, as well as any other service that involves contractual and contract-like expression.

FIG. 2 illustrates a world-wide-web form interface for bContract instantiation. The consumer has made selections and entered text to instantiate the parties and terms of the bContract. Additionally, instantiation may involve the consumer uploading media, such as audio, images or digital video, that will be associated with the bContracted service and referred to and rendered or otherwise operated on by the bEngine interpreting the bContract.

For comparison, FIG. 3(a) illustrates a simple form of a cellular mobile telephone handset that is used to receive a bToken short message for presentation to a bScanner. The encoding of a bCode as a bToken, bToken message and subsequent processing is taught in the previous disclosure PCT/AU2005/001799 (and below).

FIG. 3(b) illustrates the extended component structure and control/data flow when the device of FIG. 3(a) is augmented in accordance with the distributed bPlatform method. The bToken message received is routed into a bToken cache instead of the generic message store of the device.

Subsequently the network client component in FIG. 3(b) contacts a bContract server to retrieve all or part of the bContract associated with the bCode that the bToken decodes to. The network client component may also pre-fetch digital media or other resources that the bContract refers to, and store these resources in local cache memory. This practice improves the user experience of the consumer when interacting with the service by eliminating media download latency and unavailability in areas where wireless network coverage is poor or unavailable.

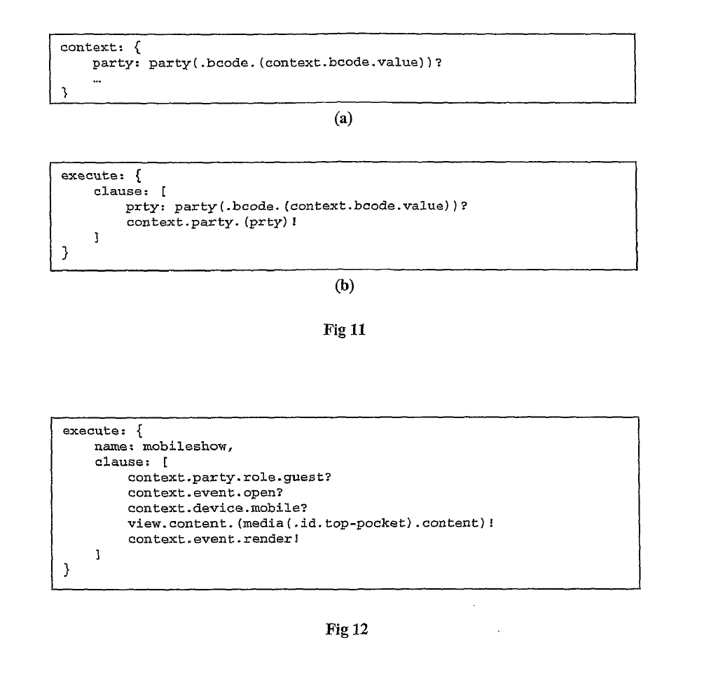

A consumer may subsequently invoke the bContract by selecting it from a menu of available bContracts. One possible selection interface is illustrated in the previous disclosure PCT/AU2005/001799 (and below). In response to being selected an “open” event may be generated. A bContract interpreter component responds to this event by executing bContract instructions guarded by the “open” event. FIG. 12 illustrates the form of such guard and instructions incorporated as part of a bContract.

The execution of the bContract may result in the display of information about the bContracted service, a rendering of the bToken, rendering of digital media, user interface widgets providing access to associated media and services. In the example illustrated in FIG. 3, a digital map service is shown and a digital video episode (mobisode) may be played in response to a user selection.

An advantage of the present system is that the bToken may be rendered in a form, FIG. 3(b).2 that is readily recognized by a bCode scanner. The standard message rendering FIG. 3(a).1 may be difficult to recognize due to font selection, background images or other features of the standard message user interface. Alternatively the bToken may be rendered as a barcode of any symbology or as an audio or radio transmission or any other form of digital token presentation.

Another advantage of the present method is that the consumer may have access to valuable associated services and media. In this example, the consumer has access to a mapping service that directs her to the location where the bContracted service is being provided. The mapping service is invoked in response to the consumer selecting the “How to Get There?” user interface widget. The mapping service may itself be implemented as bContract operations or as an external service.

FIG. 4 illustrates a bScanner apparatus, constructed according to an embodiment of the present invention. The bScanner incorporates graphical and audio rendering means, as well as a bToken scanning means. Additionally the bScanner may incorporate long or short range wireline or wireless data communications means for interchanging data with network computers or local devices, such as the mobile device presenting a token. Additionally the bScanner may incorporate a printer, CD/DVD writer or other rendering means for rendering text or other content on physical media.

In this case illustrated in FIG. 4, a bToken is rendered on the screen of a mobile telephone device 1. The mobile telephone screen is oriented for reading by the scanner camera 2. The mobile telephone is positioned for scanning. The operation of the bToken scanning means and another physical form of the apparatus is specified in PCT/AU2005/001799 (and below).

A successful scan occurs when the bToken is recognized and successfully decoded into a bCode. The result in a “scan” event, which invokes the bContract associated with the scanned bCode. The scan event results in the execution of any bContract operations that have been guarded by a “scan” event occurring on a scanner device. FIG. 13 illustrates such guarding and other contextual conditions and associated bContract instructions.

As an example, FIG. 4 illustrates a visual display and audio rendering that are instructed by the bContract. Additionally, the bContract may instruct the scanner to display user interaction widgets, render audio/visual media, operate mechanical devices and so on. The bContract may also instruct the scanner to connect with the scanned device via a wireless connection in order to download or upload media or perform other operations with that device. The scanned device may retain a reference to the scanner, and subsequently communicate with the scanner to achieve such data transfers or other operations. As an example, a bScanner may provide a digital music or video item to a scanned mobile telephone device via a short range wireless Bluetooth connection. The downloadable media item or other service may provide an incentive for a consumer to visit a retail location hosting the bScanner as an example.

FIG. 5 shows a component and control flow diagram of a distributed bContract engine (bEngine). A bEngine implements the method of the present invention. A bEngine may be incorporated as a part of consumer mobile bClient device, bCode scanner, bContract appliance or other device that may form part of the distributed bContract platform.

The bContract Engine, in embodiments of the present invention, may be a processing component that executes bFunctions that form part of a bContract. This execution mechanism may, for example, consist of physical sensors and computer hardware to execute conditional tests, computer hardware as memory to execute logical operations, communications hardware to execute communications operations and physical effectors to execute physical operations.

The main components and structure of a bContract Engine in accordance with an embodiment may include the following exemplary components: a persistent store containing a collection of bContracts and optionally an index that facilitates fast retrieval of the bContract associated with a given bToken; a bFunction execution mechanism (bInterpreter), which performs the evaluation and execution of bFunction conditions and actions; a bContract Service Interface, which enables an external entity to call for the execution of a bContract.

Additionally, the bContract Engine Interfaces may be implemented using a number of techniques, including procedure calls, web service protocols, asynchronous messaging and so on. Calls on bContracts may be issued by a remote procedure call (RPC) mechanism or received as an asynchronous message (MSG), and bToken issue/revoke may be implemented by an RPC mechanism, for example.

FIG. 3, described above, illustrated the integration of a bEngine as part of a mobile telephone bClient device. In a similar way the bEngine may be integrated as part of the scanner illustrated in FIG. 4, or as part of any other form of token scanner device.

A bEngine contains a network client component, which communicates with a bContract server to download and upload bContracts from that server. The bContract server may be constructed as a distributed service consisting of any number of servers hosting a large number of bContracts in an efficient manner. The bContract server may be implemented as a reliable distributed object store.

Reliable execution of bContracts requires that multiple devices do not execute bContract operations simultaneously in a manner that would allow unintended behaviour or lead the bContract to an inconsistent state. The required reliability may be implemented using transactions to enforce mutual exclusion to the entire bContract or to critical regions of the bContract. Offline execution of bContracts may be implemented by providing bEngines with execution permits (capabilities) that expire unless renewed. A person skilled in the art of distributed systems may apply other alternative methods to ensure safety and synchrony.

A bEngine may contain a cache component that locally stores bCodes, bContracts and associated media and other resources. The cache component is typically required to provide efficient execution in the face of limited network communications bandwidth, high communications latency and high communications cost.

A bContract interpreter forms part of a bEngine. PCT/AU2005/001799, teaches the construction of a bContract interpreter. A bContract interpreter reads and executes the language used to express bContracts. The bContract language is preferably a simple scripting language or simple logic based language with declarative semantics. Examples of such languages are ECMAScript, Python, Prolog, OPS-5/Clips and so on. The present disclosure employs a simple declarative query/assertion language.

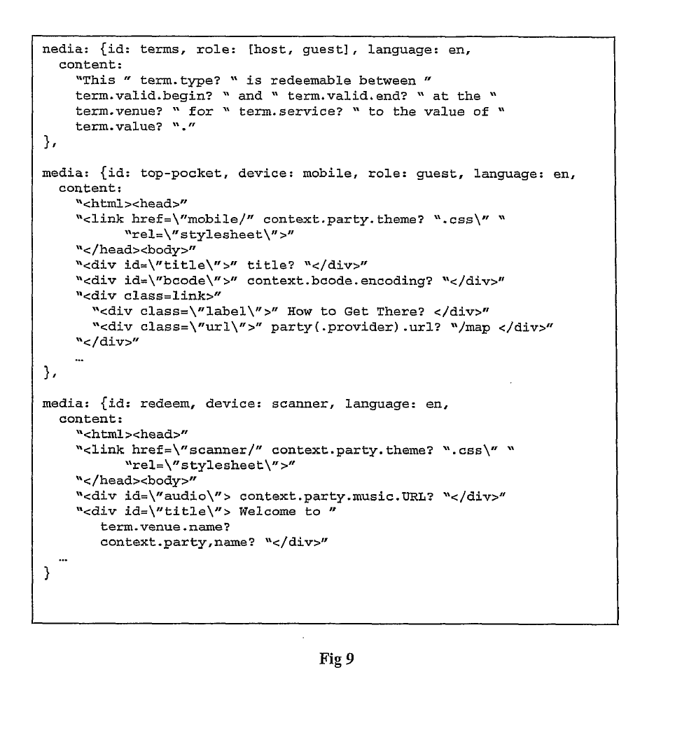

A bEngine may contain a user interface component that gives effect to the audio/visual rendering and interaction by the user of the device. As an example, FIG. 5 illustrates a simple screen rendering effected by this component. The rendering is of an HTML document generated by the bContract interpreter in response to a bToken scan event. FIG. 9 illustrates how such example HTML media may be generated as part of a bContract. A bEngine may contain other components that give effect to instructions generated by the bContract interpreter.

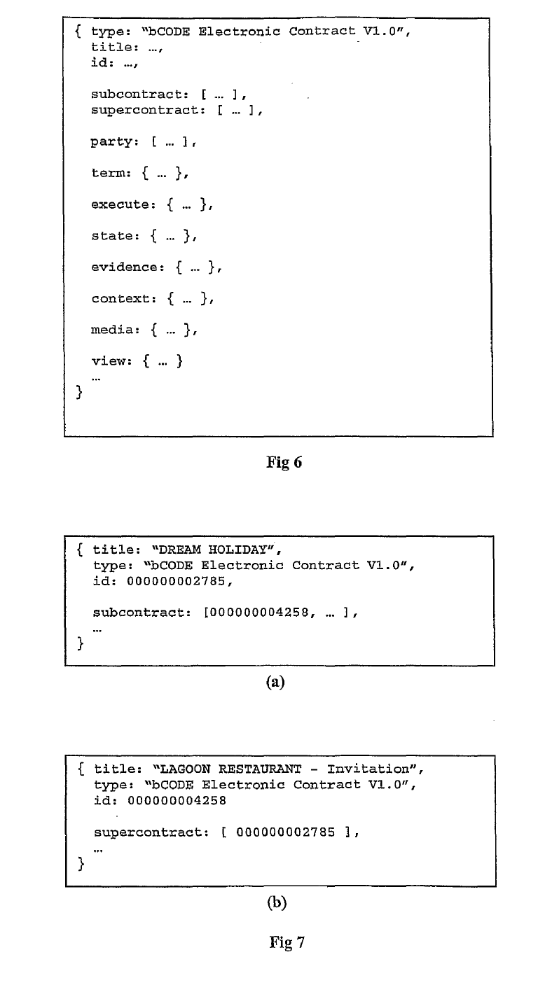

FIG. 6 shows an outline of a bContract and its execution environment when it is actively being interpreted within a bEngine. The structure consists of the bContract elements and execution context elements. The illustrated embodiment also includes media and view elements used to implement user interaction and digital media operations.

Note that FIG. 6 and subsequent figures illustrating bContract and context elements employs a slightly modified Javascript Object Notation (JSON) to express the hierarchical structure of elements and collection of elements into ordered lists, denoted by square brackets “[” and “]”, and key value paired collections, denoted by braces “{” and “}”. Quotation is not used to delimit strings, unless the string contains white space or other special characters. XML or other data structure or programming language notations may readily be employed as alternative notations. Internal representations of these structures are readily implemented as document-object-model (DOM) trees, object hierarchies, relational tables or other representations by a person skilled in the art.

As shown in FIG. 6, a bContract may include a header identifying the structure as a bContract and providing system version information. The bContract may be identified by a universally-unique-identifier (id) for ease of reference. Alternatively a service provider bCode or other identifier may be used.

An advantage of the representation illustrated in FIG. 6 is that all information required to interpret and give effect to the bContract is available as a single independent object structure. The bContract may be transferred from one device to another for inspection and execution, enabling the implementation of a scalable platform consisting of large numbers of bContracts and devices that execute bContracts.

The structure includes an execution context, which enables the execution path to depend on time, geographic location, executing device, present parties and other information about the context in which execution is occurring. This method enables the construction of context aware services.

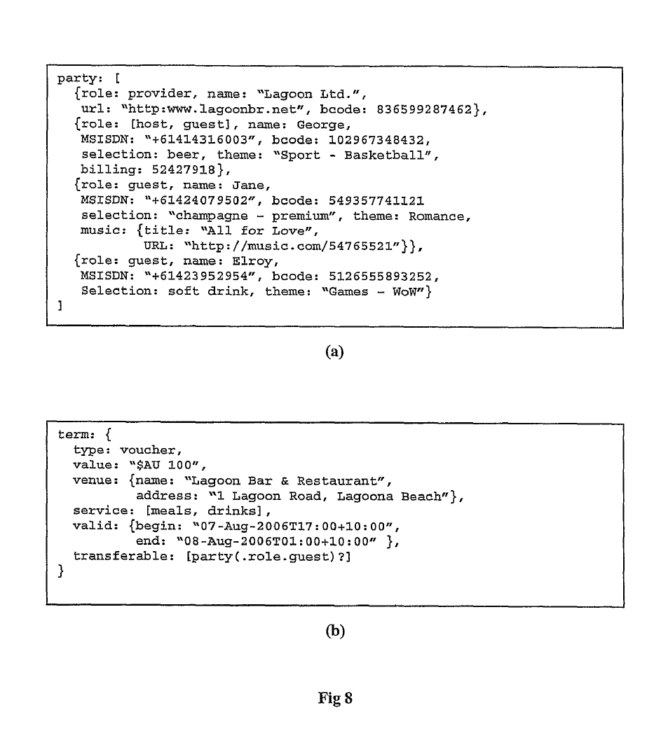

FIGS. 7(a) and (b) illustrates a mechanism used to construct composite bContracts. In this case a service provider has promised to provide a “Dream Holiday” to a consumer. A “Lagoon Restaurant Invitation” forms part of the “Dream Holiday”. Using the illustrated subcontract/supercontract mechanism a hierarchy of bContrats may be constructed. The user interface to the bContract may provide a convenient means to view and operate on such composite contracts. The manner in which the bContract itself may generate the interfaces is described below.

FIG. 8(a) illustrates how information about the parties to a bContract and the unique identifiers (bCodes) may be represented. In this case the representation includes selected service parameters that apply individually to each of the parties. More generally, service parameters and references to external resources, such as digital media, may be represented and associated with parties in other parts of the bContract, such as the media section described below for instance.

Note that the service provider is also issued a bCode in order to enable the service provider to execute elements of the bContract. In this case the service provider may scan this bCode to confirm that a redemption of the promise encoded by the bContract has been delivered. Additionally the bContract may include operations enabling the service provider to change terms, provide refunds and other operations agreed to by the parties and encoded as executable by the service provider.

FIG. 8(b) illustrates a representation of the terms of the bContract. As illustrated, the information items represented here may be analogous to the terms of a contract as written in a natural language, such as English.

The terms, and other items, of a bContract are not limited to explicitly nominated data. The final clause in FIG. 8(b) states that the bContract is transferable from one guest party to another. We employ a shorthand query language to form this expression: In this case the “7” indicates a query analogous to an SQL “select” statement. The parentheses indicate a predicate on that selection, analogous to an SQL “where” clause. We employ this simple notation in an effort to make bContract expressions simpler. A person skilled in software engineering can readily implement alternative query and computational expressions and a bContract interpreter or compiler to give effect to those expressions.

FIG. 9 illustrates the construction of user interface and user interaction elements of a bContract. The first media item consists of generic text explaining the terms of the bContract in natural language text, being English in this example. The second media item is an HTML interface for a mobile device. The third item is an HTML interface for a bCode scanner device. Note that the construction of interfaces and media may be governed by stylesheets and other transformations, as well as conditional operations triggered by the context of the bContract.

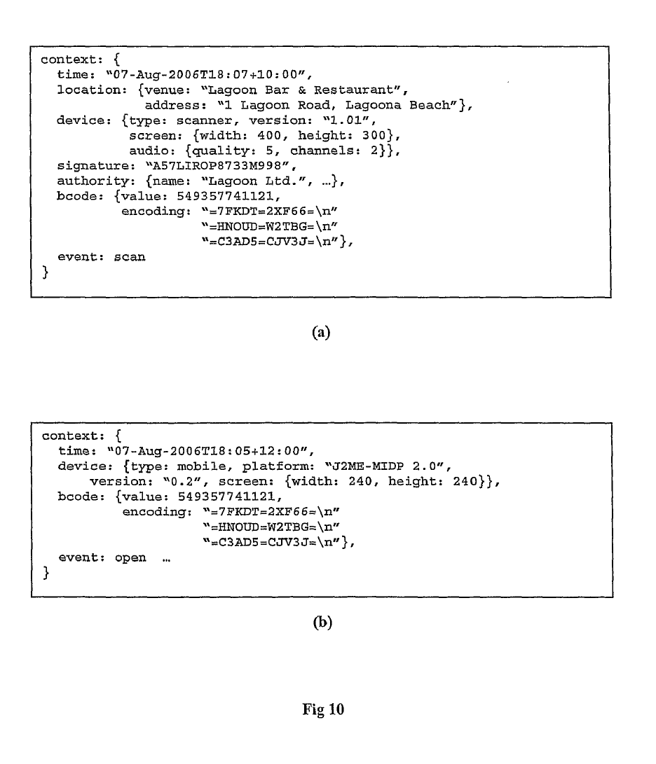

FIGS. 10(a) and (b) illustrate the representation of an execution context for a bContract. For 10(a) the execution context is a bScanner device that has just experienced a scan event of a specific bToken. For 10(b) the context is a cellular mobile phone, where the user possessing the nominated bToken has just selected to open the bContract for viewing.

FIGS. 11 to 13 illustrate the representation of, constraints and instructions that constitute execution steps of the bContract. In PCT/AU2005/001799, these execution constraints and instructions were referred to as bFunctions. For the purposes of the present disclosure we simply represent these elements of a bContract as clauses of execute sections of the bContract.

FIG. 11(b) illustrates the use of an execute clause to assert a value for the party of the current execute context. This party is the party whose bCode appears in the current execute context. Note that the exclamation mark “!” denotes an assertion, analogous to an SQL update clause. This same effect can be stated more directly, as shown in FIG. 11(a), as part of the context representation itself. A person skilled in the art may use SQL, Prolog, Clips or other query/assertion language in a similar way.

FIG. 12 illustrates how an execution clause responds to the situation where a user opens up a bContract on a mobile device. The clause is guarded by queries specifying conditions on the current context, followed by an assertion that sets up HTML media for rendering in the current view. In this case the HTML is further transformed by a stylesheet to generate the leftmost display in FIG. 3(b).

FIG. 13 illustrates how an execution clause specifies a response to a token scan event on a bScanner device. In this case a voucher redemption is initiated, the operation is recorded as part of the state of the contract and the change is digitally signed. Note that this example also includes an index element declaring the bCodes that the execute clause responds to. The index declaration may be used by the bPlatform to look up the execute clause efficiently.

Some of the discussion of PCT/AU2005/001799 is detailed below.

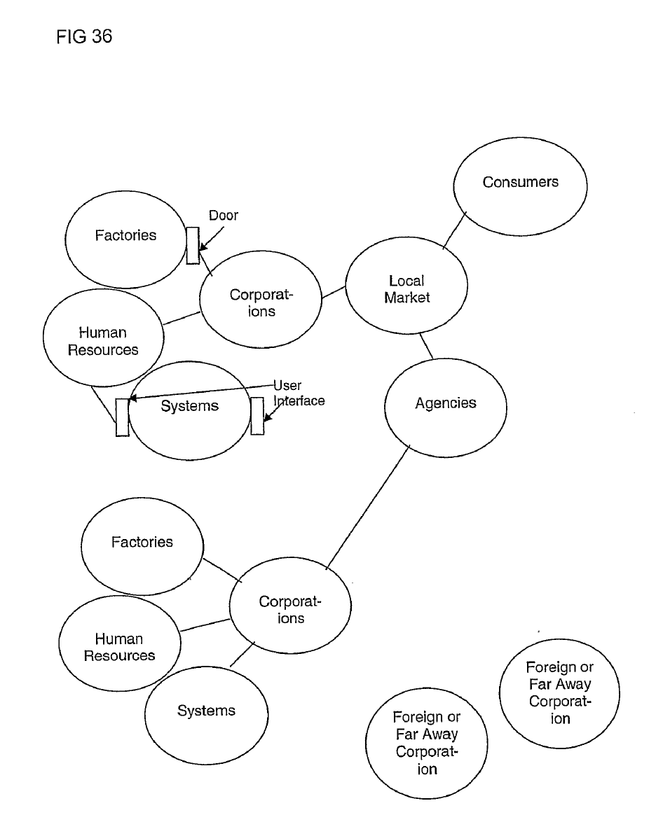

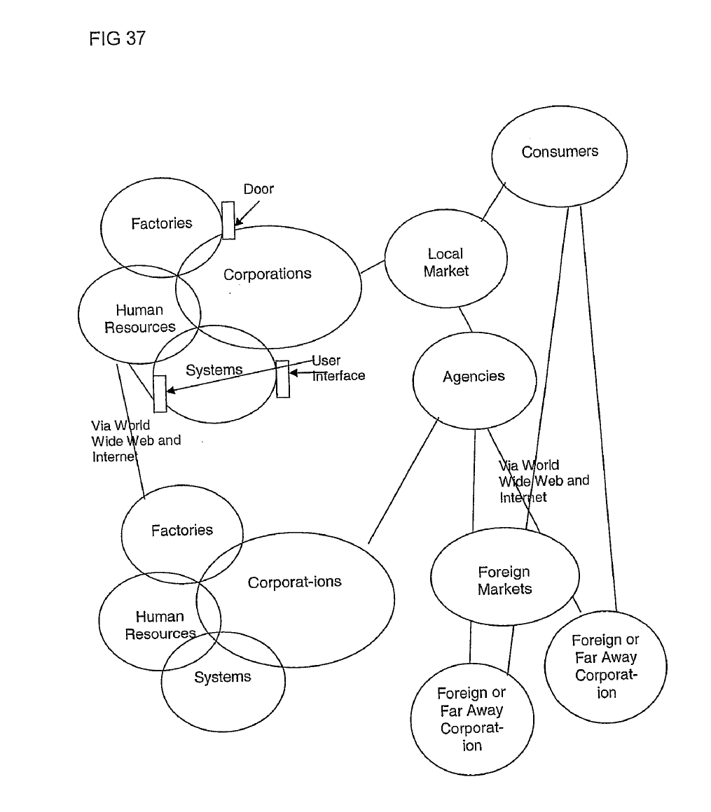

Commerce is normally conceptualized and regulated in terms of contracts, agreements, promises and the like. A contract generally consists of a set of promises and an agreement by the parties to the contract to perform (i.e., fulfill) the aforementioned promises. Traditionally, commercial contracts are often implied by conventional and legislated patterns of practice. Promises and contracts are expressed in forms of words, which may be recorded as text on paper or other suitable physical media. Because these traditional non-digital commerce methods have been limited by manual processes involved in trade such as paper contracts and face-to-face presence and encounters required to perform trade some of the limitations include: static paper contracts that are time-costly and money-costly to instantiate, negotiate, execute, alter, perform and police; static invocation using physical artifacts such as paper tickets, receipts, documents and cards (e.g. magnetic stripe, barcode, smart-cards) which requires physical presence by humans and machines to perform trade, or part processes to a trade; manual processing of transactions; and manual and/or external performances to contracts; common human languages (e.g. English) that's hard to decipher, alter and understand, often imprecise and hard to automate using machines. As a result, markets are very fragmented (as illustrated in FIGS. 36 and 37), and there is a lack of reach, common protocol, and interoperability and Marketability of economic units.

The availability of low cost computing devices and communications networks is enabling electronic commerce. The term electronic commerce (e-commerce) denotes forms of commercial practice involving transactions assisted by or carried out by computers communicating across networks. More recently, e-commerce has become an increasingly popular way to carry out commercial transactions between business entities (B2B e-commerce). In e-commerce practice, promises and contracts are expressed as text, which is encoded in digital form, stored in computer files, and transmitted in electronic data interchange formats based on encoding technologies such as XML.

More recently, the availability of low cost mobile computing devices and wireless communications networks is extending the reach of e-commerce so that transactions involving computation and network communications can take place anywhere and at any time. The term mobile electronic commerce (m-commerce) is generally used to refer to commercial practices involving such transactions.

One aspect of an m-commerce transaction is that it can take place at a time and in a location and within a context that is related to the transaction. The term mobile electronic commerce in context (x-commerce) refers to commercial practices involving such transactions in context. An x-commerce transaction can involve a mix of remote network, local electronic, and local physical interactions between computing devices and parties to the transaction. X-commerce transactions can provide a convenient, natural and rich experience for consumers, and therefore extend the reach of electronic commerce beyond business-to-business (B2B), into business-to-consumer (B2C) and consumer-to-consumer (C2C) commerce.

All forms of e-commerce are currently at a very early stage of evolution and lacking many convenient, accepted patterns of practice and forms of expression. This lack of structures and platforms has inhibited the growth of electronic commerce, particularly when consumers are involved (e.g., B2C and C2C).

Accordingly, embodiments of the present invention disclose the construction of a novel electronic commerce system referred to herein as a bPlatform. In certain embodiments, the platform may provide a ways to conduct x-commerce transactions in a way that is convenient, natural and provides a rich consumer experience. The platform may also provide a way to conduct more general m-commerce and e-commerce transactions in a more efficient manner and in a more convenient form than is currently possible.

As discussed above, e-commerce is based on contracts, agreements, and promises. The essential constituent of a contract is a promise by one party (promisor) to cause specified actions to be performed, generally for the benefit of another party (promisee). The bPlatform employs a novel digital encoding to express, and a mechanism to give effect to contracts, agreements, and promises. A bContract defines the aforementioned expression and mechanism.

The disclosed bContract mechanism is a powerful new primitive for e-commerce. In certain embodiments, the disclosed bPlatform implements and employs the bContract method to provide a number of advantages and opportunities that are not provided by other known electronic commerce methods. In certain embodiments, some of these advantages may include, but are not limited to: (1) construction of a rich range of electronic promises, including: fixed, variable and contingent promises; unilateral promises, such as electronic offers, RFPs and RFQs; multilateral promises involving N parties in various roles; (2) composition of promises to form bundled offers, contracts and other composites and the inverse decomposition of these composites to enable a rich, highly efficient marketplace to develop electronic promises and their derivatives; (3) providing a mechanism to formalize conventional and commonly useful patterns of practice as contract templates, and to instantiate the templates as effective promises, contracts and other derivatives; (4) mechanisms for the parties to the contract to conveniently and securely call on promised actions anywhere and at any time employing an electronic device that provides the necessary computational and communications devices; (5) ways for the parties to the contract to conveniently conduct actions of a promise as a mobile commerce transaction in context (x-commerce); and (6) providing controlled visibility and auditing of the electronic contract and its lifecycle from creation to termination.

In an embodiment of the present invention, an electronic commerce (bCommerce) method is provided that includes publishing a sell-side or buy-side offer for a product or service (bTemplate); receiving, by a user, the published offer and conditionally accepting the offer, forwarding the conditional acceptance to a matching processor (bMarket) to request the product or service; receiving the conditional acceptance by the matching processor; determining, by the matching processor, whether conditions present in the conditional acceptance can be fulfilled; forwarding, by the matching processor, at least one option for acceptance; displaying the at least one option for selection to a user, selecting, by the user, one of the at least one options; and providing a token (broken) to the user. Additionally, in certain embodiments, the token is configured to be used to call for execution of the promised actions of the offer, such as redeem the service or product, be transferable to another user device, or to be stored for future redemption of the product or service.

Additionally, in certain embodiments, the offer may be for movie tickets and the conditional acceptance is conditioned on at least one of the movie, the time of the movie, the price of the ticket, the location of the showing of the movie, or the number of movie tickets available; or the offer may be for a transportation ticket and the conditional acceptance is conditioned on at least one of the destination, the time of departure/arrival, the price of the ticket, or the number of tickets available. Additionally, the token may be stored in one of a user device or a remote storage device that can be accessed by the user device for redemption or transfer, and the redemption of the token causes additional offers to be published to the user; one or more tokens can be used to redeem one or more products or services. In further embodiments, redemption of a token is accomplished by presenting the token to an electronic scanner or electronically transmitting the token to a receiver.

In other embodiments, the token represents the ability to redeem or transfer at least one of: an entertainment event ticket, a transportation ticket, a key, a raffle/lottery ticket, a license, a membership, a personal identifier, monetary value, a voucher, a loyalty card, a medical prescription, a transaction receipt, login credentials, a url/uri, a digital right, a piece of digital media, a business card, a queuing token, a bill, or a non-disclosure or other agreement to refrain and/or the token may be designed for use in mobile devices.

Further, in certain embodiments, the token may be human readable, machine readable, or OCRable and may be configured for multi-mode presentation including at least one of OCR, barcode, or NFC.

Additionally, the token may be transferable using a store and forward messaging protocol including SMS, MMS, and/or e-mail or a synchronous protocol including HTTP or WAP.

In still a further embodiment, an electronic commerce system, is provided that includes a user device for requesting a product or service with predetermined terms, the user device being configured to forward the request to a matching processor; the matching processor being configured to receive the request from the user device, determine whether the predetermined terms can be fulfilled, and forwarding at least one option for acceptance to the user device; and a display device associated with the user device for displaying the at least one option for selection, wherein when one of the at least one options is selected, the user device is provided with a token. The token may be configured to be used to redeem the service or product, be transferable to another user device, or to be stored for future redemption of the product or service and, in some embodiments, the request may be made from one of a template provided to the user device or as a free text input that can be parsed by the matching processor.

In still further embodiments of the invention, an electronic commerce method may include forwarding at least one offer for acceptance to a user device based on a request from a user, and providing a token to the user based on the user's selection of one of the at least one offers. The token may represent the ability to redeem a product or service, transfer the redeemability of the at least one product or service to another user, may be stored in one of the user device or a remote storage device that can be accessed by the user device for redemption or transfer, and can be combined to redeem one or more products or services; and redemption of a token may be accomplished by presenting the token to an electronic scanner, or electronically transmitting the token to a receiver.

In still further embodiments of the invention, an electronic commerce method may include forwarding at least one offer for acceptance to a user device based on a request from a user, and providing a token to the user based on the user's selection of one of the at least one offers. The token may represent the ability to redeem a product or service, transfer the redeemability of the at least one product or service to another user, may be stored in a remote storage device that is configured to store a plurality of a the user's tokens in a manner such that the user can access the tokens from the user device and select a token for redemption or transfer, and redemption of a token may be accomplished by presenting the token to an electronic scanner, or electronically transmitting the token to a receiver.

In still further embodiments of the invention a matching system may include a receiver for receiving a request from goods or services from a user, wherein the request includes an identification of the goods or services and user defined terms associated with the request for the goods or services; a parser for parsing the request to determine the requested goods or services and the associated terms; a processor for comparing the parsed request to information in a database to match the parsed request with actual goods or services that are available; and a transmitter for forwarding at least one match to the request to the user for acceptance. The user may select one of the at least one matches, the matching system provides the user with a token that is configured to be used to redeem the service or product, be transferable to another user device, or to be stored for future redemption of the product or service.

Generally, commercial transactions are based on contracts, agreements, and/or promises that govern the execution of future actions. The present invention relates to a bContract, its constituent parts, and other additional parts which make up a novel mechanism that may, in certain embodiments, be analogous to the conceptualization of a contract. In general, a bContract is a new more powerful expression of a contract in a number of ways.

For example, a bContract may be configured to govern the execution of future actions, and may also contain an executable specification of actions. The expression that specifies actions is referred to herein as a bFunction. The actions specified by a bFunction may be logical operations executed by digital computers, communication operations, and/or physical actions executed by digitally controlled mechanisms. A bFunction, in certain embodiments, may specify constraints on the order in which the operations that constitute an action are performed. Additionally, a bFunction may, in certain embodiments, have the expressive power to specify conditional (contingent) actions. Examples of conditions, or contingencies, that can be expressed include conditions on time and location, observable state and relationships of physical objects, state of the bContract or other information bearing structure, and/or knowledge (or lack of knowledge) of information. Of course, the above listings are only examples of some of the expressive powers of the bFunction.

A bPlatform provides a mechanism to evaluate the conditions described above and execute the actions specified by the bFunction(s). The evaluation/execution mechanism is referred to herein as a bInterpreter.

In certain embodiments, the bContract may provide at least one of the parties to the contract a digital token that enables parties to the contract to call on those specific actions of the contract that the respective party is entitled to. These tokens are referred to herein as a bToken. Further, bContracts are self contained digital entities with persistent states.

The above terms will be further described and defined below with respect to various embodiments to provide a person with ordinary skill in the art a better understanding of the present invention.

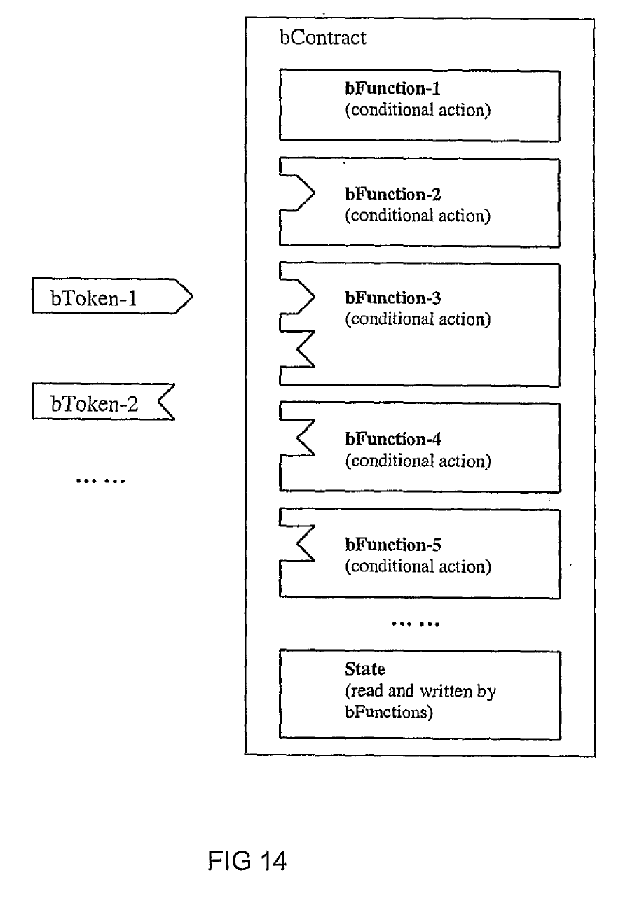

FIG. 14 illustrates the bContract mechanism in accordance with embodiments of the present invention. In the embodiment illustrated in FIG. 14, the bContract consists of 5 individual bFunctions and mutable state information shared by these functions. More generally, any part of a bContract that may be modified by the execution of a bFunction is considered a part of a mutable state. For example, one bFunction may be modified by another bFunction. The state information represents the modifiable portion of the bFunction. In the embodiment of FIG. 14, the state information is stored as a distinct component for simplicity and explanatory purposes. It should be readily understood that other methods for storing state information can be adapted without deviating from the general objectives of the present invention.

The embodiment in FIG. 14 also illustrates two bTokens. BToken-1 is required to invoke bFunction-2 and bFunction-3. BToken-2 is required to invoke bFunction-3, bFunction-4, and bFunction-5. bFunction-1 does not require the presence of a bToken as a condition of its execution. In other words, bfunction-1 is an autonomous bFunction that executes when the conditions that it specifies are satisfied.

More generally, a bContract contains one or more bFunctions, and is associated with zero or more bTokens. Each bToken maps to one or more bFunctions within the bContract.

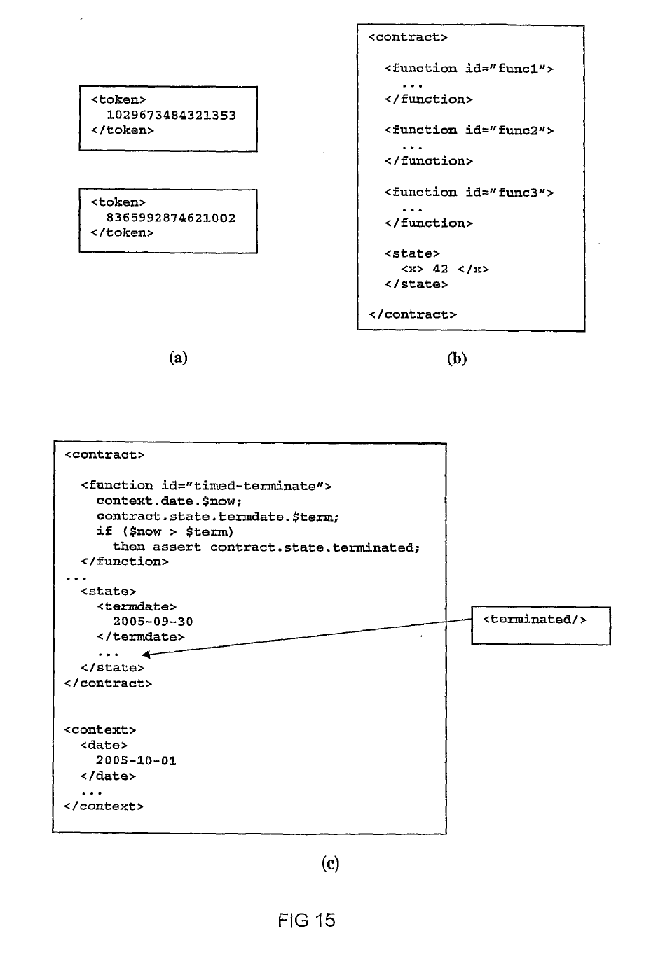

In certain embodiments, extensible mark-up language (XML) syntax may be employed to represent the state of bTokens, bContracts, bFunctions and other information bearing entities. In FIGS. 15A-2C, for example, a bContract element is marked up using a <contract> tag. For example, as illustrated, the bContract contains the value “42” for element x, which forms part of the state of the contract. As an exemplary convention for tagging, lower case alphanumeric characters are employed and the leading “b” from terms such as “bToken”, “bContract” and the rest of the b-terminology employed in this disclosure are dropped. Of course, any conventional tagging method may be employed.

While XML is used here to express structured state information, a person of ordinary skill in the art may readily employ other representations, such as relational database records, object oriented programming models, semantic networks and so on. XML syntax is convenient to express structured state information, but it can be difficult to read when used to express conditions or constraints to be evaluated and operations to be executed. Instead of XML, therefore, simple scripting style language within the XML to express conditional actions (bFunctions) may be embedded, as illustrated in FIG. 15C for example.

For clarity, some purely technical details are omitted from the exemplary scripts. For example, explicit <![CDATA[ . . . ]]> constructs, which would normally be required to ensure correct parsing of XML meta characters such as “<” and “&” are omitted from embodiments. Additionally, logical operators, such as “<” (less) and “>” (greater) can recognize and respect the semantics of lexical ordering of strings and temporal ordering of dates and times, as well as numeric values. A person skilled in the art should be able to readily infer these and other technicalities.

Scripts generally employ dot notation to denote XML structures, as used in ECMAScript for XML (E4X) for example. Each statement of a script is a logical expression. For example, in the case that the logical expression evaluates true, the following statement is executed or in the case that it evaluates false, the processing of the bFunction terminates; etc. Short circuit evaluation of logical operators, may also be assumed. Control constructs, such as if . . . then . . . else . . . conditionals, are assumed to have conventional meanings.

bToken

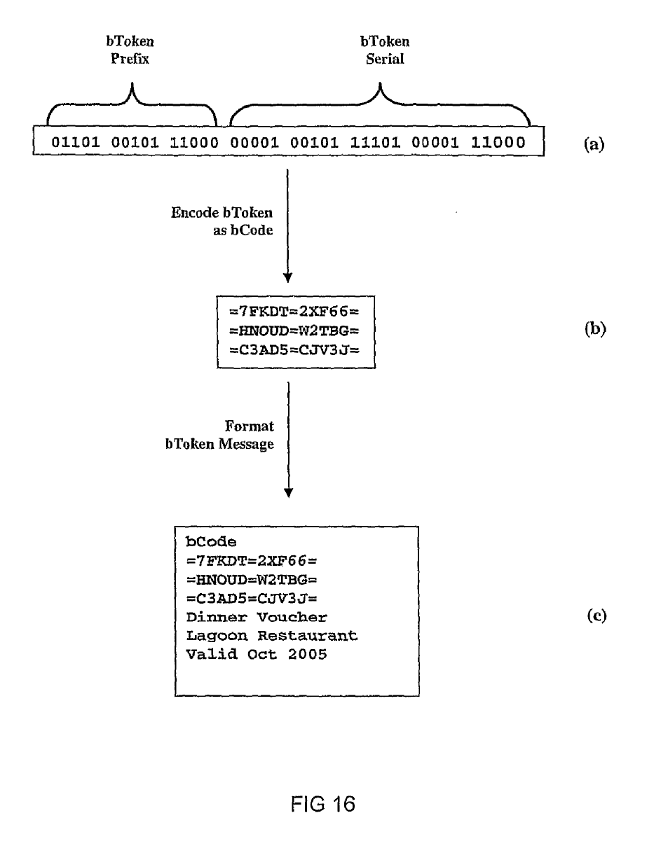

In certain embodiments, a bToken may be a sequence of binary digits. The aforementioned sequence may, in certain embodiments, be at least 40 binary digits long (in other embodiments, the sequence may be as long or as short as desired, e.g., 10-20, 30-60, 60-100 bits long), as illustrated in FIG. 16A. In this case the space of distinct bTokens consists of 2 to the power of 40 unique values. An individual bToken is allocated from the space of available values by way of an allocation method. As an example, allocation may simply yield successive bTokens starting from 0 and incrementing by 1, with wrap-around back to 0 on overflow. In other embodiments, however, the bToken may be structured into two sub-sequences of bits—a prefix field and a serial field. FIG. 16A illustrates a 15-bit prefix and a 25-bit serial. The prefix field may be of fixed or variable length. The prefix field can be employed as a prefix mask for various bToken operations. For example, a bToken interrogator (bScanner) device may request a client device to present a bToken with a prefix that matches a prefix nominated by the interrogator. The given prefix may be associated with a specific administrative domain for example. In this case, the client may not be required to expose bTokens of other administrative domains to the interrogator which may, in certain embodiments, lead to efficiency and privacy benefits.

As illustrated in the example of FIG. 15A, a <token> tag and a decimal number representation of bTokens in subsequent discussion that employs XML notation may be employed. This exemplary notation emphasizes an important feature of a bToken, namely that it bears a distinct value relative to other bTokens that may be in use at a given time. The following paragraphs present a construction that satisfies this, along with additional exemplary properties of bTokens.

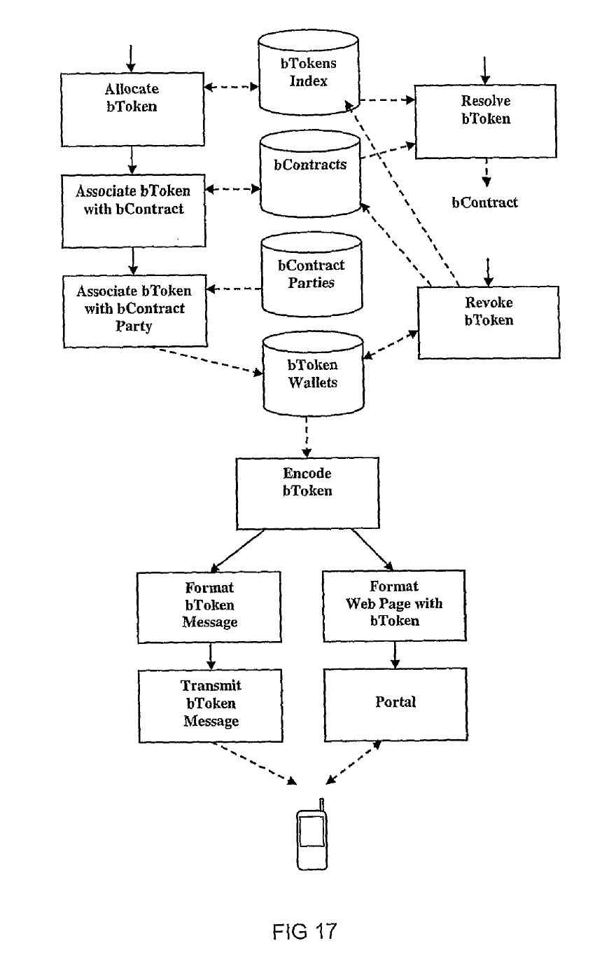

Flowchart-like notation is used herein to describe architectural and procedural aspects of the system. In FIG. 17, for example, rectangles denote information processing components, cylinders denote persistent information (databases), solid arrows denote control flow or invocation of the processing component located at the head of the arrow by the element located at its tail, dotted arrows denote major data flows along the arrow, and dashed arrows indicate that a remote communication link is typically employed to implement the control or data flow.

FIG. 17 illustrates the processing steps and information relationships between bTokens and the other main bPlatform components. As shown, the allocation process (e.g., Allocate bToken) maintains a persistent record of allocated bToken values (e.g., bTokens Index). An allocation may employ a random number generator to allocate a new bToken from the space of available values to reduce the likelihood of successful counterfeiting of a bToken. A random allocation process should, in certain embodiments, avoid the generation of bTokens that are duplicates of already allocated values as revealed by lookup of the bTokens index. In the case that the generated random number corresponds to an already active bToken, allocation may generate a new candidate number by calling the random number generator again or calling a deterministic procedure to find an unallocated number.

In the case that bTokens are allocated in a sequential or otherwise determinable manner, then bTokens may be encrypted to hide this predictable structure. The bToken may, in certain embodiments, by encrypted before it is transmitted, and decrypted before it is resolved.

A bToken refers (e.g., maps and/or identifies) to one or more objects by means of an association/resolution method pair. The association method records which object(s) a bToken identifies. Subsequently given a bToken, resolution returns a resolvent consisting of the previously associated object(s), or an error indication if no current association exists.

For the purpose of the present embodiment, a bToken maps to a bContract and to a specific party to that bContract. FIG. 17 indicates the association process as consisting of two steps, where the bContract is updated to indicate the new bToken value and where the bToken is stored in the bWallet of the associated party. Many alternative methods, including relational database records, for example, may be used to effect such associations. In certain embodiments, bToken association and resolution method pair may be designed to interpret a bToken as an index number or hash code, used to select a bContract from directly addressable or content addressable memory. This and other methods for efficient one-to-one mapping should be readily known to a person of ordinary skill in the art. In certain embodiments, a bToken may be structured to contain a subsequence of bits, which may identify one of several bToken resolvers. Generally, such distributed bToken resolution would consist of a number of bToken resolvers that may be located on separate server computers. Alternatively, in certain embodiments, a bToken may be structured to contain one or more sub-sequences of bits interpreted as meta-data about the bContract identified by the bToken. As an example, the bToken may contain a sequence that identifies the resolved bContract as a transit ticket and another subsequence that identifies the transit authority providing the transport service. Alternatively, in certain embodiments, a bToken may be structured to contain one or more subsequences of bits interpreted to specify geographic, temporal or other constraints on the validity of the bContract. These constraints may simply reflect the bFunction conditions expressed as part of the bContract itself. Such “up-front” conditions may be processed quickly and locally, thereby improving system performance as perceived by end-users.

bCode

Once a bToken has been allocated and associated with a bContract and party to the bContract, the bToken is made available to that party. The bToken may be encoded (e.g., encode bToken step in FIG. 17) in a number of alternative formats for presentation to the end-user. Examples of bToken presentation formats may include, but are not limited to: an N-CODE format as disclosed in patent application PCT/AU2005/000276, incorporated herein by reference in its entirety; a sequence of decimal digits, a barcode or other graphical format, as employed for universal product codes (UPC codes) and its many 1 dimensional, 2-dimensional and other variants; a sequence of audio tones, such as the DTMF tones employed in the telecommunications industry, or as audio watermarks embedded (disguised) in audio content for example; and an RFID or other radio transmission format, such as Bluetooth or NFC (contactless smart cards), for example. Additionally, in certain embodiments, combinations of these formats may be utilized.

As discussed above, the bToken may be encoded in the N-CODE format. This format is referred to herein as the bCode format and bTokens encoded in this format as bCodes. This encoding is illustrated in FIG. 16B. In this embodiment, Reed Solomon coding is applied to the eight 5-bit symbols of the bToken and three 5-bit symbols of a standard CRC checksum to produce a 150-bit redundancy coded bit sequence. The resulting 150 bits are grouped into 30 5-bit symbols expressed using a selection of 32 distinct uppercase alphanumeric characters. The 30 characters, in this embodiment, are divided into 3 lines for display on small screens where “=” symbols are used, in this embodiment, to frame and group the code for simpler extraction by a bScanner image processing algorithm. Alternative methods of redundancy coding, character/symbol representation and framing of the bCode may be employed. As an example, just a single character, such as a “/”; separated by varying number of space characters could be used to represent the encoded bits of the bCode.

Subsequent to encoding the bToken into a bCode or other format, the bCode may be embedded into a message, such as an SMS short message, e-mail message, instant message or other such messaging form for transmission to an end-customer. The formatting of the bCode as a short message is illustrated in FIG. 16C. Alternatively the bCode or other encoding, may be embedded as part of a world-wide-web page, Internet service, printed media, TV broadcast, MP3 music file header or other media distribution. The bToken may be explicitly represented as part of a media stream or embedded as a digital watermark.

As an example, a typical bToken message may consists of: a header line including the text “bCode”; a bToken encoded as a bCode or other encoding; descriptive information about the associated bContract; descriptive information about the actions and conditions of the bContract; instructions to the end-user related to the use of the bToken; and optionally other media to be used to display the bToken message or associated with the service.

A person skilled in the art may readily construct other bToken and message formats and useful functionality, such as bToken deletion/retirement/revocation and re-transmission/re-issuing for example.

In certain embodiments, the allocation, association, issuing, resolution and retirement processes maintain a comprehensive database of information about allocated bTokens. Examples of such information include, but are not limited to, the date and time of these events.

bFunction

FIG. 15B illustrates a simple bContract form with embedded bFunctions. In this embodiment the three bFunctions are identified as “func1”, “func2” and “func3”.

A bContract may contain one or more bFunctions. At one extreme, implementations may choose to express all the various algorithmic elements of a bContract as a single bFunction. At the other extreme, an implementation may choose to employ a set of constraint expressions or conditional action rules, in which case each of these expressions or rules could be considered to be a small bFunction.

In certain embodiments, the algorithmic aspect of a bContract may be expressed as a small set of reasonably independent bFunctions. bFunctions consist of conditions to be evaluated and actions to be executed contingent on the value of the evaluated conditions. Other programming language may also be employed to express bFunctions. In certain embodiments, the chosen language may have a compact textual representation, and is easy for humans to read. A scripting language, such as X4E or the style of language illustrated in FIG. 15C may have the advantage of a compact textual representation and readability. Event-condition-action (ECA) rule systems and other production systems, provide another exemplary language for expressing and evaluating bFunctions. In certain embodiments, the chosen language may be able to deal with XML structures as a native data type. XML may be a preferred representation for long-term storage and communication of bContracts across networks.

As an example, FIG. 15C illustrates two top-level XML elements: a contract element, representing a bContract, and a context element. The bContract contains an autonomous bFunction identified as “timed-terminate”. The first expression of the bFunction is:

context.date.$now.

The value of this expression is true, and a side effect of evaluating the expression may be to bind a variable $now to the value of the date element of the context top level element, i.e. “2005-10-01”. The expression would evaluate to false in the case that no date element existed in a context element. In this embodiment, the evaluation of the “terminate-offer” function would terminate. Optionally such unexpected termination of functions may be used to generate an exception, which can be supplied by any conventional technique.

The remaining expression of interest is: assert contract.state.terminated. The evaluation of this expression adds a <terminated!> element to the state of the bContract, as illustrated by the arrow in FIG. 15C with the intention being that the other bFunctions of this contract may subsequently use a simple contract.state.terminated expression to sense that the contract period has expired, and hence behave appropriately in case there is a call to perform promises that no longer apply.

bContract Engine

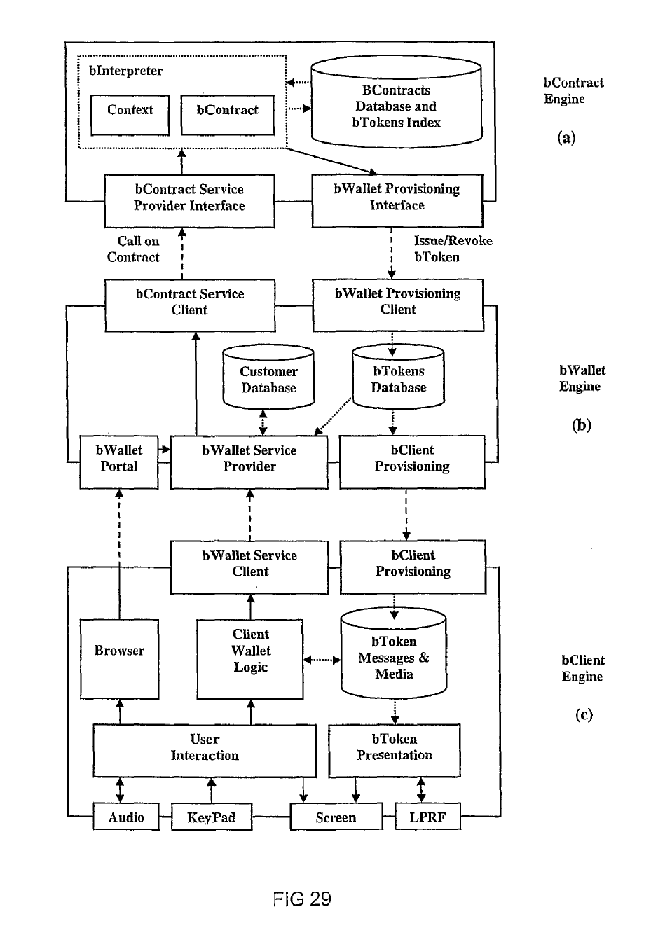

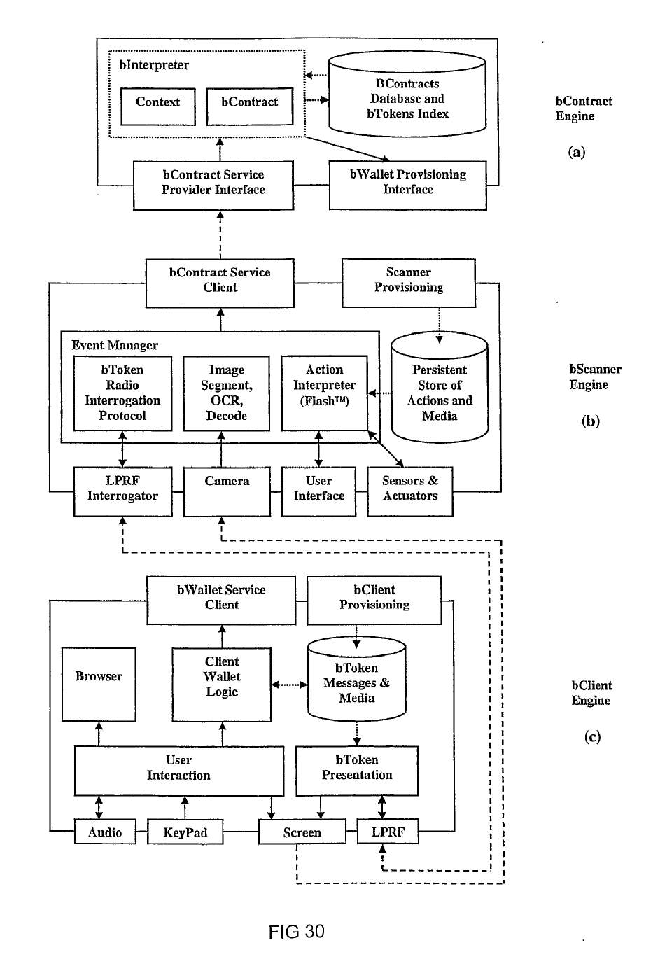

The bPlatform may be partitioned into a number of “engine” components. A bPlatform may, for example, be constructed from a selection of engine components, as illustrated in FIGS. 29 and 30, for example. A person skilled in the art may choose to factor a bPlatform implementation along different lines than chosen for these embodiments.

The bContract Engine, in this embodiment, is a processing component that executes bFunctions that form part of a bContract. This execution mechanism may, for example, consist of physical sensors and computer hardware to execute conditional tests, computer hardware as memory and to execute logical operations, communications hardware to execute communications operations and physical effectors to execute physical operations.

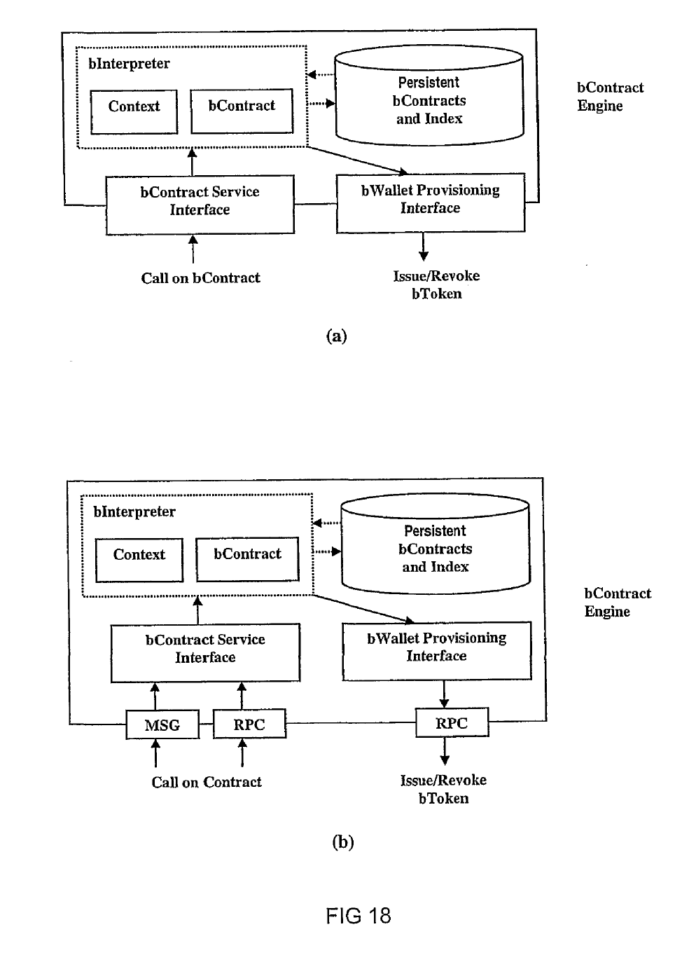

The main components and structure of a bContract Engine in accordance with an embodiment are illustrated in FIG. 18A. In FIG. 18A, the bContract Engine consists of the following major components: a persistent store containing a collection of bContracts and optionally an index that facilitates fast retrieval of the bContract associated with a given bToken; a bFunction execution mechanism (bInterpreter), which performs the evaluation and execution of bFunction conditions and actions; a bContract Service Interface, which enables an external entity to call for the execution of a bContract. Typically the call results in the execution of one or more of the bFunctions of the called bContract; and a bWallet Provisioning Interface, is used to issue or revoke a bToken by the bInterpreter executing issue/revoke bToken actions.

Additionally, a bContract Engine may provide more than the two interfaces shown in FIG. 18. For example, the bInterpreter may call on external entities to provide information or execute actions as part of the evaluation and execution of bFunctions.

The bContract Engine Interfaces may be implemented using a number of techniques, including procedure calls, web service protocols, asynchronous messaging and so on. As illustrated in FIG. 18B, calls on bContracts may be issued by a remote procedure call (RPC) mechanism or received as an asynchronous message (MSG), and bToken issue/revoke may be implemented by an RPC mechanism.

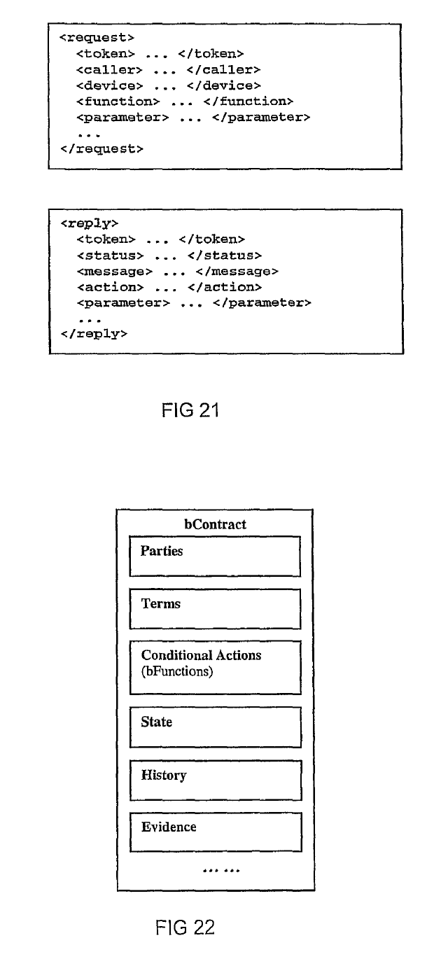

FIG. 21 illustrates request and reply protocol units that may be employed for a bContract Service Interface. An external entity, such as a bWallet, bScanner or bClient can call on a bContract by instantiating the request element. The caller provides a bToken value for the token element, and may optionally instantiate an explicit caller identification, calling device identification, bFunction name and/or parameters. The bInterpreter returns a result to the caller by instantiating a reply entity, which provides a status code, textual message, and optionally an action with parameters for execution by the caller. The reply action may, for example, be utilized to provide user interactions and operate physical mechanisms connected to a bScanner.

As indicated in FIG. 18, a bInterpreter executes bFunctions in a runtime context. The context reflects the parameters of the call and other relevant contextual information. A bInterpreter, in the embodiment of FIG. 18 cycles through the following steps:

Step 1: Wait for trigger event: A trigger event may be a call via the bContract Service Interface or an external event, such as a time-of-day event nominated as a condition of execution by a bFunction.

Step 2: Retrieve the one or more bContracts associated with the event from persistent store.

Step 3: Evaluate the conditions and actions of bFunctions of the retrieved bContract.

Step 4: In the case that the execution of actions modified the bContract or created new bContracts, store the updated bContracts in the persistent store.

Step 5: Go to step 1.

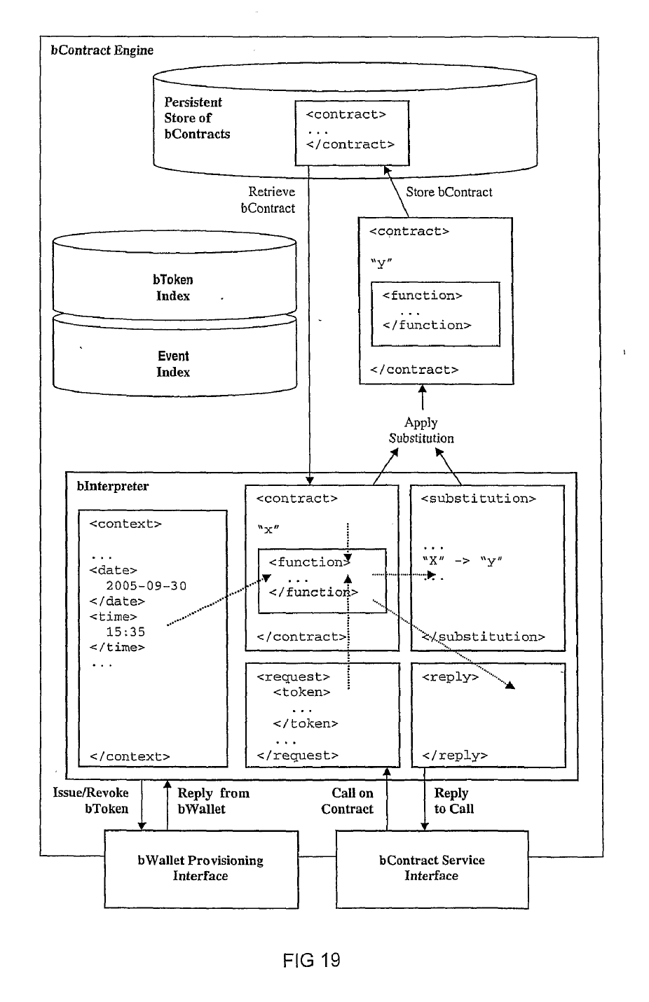

FIG. 19 illustrates an exemplary implementation of a bContract Engine in more detail. A bToken Index and an Event Index are maintained to enable the Engine to prime events and respond to calls and events. More sophisticated implementations may choose to employ RETE networks or other efficient mechanism for this purpose.

The bInterpreter illustrated in FIG. 19, includes a representation of the current time and date as part of the execution context. A call on a bContract is represented as a request entity and the results are encapsulated and returned to the caller as a reply entity. Modifications of the state of the bContract are maintained as substitutions, which may be applied to the bContract before it is written back into persistent storage.

The bInterpreter functionality may, in certain embodiments, be implemented by means of alternative mechanisms, such as a persistent object database and Java Enterprise (J2EE) execution mechanism, or a relational database and a .NET execution mechanism and environment.

bContract

FIG. 15B, as discussed above, illustrates the simplest structure of a bContract, including an algorithmic aspect, expressed as bFunctions, and an information aspect, expressed as state information that changes over time as a result of the execution of bFunctions.

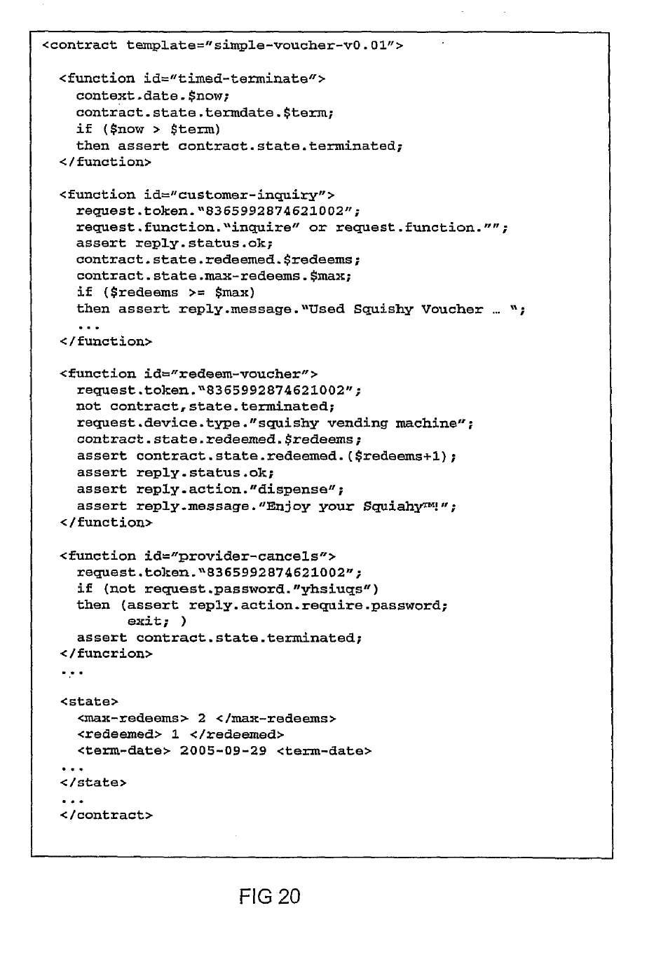

This exemplary bContract form of FIG. 15B may be instantiated in the manner shown in FIG. 20. The illustrated bContract provides the terms and functionality of a retail voucher. A consumer that holds the bToken associated with this bContract is entitled to two free items, in this case the items are called “Squishies”, dispensed by a “Squishy Vending Machine”.

For the FIG. 20 and subsequent examples, the bInterpreter evaluates all bFunctions of the bContract starting with the first (topmost) bFunction and working down the page. An “exit” action may be implemented to terminate execution early.

Alternative implementations may provide mechanisms for declarative bFunction conditions or pre-evaluation to provide more efficient selection of bContract execution. However, the illustrated execution order and mechanism is very simple to implement, and since bFunction execution represents a relatively small load, a simple implementation, may be preferred.

FIG. 20 illustrates an autonomous bFunction “timed-terminate” that updates the state of the bContract to indicate that it has terminated. The effect of termination can be seen as part of the “redeem-voucher” bFunction, which does not return a “dispense” action to a vending machine if the state of the bContract indicates that the contract term has expired.

Note that three of the bFunctions, illustrated in FIG. 20, test the value of a bToken. This value is given as part of the calling request. For example, the “redeem-voucher” bFunction opens with the expression: request.token. “8365992874621002”. This expression evaluates true if and only if a request element with the specific token “8365992874621002” is present.

There are two bToken values, issued to the two parties of the contract illustrated in FIG. 20: One to the consumer and the other to the “Squishy Corporation” as the service provider. The consumer can obtain information about the contract by requesting the “customer-inquiry” function or a request to “redeem-voucher” to obtain the desired item. In this case the “redeem-voucher” request must originate from a “squishy-vending-machine”, as this is enforced by a condition expression in the “redeem-voucher” function. The service provider can invoke the “provider-cancels” function to terminate the offer at any time, since there are no additional conditions expressed.

FIG. 20 also illustrates how a bContract may be instantiated to provide an electronic form of the retail voucher. More generally, bContracts can be employed to express any form of contract, contractual or non-contractual promise and other form of action projected for future execution. Examples of such bContract applications include, but are not limited to: (1) Entertainment Tickets entitling a consumer to attend an entertainment or other event. In this case the entry to premises is typically provided by a bScanner operating a turnstile mechanism or providing an agreed signal to venue staff to permit entry; (2) Transit Tickets so that a consumer may be issued a bToken, linked to a bContract, as part of a transport ticketing system. In this case fixed installation bScanners may be employed to provide entry/exit points, and hand-held bScanners for ad-hoc ticket inspection; (3) Games of Chance where lotteries or other games of chance may employ a bContract to record, enforce and inform the terms of the game. In this case a bToken would typically be issued to the participant as proof of participation and mechanisms to redeem a prize; (4) Keys for entry to premises, such as a hotel room for example, may be gated by a locking mechanism that incorporates a bScanner. bContracts may be formulated to provide time limited access for visitors and additional services, such as charging of meals to the room account, promotional offers and so on; (5) Memberships for membership of an organization and the consequent rights and obligations may be expressed as a bContract. In this case a bToken issued to the member may provide the means to enter service venues and call for other services associated with the membership, as well as membership renewal subscriptions, membership voting rights and other such services; (6) Vouchers for many forms of retail vouchers are in use for promotional, customer loyalty and customer behavior tracking purposes. A bToken provides a low cost means for distribution, redemption, tracking and other such infrastructure. The underlying bContract may combine traditional voucher, loyalty and other customer relationship elements. Privacy concerns permitting, the execution of bContract calls may be tracked to obtain customer behavior information; (7) Prescriptions and Recommendations so that A physician may issue a bToken to a patient to enable the patient to redeem medications nominated by the underlying bContract from a pharmacy. Similarly other orders and recommendations may be implemented using the bToken/bContract mechanism. In this case the functionality of the underlying bContract may include incentive schemes for the party making the recommendation; (8) Titles and Rights where a bToken and underlying bContract may provide proof of ownership of property of various kinds As an example, an escrow service may issue a bToken and express the underlying service conditions and actions as a bContract. In the case of digital assets, such as music, video, computer game items and so on, a bToken can provide the means for a consumer to access and trade the assets. The underlying bContract can enforce the terms of the consumer's and copyright owner's rights; (9) Identity and Certification Documents where a bToken may provide the means to access identity, certification or other information that is supplied under specific conditions nominated and enforced by the underlying bContract. For example, the bContract may demand appropriate proof of entitlement in addition to a bToken; (10) Queuing Tokens where a bToken may be issued as a queuing token for a consumer waiting to obtain a limited capacity service or enter a site. The underlying bContract may execute a notification message to the consumer and provide other associated services, such as timed issue of refreshment vouchers while waiting; (11) Agreements where the parties to an agreement, such as an employment, non-disclosure, goods or service supply, rental or lease, financing, MoU, agency, power of attorney and so on may express the agreement as a bContract. bTokens may be issued to the parties to provide access to the terms of the agreement, a way to call for performance and other relevant functions. The conditions of the bFunctions of these contracts can readily express fixed price, variable price or contingent price terms; (12) Methods of Payment where payment tokens, lines of credit, debit cards and other means of payment may be implemented by means of bContracts. Advantages of using bContracts for this purpose include the ability to express and enforce a wide variety of constraints on payment actions. For example, payments may be authorized for nominated classes of products and services only. As another example, a payment by a child may initiate an authorize request to a parent; and (13) Derivatives so that Trading instruments, such as futures contracts, options and other securities may be implemented as bContracts and meta-bContracts as disclosed by the description of a bMarket system embodiment below.

Persons skilled in the art may formulate bContracts for additional applications as well without deviating from the principles of the present invention.

In order to facilitate the above applications, the bContract structure may be extended as illustrated in FIG. 22. This exemplary structure is closer to the form of traditional contracts recorded on paper, thereby making it easier for humans to construct and read the bContract. The Terms section may be used to express the definition of names and values to be used as bFunction conditions to restrict the execution of promised actions. The History section may record a trace of the calls and the major changes of state of the bContract. The Evidence section may contain digital certificates and signatures by the parties to the contract and by the administrative authority operating the bPlatform.

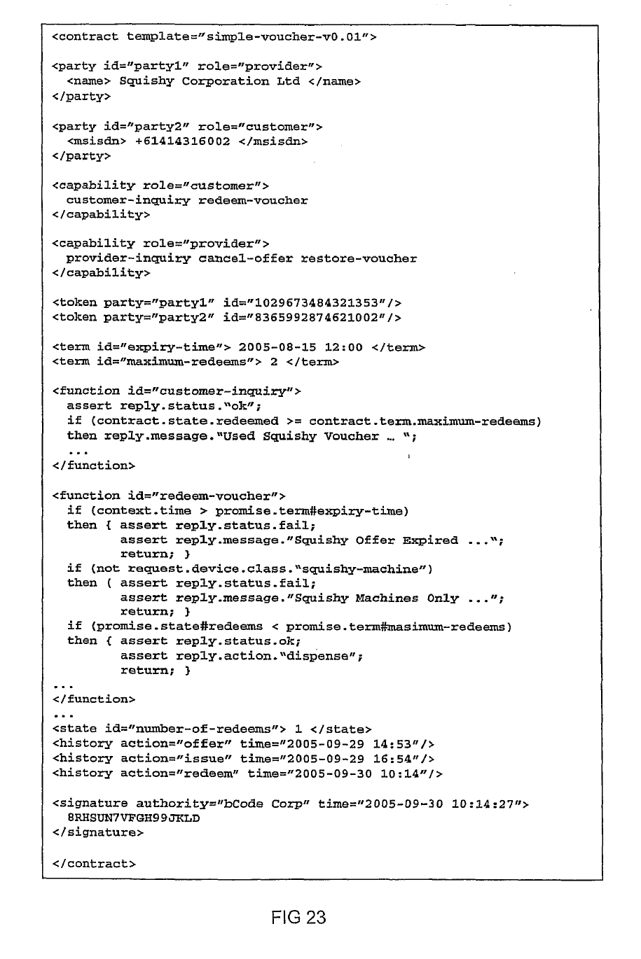

FIG. 23 displays an example instantiation, as a voucher, of the form of bContract shown in FIG. 22. Note that the parties to the contract are associated with roles, and bTokens are in turn associated with these roles. The terms of the contract include an expiry date/time and the number of permitted redeem actions. The history section retains a time-stamped record of bFunction calls. The evidence section illustrates a time-stamped digital signature verifying the integrity of the bContract by “bCode Corp”.

So far the bContract mechanism has been used to manipulate object-level information and state about an application domain, such as ticketing for example. However, the bContract mechanism may also be lifted from this object level to the meta-level, where the bContract reflects and manipulates information and states of bContracts themselves.

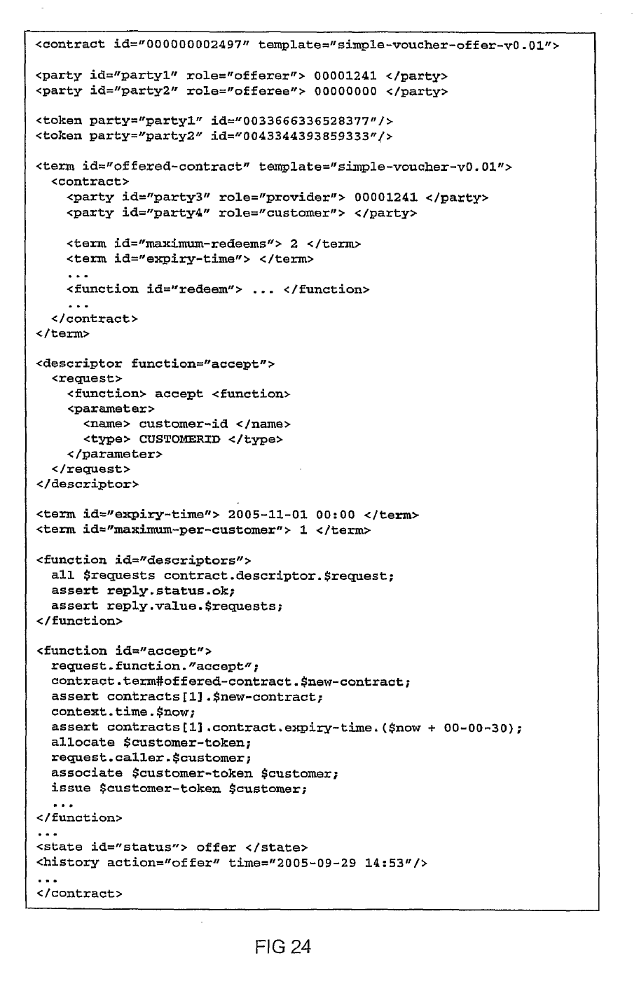

The meta-bContract art, shown in FIG. 24 illustrates a bContract that constitutes an offer by an “offerer” party to an anonymous “offereee” party. The offer contract encapsulates the partially instantiated contract being offered “offered-contract” as one of its terms. Such partially instantiated contracts may be referred to as bContract templates. These templates are instantiated by the meta-level bFunctions.

The offeree may accept the offer by invoking the “accept” meta-level bFunction. This function creates the new contract instance using the expression: assert contracts[1].$new-contract. The bInterpreter may be constructed to explicitly or implicitly save such new contracts in the bContracts database. In this embodiment an array called “contracts” is used to hold such contracts to be stored.

The “accept” function also calls on the bToken allocate, associate and issue functions to create a new bToken for the customer. These functions may be coalesced into a single function call, but as discussed above, may also be separate for didactic purposes.

The above meta-contract mechanism provides the means to express a range of instruments including, but not limited to: Offers to Sell—Partially instantiated contracts representing goods, services for sale, with a meta-contract function that instantiates the offer; Offers to Buy—Partially instantiated contracts representing requests-for-quotations (RFQs), requests-for-proposals (RFPs) and other offers and expressions of interest to acquire goods or services. In this case meta-contract functions may be provided for sellers to respond to the offer; and Derivatives—Any bContract, terms of the bContract permitting, may be manipulated by meta-contract functions to alter the terms of the contract, divide the contract, compose multiple contracts into one and similar operations.

In addition to the meta-contract aspect, FIG. 24 also illustrates other features of bContracts. The parties are here represented by “ids” being unique identifiers of database records in a database of bContract parties. In this embodiment, the identifier “0” is reserved for an anonymous party.

The exemplary bContract also provides a “descriptors” function, which may be called by any of the contract parties to return an XML formatted description of the function signatures of the bContract. FIG. 24 is an example of an introspective bFunction, which facilitates automated processing of bContracts.

Typically bContracts are embedded within a bPlatform that employs the bContract mechanism to provide economically valuable services in a way that is convenient for consumers to use. bContracts may implement a standardized set of well known bFunctions, which other processing and user interaction elements of the bPlatform can rely on to provide the functionality they need. The above-mentioned “descriptors” bFunction, and the “metadata” bFunction are examples of such a protocol.

bWallet

A bPlatform may optionally provide a bWallet service that enables an end user to manage the set of bTokens issued to that end user. A bWallet service may be implemented as a remote server-based service, a service that executes on a user's mobile client device or as a service on an intermediate device, such as a bScanner, for example.

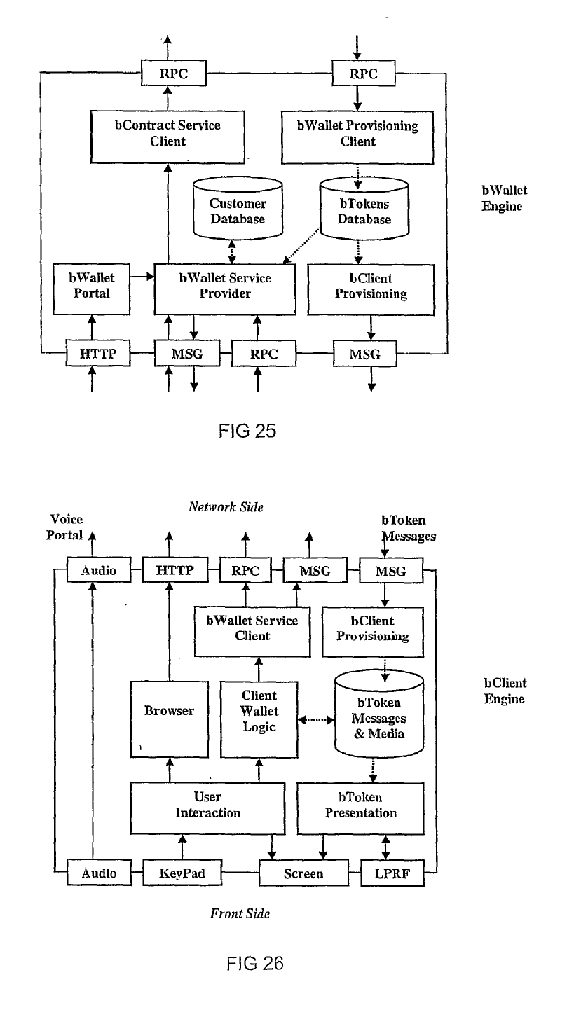

FIG. 25 illustrates a server-based implementation of a bWallet. The bTokens database stores bTokens on behalf of multiple users. Information about each user of the service is maintained in a Customer Database. The bTokens issued by a bContract Engine arrive in the wallet by means of a bWallet Provisioning interface. The bWallet may pass on bTokens further to a bClient device, for example, via a bClient Provisioning interface.

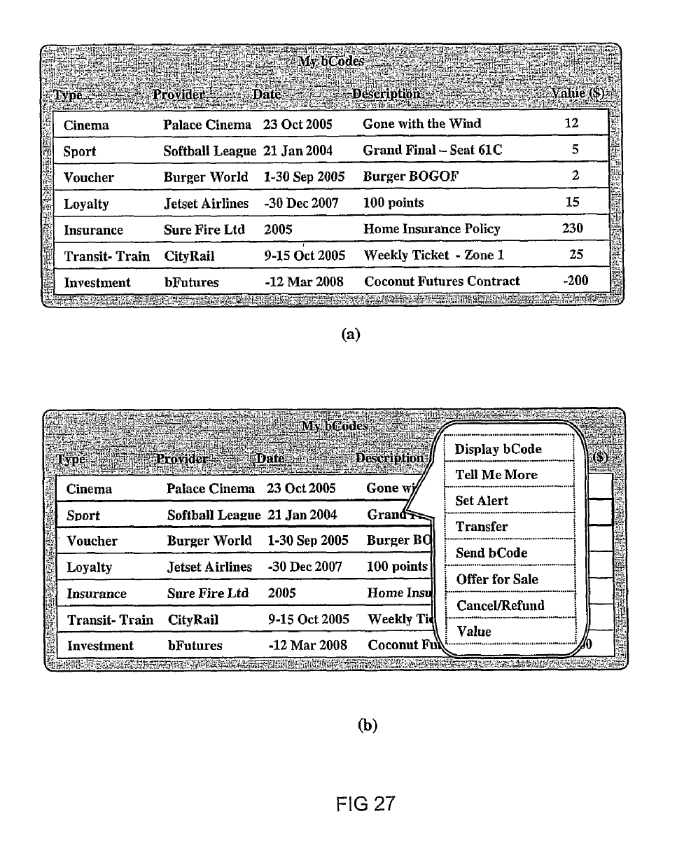

A user (customer) of the bWallet service may access the service via a web portal interface or via an RPC or asynchronous messaging interface. FIG. 27 illustrates exemplary services offered by the bWallet and an example look-and-feel of the web portal service. In FIG. 27, the customer is offered a list of bTokens that includes short meta-data items describing the associated/underlying bContracts. In certain embodiments, bContracts may implement a “metadata” bFunction that enables the bWallet to query for this information in a machine-readable format, such as XML. Additionally, the user may order the columns of the display using a mouse click or other user interaction mechanism. The user can also select any one of the bTokens, revealing a menu of bFunctions offered by the underlying bContract. The customer may also be able to select one of these functions, resulting in a call to the bContract engine with the selected function name indicated in the call request.

While a simple bWallet consists of a collection of currently valid bTokens, more elaborate implementations may choose to provide a persistent record of expired bContracts as well. Still other implementations may provide a search mechanism or recommendation mechanism that enables the customer to search for bContracts, such as offers of interest.

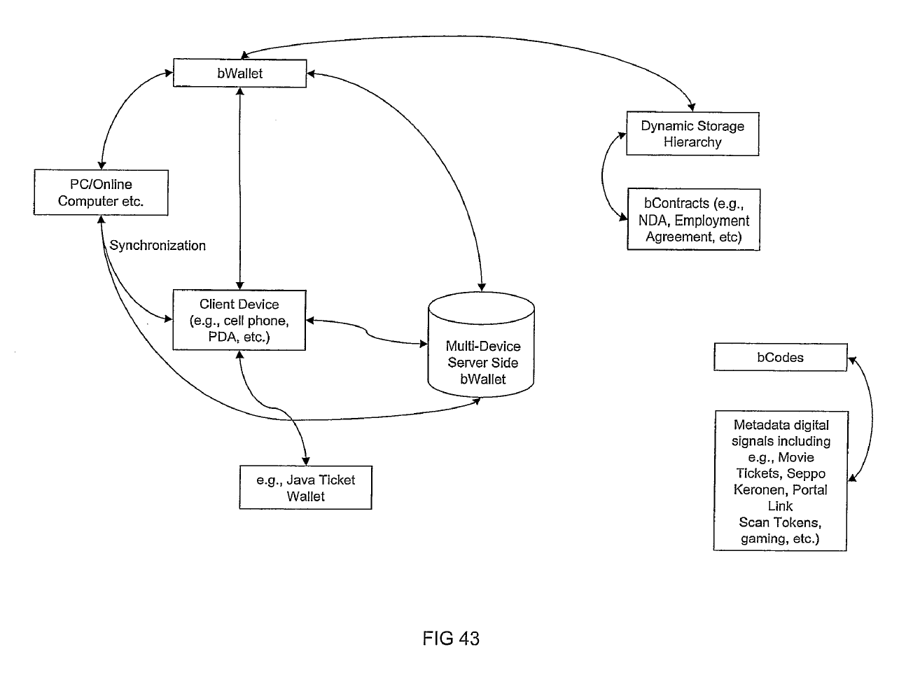

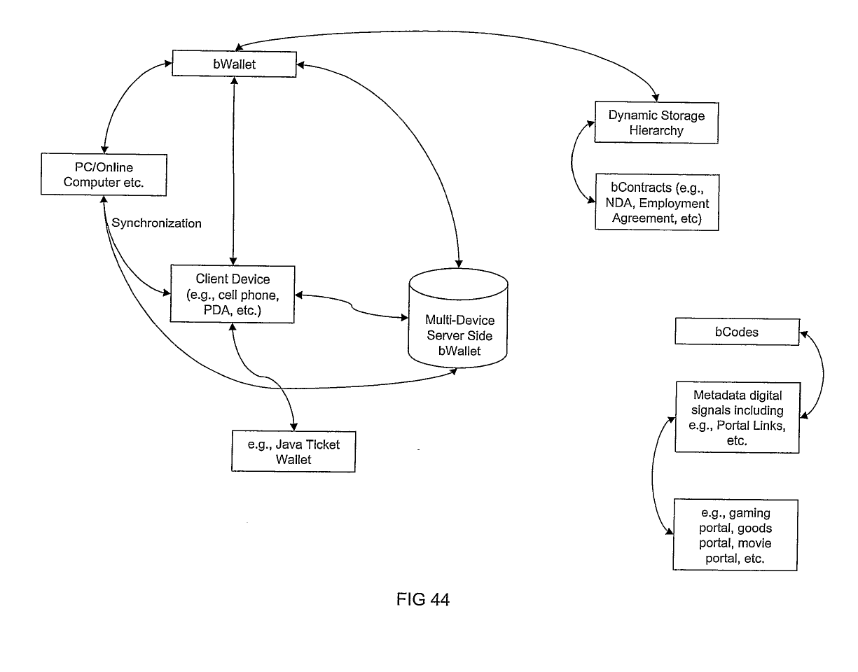

Additional embodiments and functionality of the bWallet are illustrated in FIGS. 43 and 44.

bClient

A bClient provides the necessary functionality that a consumer needs to access bPlatform services. The bPlatform may be designed to enable the use of existing portable electronic devices for this purpose so that any device that provides the mechanism for digital data messaging can be utilized as a simple bClient. Exemplary devices include, but are not limited to, cellular phones, PDAs, mobile game consoles, music and multimedia players and notebook computers. Exemplary messaging services include, but are not limited to, short messaging services, such as the SMS/GSM service, e-mail services and instant messaging services.

A cellular telephone handset is a typical example of a simple bClient. bTokens, encoded as bCode messages, may be transmitted to such a device by means of a short messaging service, such as the SMS/GSM service, for example.

Another example of a bClient is a cellular phone equipped with a low power radio frequency (LPRF) transceiver, such as a Bluetooth or Near Field Communications (NFC) transceiver, for example. In this case a bToken may still be transmitted to the client as a bCode message. In order to make full use of the LPRF capability, the client may incorporate additional functionality to automatically call for another form of token encoded in a form specifically designed for LPRF presentation. This client-calls back mechanism may operate as follows: (1) The bClient receives a bCode message; (2) The bClient recognizes the bCode message by message header or content pattern match; (3) The bClient transmits a request to a bPlatorm to provide an alternative format and/or other associated content; (4) The bPlatform replies with the requested representation and/or content. This client-calls-back mechanism may be advantageous because the sender of the bToken need not know what formats are supported by a specific client, while at the same time heterogeneous clients are supported provided so long as the clients implement the “lowest common denominator” bCode format and the call back mechanism.

FIG. 26 illustrates the construction of an advanced bClient engine that may be incorporated as part of a client device to provide more functionality and convenience of use for bPlatform services. This engine incorporates a bClient Provisioning component, which recognizes a bToken message and saves the message in a form accessible by the bWallet component of the client. The bWallet component of the Engine typically presents bTokens on the client device screen in a form similar to that illustrated in FIG. 27, and described above.

A bClient Engine may also incorporate a bToken presentation component, which responds to a query, transmitted via LPRF by a bScanner, by transmitting a bToken that matches the query as a reply to the bScanner. This query-initiated form of presentation improves the end-user experience by eliminating the need for the end user to manually find and select a bToken for presentation.

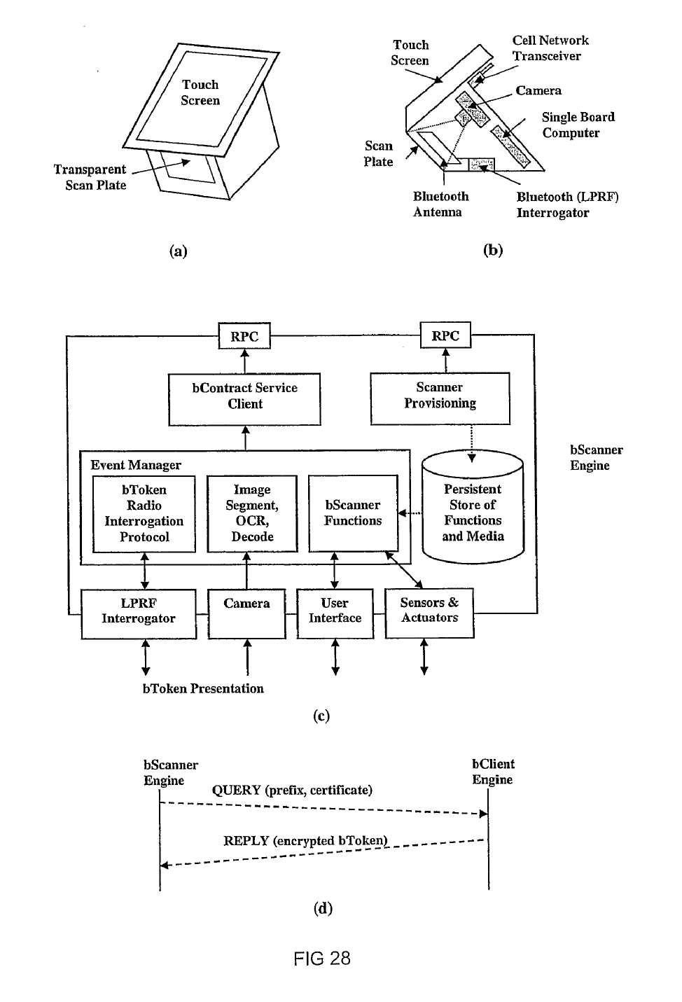

The bToken prefix, illustrated in FIG. 15, is designed to facilitate query-initiated presentations. A simple form of the presentation protocol is illustrated in FIG. 28D. A bScanner transmits a query protocol data unit (PDU) that contains a bToken prefix and a bScanner certificate that includes the bScanner public key. The bClient replies with a PDU that contains one or more bTokens with the same prefix as the query. The client may, in certain embodiments employ the certificate supplied by the bScanner to verify that the bScanner is not an impersonator. The client may also encrypt its reply to the bScanner using the supplied public key. Typically the bScanner will subsequently indicate the acceptance/rejection of the offered bToken. A person skilled in digital communications can provide variants and elaborations of this protocol.

A bClient engine may provide a richer user experience by automatically calling on a bToken to supply alternative or additional digital media, such as graphics, audio, or video associated with the bToken. These media may then be presented to the end user as representations or additional to the bToken.

bScanner

The bPlatform may employ intermediary devices, called bScanners, to provide the tools for consumers to carry out x-commerce (m-commerce in a local context) transactions. Such local contexts include the entry turnstile of a cinema or transit authority, the point-of-sale of a retail business and so on. The consumer experience may be improved by providing the tools to complete a transaction by interacting with a local hardware device that recognizes bTokens, provides rich user interaction means, calls on bFunctions and performs actions nominated by the bFunction locally.

FIG. 28C illustrates a construction of a bScanner. A bScanner typically communicate directly with a bClient using a local communications device, such as visual signaling, audio signaling and low power radio frequency (LPRF) signaling. A bScanner apparatus typically provides a user interaction device, such as a touch display, to inform the user and enable the user to further interact with the service being delivered. An intermediate device also often provides service specific mechanisms that perform functions such as opening a turnstile, dispensing a physical product and so on. By combining a touch screen interface that are deployable in physical commerce locations such as retail locations, with a identity recognition device such as a bCode recognition engine, the bScanner can bring internet website functionality from cyberspace into the physical world. The touch-screen when utilized this way is providing website functionalities with locational context, and the bCode presented provides corresponding “browser-cookie” functionalities. Unlike paper-based barcodes in similar devices such as airline check-in kiosks, the bCode provides “cookie” like functionalities such as dynamic generation, manipulation, updatability, deletion and dynamic server-side mapping. Through this mechanism, the bScanner brings functionalities that are normally privileges of online merchants, such as context-specific targeting (e.g. Doubleclick.com), dynamic automatic product recommendations (Amazon.com) and searching, matching and credibility services (e.g. Ebay.com), to the multi-trillion dollar offline retail market.

A bScanner typically operates according to the following procedure:

Step 0: A bPlatform may employ a bScanner Provisioning interface to preload or cache (partial) bContracts, bScanner functions and presentation media that the bScanner may require to operate. This provisioning step may occur at any time.

Step 1: Wait for customer to approach. During this time a bScanner equipped with display or an audio rendering apparatus may display promotional or other content. A bScanner equipped with an LPRF device may broadcast LPRF advertisements of the services the scanner offers.

Step 2: Acquire bToken from a bClient. A digital camera, triggered by a proximity detector, may be used to obtain a bCode image displayed on a mobile device screen. An audio signal, emitted by a bClient, may be acquired using a microphone. An LPRF radio signal may be acquired using an LPRF receiver, according to a protocol such as the example in FIG. 28D.

Step 3: Decode the acquired bToken. In the case of a visual bCode, decode is performed by segmenting the bCode from the acquired image, applying optical character recognition (OCR) and applying the reverse of the encoding process illustrated in FIG. 2. The framing character, e.g., “=”, of the bCode, enables well-known image processing methods to be used for segmentation. Encrypted bTokens also required decryption to reveal the bToken value.

Step 4: Ensure that the given bToken is valid by querying a bToken index, typically via a bContract service interface. In the case that the bToken is valid, and of a type that the bScanner is able to deal with, proceed to step 5. Otherwise provide an indication to the user that the bToken is not valid and go to step 1.

Step 5: The bScanner may directly invoke the bContract with a predetermined bFunction name (and other parameters). Alternatively the bScanner may present the consumer with a menu of available functions for the given bToken. In this case the “metadata” and “descriptors” functions may be invoked by the bScanner to discover the available functionality and required parameters. Subsequently the user may select the functionality to be called. The bContract underlying the given bToken may be processed remotely or (partially) cached on the bScanner itself.

Step 6: The bContract engine will typically reply to a bFunction call with a reply containing the result of processing the request. The reply may contain an informative message, media to be presented or a function call to be performed by the bScanner. Examples of such bScanner functions called include opening of a turnstile and dispensing of an item by a vending machine of which the bScanner forms a part. The underlying bContract may implement a handshake protocol, which requires the bScanner to provide a positive or negative acknowledgement on completion of the requested bScanner function.

Step 7: Go to step 1.

bPlatform Architecture

The following bPlatform components were described above:

a bContract Engine;

a bWallet Engine;

a bScanner Engine; and

a bClient Engine.

These components are designed to fit together to form an entire bPlatform. Exemplary bPlatform configurations are illustrated in FIGS. 29 and 30.

FIG. 29 illustrates a single bContract engine dealing with a bClient through an intermediate bWallet. Typically bTokens issued by the bContract engine may be stored on the bWallet engine persistently, and may also be stored (cached) on the bClient.

FIG. 30 illustrates a bClient calling on a bContract by presenting a bToken to an intermediary bScanner. The illustrated presentation of the bToken is either as a visual bCode or low power radio frequency (LPRF) presentation. In this case the bScanner deals directly with the appropriate bContract engine. Alternatively, the bScanner may employ an intermediate bWallet to forward requests to a bContract engine. A bToken router or switch element may be employed to route requests to one of a number of bContract engines. This and other known distributed service methods may provide for better scalability of the bPlatform.

Alternative bPlatform configurations using the elements described in the present disclosure should be obvious to persons of ordinary skill in the art.

bPlatform Server

The value of an electronic token (bToken) to an end-user is that it provides the end-user with the capability to call on the transaction methods (bFunctions) of the digital contract associated with bTokens in the end-user's possession.

Given a bCode, for example, an end user may invoke bFunctions of the underlying bContract in the following ways:

bScanner Presentation: User locates a bCode message in the short message inbox of a cellular telephone and places the phone display on the scan-plate of the bScanner apparatus described below.

Message Presentation: User composes a short message using her cellular telephone functionality. The message consists of the word “information” or other bFunction name followed by a bCode from the cell phone inbox.

Portal Presentation: User logs onto a web portal and pastes the text of a bCode into a text field provided for this purpose on the web page input form.

RPC Presentation: User employs a Java MIDLet installed on her cell phone to pick a bCode and function to be invoked.

A server computer hosting a bContract platform and connected to the Internet receives and processes the requested bFunction. The effect of the execution is an informative message or execution of the requested functionality.

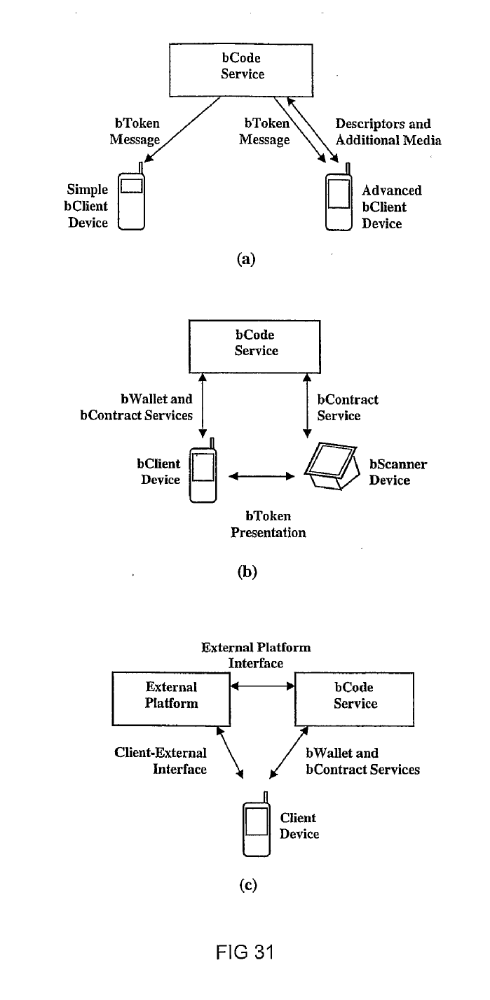

FIG. 31 illustrates an example of a physical architecture of the above bPlatform system. The simplest embodiment of the platform, consisting of a client device and a server computer, is illustrated in FIG. 31A. The client device may be a mobile phone handset, personal digital assistant (PDA), notebook personal computer (PC), desktop PC or other such device equipped with data communication, memory and computational device. The server device may be a server computer connected to a data communications network, such as the Internet.

In an exemplary interaction between the client and server, the client receives a message containing a bCode from the server, as a cellular short message. In this embodiment the server employs a Short Message Centre (SMSC) connection arranged with a cellular telecommunications carrier. Subsequently the client sends a message containing the same bCode to the server requesting the execution of a bFunction permitted by the bCode. As an example, the bContract underlying the bCode may entitle the holder of the bCode to receive a piece of digitally encoded music. The music file is transmitted to the client in response to the request.

FIG. 31B illustrates a typical x-commerce configuration of a platform. An intermediate bScanner (between the client and server) is introduced to provide a scanner to scan the bCode and execute an x-commerce transaction. The intermediate bScanner may be a ticket or voucher scanner, information kiosk, vending machine or other such device that provides a service at a specific physical location.

The bPlatform may be embedded as a component of a larger system. FIG. 31C illustrates such an embedding, where the larger system is factored into a bPlatform and an External Platform component. In this case the External Platform may interact with the client to promote a service, for example. Subsequently the External Platform may construct a bContract specification and transmit it to the bPlatform server computer for establishment processing.

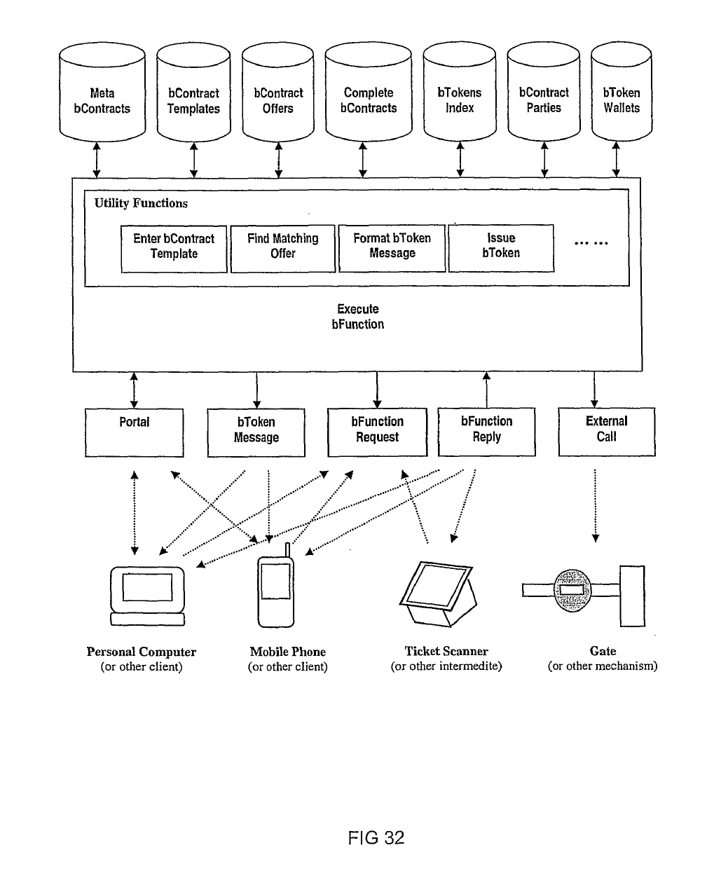

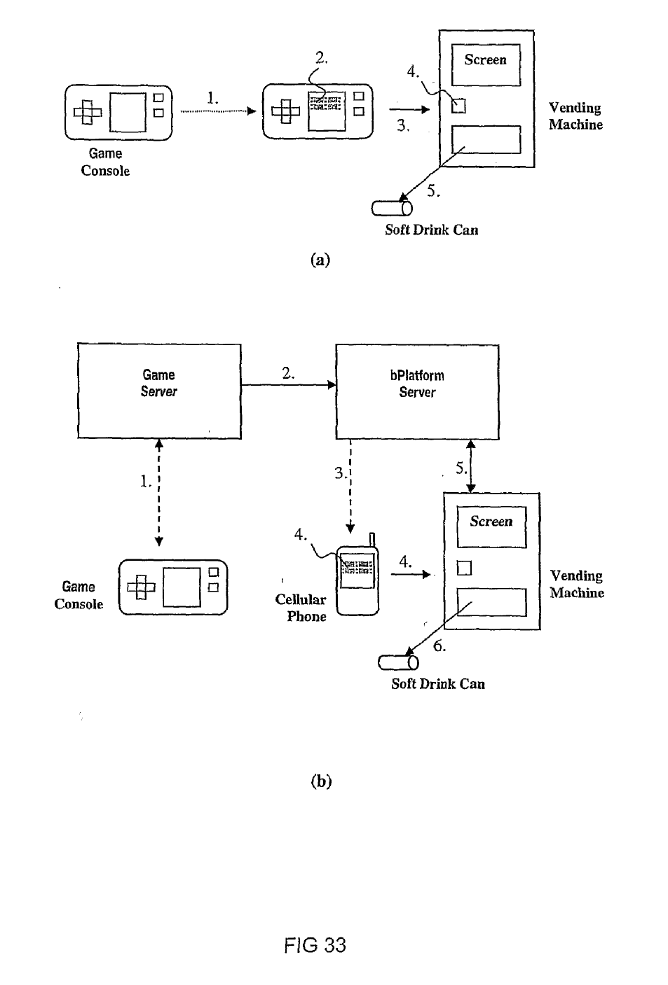

FIG. 32 illustrates an exemplary bPlatform server implementation structure. The server incorporates a bContract engine and a bWallet engine. These engines may be implemented using the C++ programming language. Relational databases may be used as persistent stores for bContract state, issued bTokens, customer records and the other database illustrated in FIG. 32. bContract templates and bContracts are represented in a relational format for persistent storage, as C++ objects during execution and as XML for interoperable transfer to other platforms.

The exemplary bContract may consist of two promises between a consumer (party 1) and a merchant (party 2) that operates the external platform. Promise 1 is an obligation on the part of party 2 for the benefit of party 1, and promise 2 is an obligation by party 1 for the benefit of party 2. Together the promises satisfy the notion of consideration required for some forms of legal contract. For the purposes of this embodiment, promise 1 may provide party 1 the right to claim a prize that party 1 has been fortunate to win in a game of chance conducted by party 2. In this case promise 2 may represent the fee paid by party 1 to party 2 to enter the prize draw.

bScanner Apparatus

Example applications of bScanner devices include ticket, voucher and customer recognition scanners, vending machines and other sales and service points that recognize bTokens. bScanner device form factor details that may vary depending on the application and details of embedding of the scanner apparatus as part of existing equipment. In this section a stand-alone bScanner device design is described. This design can readily be modified for many embedded configurations by persons skilled in the art.

FIGS. 28A and 28B display the design of a physical bScanner device that is able to acquire a bToken either from the display screen of a cellular telephone or PDA handset or presented by an LPRF protocol using the Bluetooth LPRF standard.

In FIG. 28, the bScanner is designed around a 12-inch color LCD touch display supported at a 45 degree angle facing the end-user. A 1.3 Mega pixel digital camera is mounted behind the touch screen to obtain an image size of approximately 90 mm×120 mm when a cell phone is placed in front of a transparent window (scan plate) mounted perpendicular to the front edge of the touch screen. An infrared sensor beam placed about 20 mm above the surface of the scan plate is used as a proximity sensor to trigger the acquisition of an image by the digital camera. A Bluetooth transceiver and antenna are also placed adjacent to the scan plate to enable acquisition of a bToken presented using this low power radio standard.

The above industrial design with an angled scan plate enables a consumer to quickly and conveniently position a cell phone in front of the scan plate. Preferably the bScanner apparatus is positioned at approximately waist height for the average end-user group of the bScanner.

The memory and processing devices for the bScanner embodiment may be provided by a standard small form factor personal computer motherboard, low power processor and flash memory. The bScanner employs a standard embedded wireless communications modem to provide access to the bContract platform backend server.

The bScanner core functionality may be implemented using the C++ programming language or other appropriate language. This bScanner embodiment may employ the well-known Flash platform by Macromedia Corporation for user interaction using the LCD touch screen, and as the programming language for the bScanner functions.

bIntermediaries

The bMarket described herein allows offers from buyers and sellers. Each can list standing offers to buy or sell products and services and any incomplete contract can be listed on the market as a standing offer which could have a variety of offer conditions and proposed terms. Existing bTemplates may, in certain embodiments, be used as a shortcut for the offer drafting process. In conventional systems, however, the processes are unilateral, and a single place is provided for sellers to list fixed and basic products and services for sale.

Additionally, in certain embodiments of the present invention, the bContract fields (which may be marked-up using XML) may be categorized with specific meanings and may create meaning, context, and relationships for the field information, whereas conventional systems are only capable of using a keyword syntax. Specifically, in certain embodiments, advanced searching that can search bContract fields along with information such as Object Model relationships and Associative relationships may be utilized. The associative relationships may be, for example, relationships between field data that give users adjacent or related results that are relevant and desired by the user performing the search. In certain embodiments, a number of browsing tools may be available to give a user textual or graphical representations of related results. The search base for each search may be large and bContract terms may be potentially complex. Further, associated logic may be rich, meaningful and user-friendly interfaces may be required for users to use the bMarket environment. Accordingly, the interface, in certain embodiments, may be tailored to provide manageable navigation for users. Examples of such interfaces, may in certain embodiments, include hub and spoke, hierarchy-based object browsers, proximity maps, n-dimensional maps, color-coded maps, etc (i.e., more than, for example, a straight list of products). These display methods have been used to browse content on the Internet, such as the news browser Liveplasma.com is providing for News.com. The bMarket Associate Browsers may, in certain embodiments, utilize similar methods for a bContract browser, utilizing the unique contract mark-up and classification language specified in the present invention, as well as the associative intelligence (discussed below), giving bMarket users the same functionality of browsing as if the bContracts were static context-sensitive relational content such as News.

Additionally, the goods associated with the bContract may, in certain embodiments, include all physical and virtual goods. Additionally variable term contracts which expand the tradable good domain significantly to include any unit of demand or supply in an economy may be available. For example, different stage buy offers (marketing, lead generation, request for information, request for proposals, initial offer, etc), and different stage sell offers (partially completed goods, goods requiring assembly, bundling or processing, etc.) may be possible using certain embodiments of the present invention. Accordingly, transactions in accordance with the present invention are not limited to tradable goods limited to physical goods with fixed terms of sale.

Furthermore, as described herein, the bMarket allows goods, services and bContracts to be traded in real-time. Once a bToken is exchanged, the recipient may get instant access to the physical good or service associated therewith. Accordingly, for example, the bToken can be used to get immediate access to a venue since bContracts are maintained by the bMarket central authority, all trades happen in real-time, and along with the actual transfer of the entitlements. Accordingly, there is no delay as a result of logistical events that are often slow (e.g., postage, escrow processes, etc.). Additionally, the bMarket may contain mechanisms to execute elements of bContracts. Performance may be internal to the bMarket such that actions such as redemption, variation, cancellation, transfer, etc, are directly invoked, authorized, tracked and reported by the bMarket.

Additionally, in certain embodiments, a 1-to-1 and/or a 1-to-many negotiation tool may be provided for allowing parties to negotiate variations to a contract until agreement is reached.

In addition, in certain embodiments, a bIntermediary may be employed to achieve further flexibility within the bMarket. bIntermediaries may be devices or programs that help match particular products or services with customers. In certain embodiments, the bIntermediaries may be configured to set up a portal or “skin” to provide specialized access or usage to target a specific user base or for specific products, services, industries, markets, or types of bContracts. For example, a bIntermediary may be configured to specialize in sourcing masseurs and may, therefore, be configured to create a custom portal to attract them, provide value-added content and services, and then plug them into the bMarket. In an other embodiment, a bIntermediary may be configured to set up a website that specializes in selling chocolate that uses the bMarket to source the products, and then package them in a that adds some type of value to a specialized chocolate sales portal. The bMarket bIntermediary architecture allows intermediary portals that use the Internet, Mobile Phones, PDAs, offline channels, etc. to give certain user-bases more meaningful access to the bMarket, and vice versa. Furthermore, in addition to the variety of object browsing tools such as APIs, subscription-based feeds, event-based feeds, and rule-based feeds etc. for human users, for bIntermediaries, there may be a variety of query tools, filtering tools, associative “views” of the database, etc.

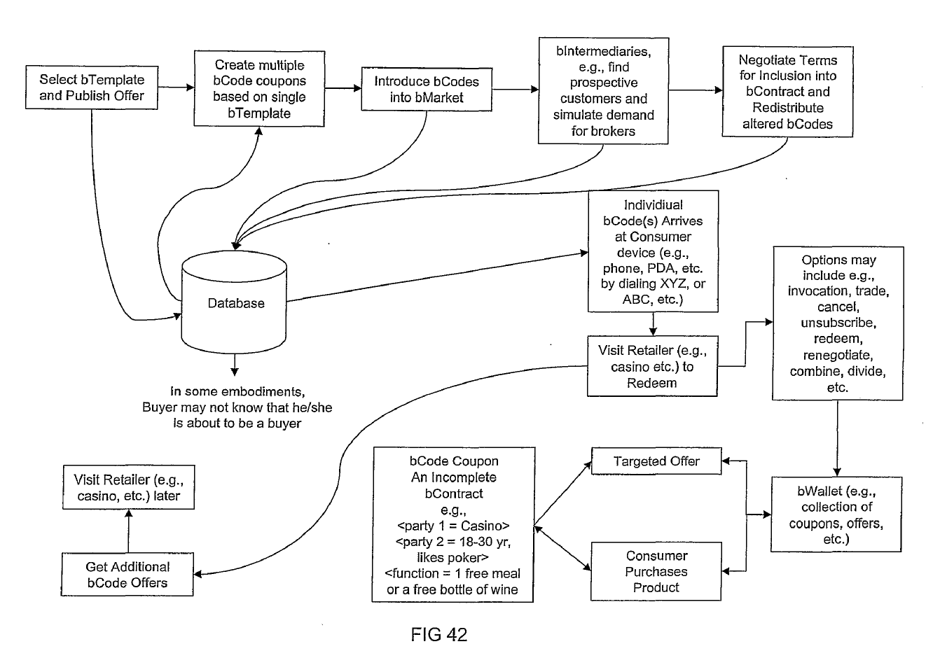

In conventional systems, however, there are no such secondary market capabilities or market creation capabilities. Specifically, user & programmatic interfaces available for human or machine intermediaries to trade in the bMarket may contribute efficiency to the market given the security and credibility control systems of the market. bIntermediaries, as discussed above, are agencies that act as facilitators for the creation, negotiation and completion of bContracts between parties, buyers and sellers. In some embodiments, the buyers or sellers may not be aware that they are going to indeed be buyers and sellers because bIntermediaries can also play a market-making function. In FIG. 42, when the retailer issues a batch of incomplete bContract offers into the market as coupons, bIntermediaries can help find the target counterparty for those coupons, so that the retailer issuer do not have to source those counterparties directly. The bIntermediaries could be a cable TV station, for example, who has access to viewers that could be informed and negotiated into being those counterparties. In this instance the cable TV can access the bMarket using a web-based interface, or if pre-configured, an automatic machine interface if certain criteria are met for the type of offer available. The bMarket provides graphical UI or machine APIs to allow bIntermediaries to query the bMarket for any standing bContract offers that it would like to participate as an agent or directly, and if the bIntermediary is interested in participating, the same graphical UI or machine API can be used to act upon those offers. bIntermediaries can build their own custom applications to access the bMarket via these standard interfaces. The intelligence in these custom applications reflect the expertise of each of these bIntermediaries, and can be machine or human intelligence. The bMarket system provides searching, browsing and subscription capabilities for bIntermediaries to access real-time information about standing bContract offers that desire to be completed, and that's the primary purpose of bIntermediaries.

As an exemplary embodiment of how bIntermediaries can function, an airline passenger and tourist from China arrives at the Sydney airport. The passenger uses his mobile device to put a bContract offer onto the bMarket requesting proposals for 5 nights of luxury accommodations. A number of accommodation providers would already have subscribed to a qualified feed of such tourists, and may choose to respond to the tourist directly. However most of these providers may be filtered out by the requester in certain embodiments, i.e. tourist, based on market credibility criteria. Of those direct bContract offer responses, the Shangri La hotel may, for example, make it through to the participant, as it may already have a credibility rating with the tourist. The Hilton hotel may also make it through. Even though it may not have a prior credibility rating with the tourist, it may have a sufficiently high market-based credibility to also make it past the selection criteria of the tourist.

In certain embodiments, there may be a number of bIntermediaries that would have also subscribed to the feed of incoming passengers. One of these could be an internally renowned holiday management organization such as Accor. One of Accor's expertise is careful management of travel needs by travelers. In this instance, Accor may use its own intelligence to find the tourist a well-recommended luxury accommodation in Sydney for China-originating travelers, i.e., one that has Chinese-speaking staff. In addition, along with its response for accommodation, in certain embodiments, it may offer a tour package which includes restaurant accommodations and a brief tour of the Sydney Casino, even though these offers were not prompted by the requester. In embodiments, Accor may be able to get past the Chinese tourist's selection criteria, because it has market credibility or it may simply be requested by the tourist.

Another bIntermediary may also get through the selection criteria, as it realizes that this particular tourist has an advertised profile of seeking a female companion, even though that did not form a part of the accommodation request. bIntermediaries can also act as experts in relationships with participants, whether as supplier relationship management or customer relationship management. In this embodiment, the bIntermediary may also package into the offer, a tour to the great singles bars in the area. The selection criteria offered by the bMarket to the tourist may contain advanced selection configuration capabilities that may allow this particular bIntermediary to be selected.

On the supply side, certain bIntermediaries can aggregate buyer groups for presentation to suppliers. In this embodiment, the forementioned bIntermediary may specialize in aggregating tourists from China and presenting that buyer block to the Sydney Casino, to obtain better terms such as price on the accommodation for this buyer group. In doing so, it is intermediating a market niche and, in embodiments, profiting as a result.

In terms of credibility development, similar to what Blogs use for building up a credibility hierarchy as well as allowing low-credibility provider to rise up the ranks, the bMarket may enable the more adventurous participants to sample lower-ranked providers and services. These participants will configure their selection criteria to target new providers. Thus the gradual build up of opinion and trading record as a result of these transactions will eventually lift quality participants and bIntermediaries where they can transact en-masse. The bMarket provides application and user interfaces for the bMarket participants and intermediaries to transact in the fashion described above.

In certain embodiments, the matching of requirements may be, just like real-life human situations, often non-precise and based on associative and fuzzy logic. So the matching of these requirements in these embodiments may often be described by a combination of words and menu selections, and are matched by the method described later under word matching, associative and affinity logic.

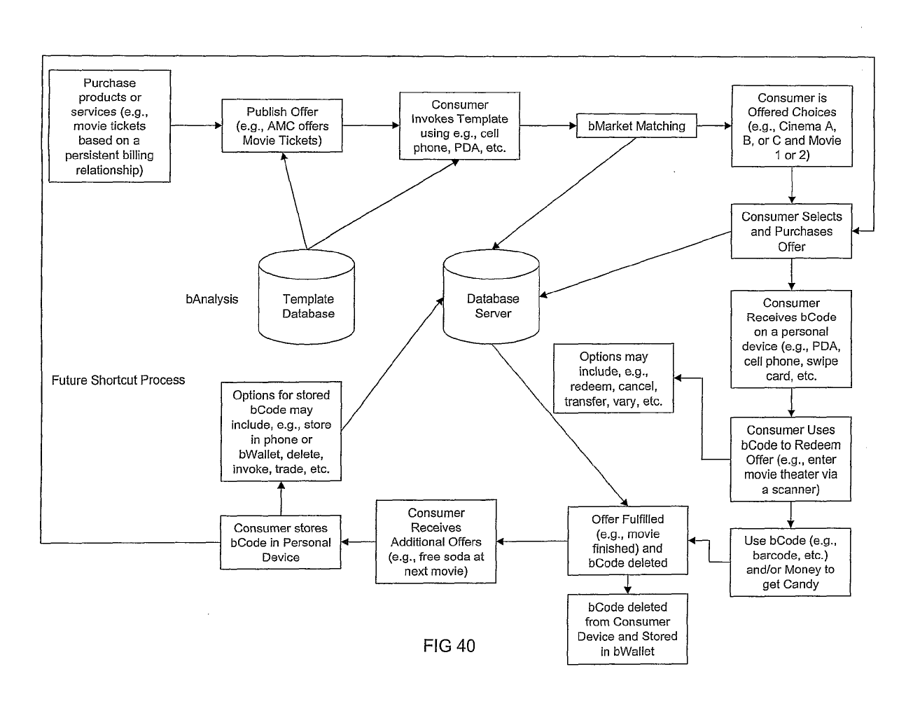

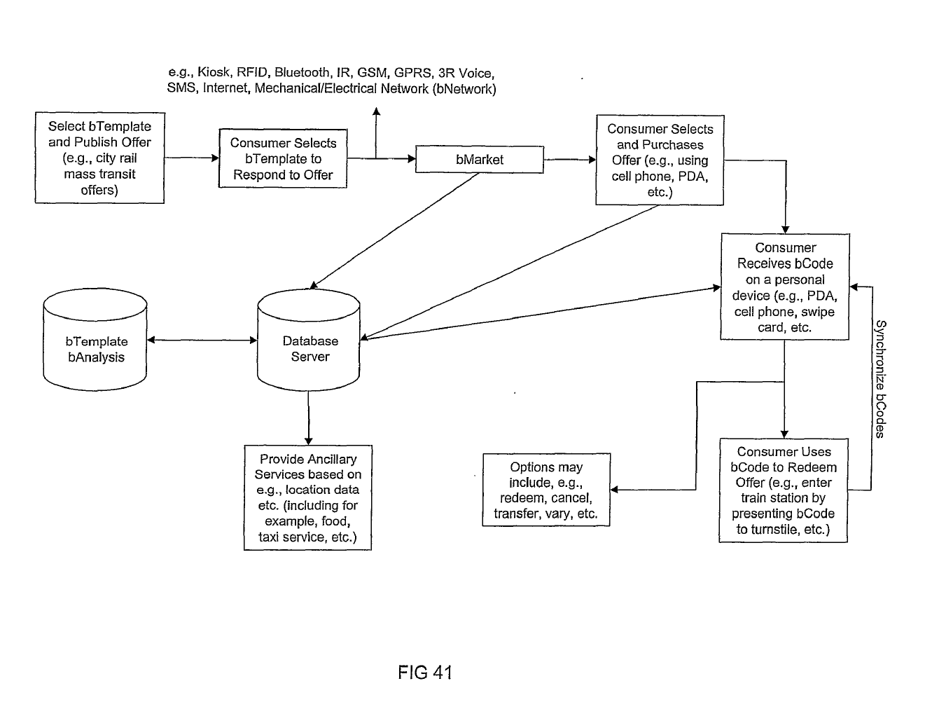

As shown in FIG. 40 and FIG. 41, for example, the bAnalysis process extracts information from the bMarket transaction database and performs data mining and data analysis on those transactions. The result is summarized data and interrelationships between the data, which could include demographic analysis, trending results, pricing analysis, etc. This information can then be made available in standard human-viewable forms such as reports, graphs, charts and tables, or alternatively be made available in machine-API query form such as remote database access formats and query tools such as OLAP. This information can then be processed further by the bAnalysis process into condense form such as bTemplates. This is effectively converting information from past transactions into most likely and most readily executed bContract forms, i.e., into commonly used bTemplates. These bTemplates are stored in similar formats as bContracts.

This last step completes the typical bMarket transaction. As shown in FIG. 40 and FIG. 41, it begins with an actual demand, or market-stimulated demand. Then a bTemplate is selected to create an offer. It is then released into the bMarket for publication and intermediation. Through direct or bIntermediaries, the offer is being counter-offered by various parties. This is then negotiated and executed. bCodes are generated and issued to confirm the agreement, and stored for later invocation. Then after the final invocation, the transaction is completed and information is stored in the database, and subsequently processed by bAnalysis. As a final step, the information is fed back to the bTemplate database to facilitate and expedite future bMarket transactions. This process is performed iteratively to progressively optimize market efficiency. The mechanism provides a significantly faster and real-time market commerce and self-optimization then processes that exists today by using the data and communication formats detailed in the present invention, the detailed process used to take advantage of these standard formats, and the utilization of mobile devices to keep all market participants connected to the market to avoid lapse time from the separation from the bMarket (e.g., when a person is not online in a traditional e-commerce situation)

Cinema Ticket System

A cinema ticket system may be constructed using the bPlatform system and bScanner apparatus described above. The ticket system may, for example, consist of:

Ticket Portal: An Internet ticket sales web portal is constructed using standard web portal implementation techniques. This portal provides an option for the user to receive a chosen ticket as an SMS short message containing a bToken in the bCode format.

SMS Gateway: The bCode short message is formatted and transmitted to the end-user via an SMS messaging gateway service.

bPlatform Server: An Internet connected server computer is used to host a bContract engine and a bWallet engine. Administrative and bScanner provisioning components are also implemented as part of the server.

bScanners: bScanner devices are located at the entrance of cinemas screening films promoted by the ticket sales portal. These scanners display an “admit” message in response to the presentation of a valid bCode encoded token. Additional bScanners are located at the cinema “candy bars”, where the customer may redeem a bCode voucher.

The bContracts underlying the cinema ticket bTokens, provide bFunctions that enable the consumer to redeem a ticket for cinema entrance, redeem an optional promotional voucher at the cinema candy bar, transfer the bToken to another consumer, rebook the ticket for another time, to obtain a short description of the film being screened and the screening times and to receive an alert at a set time prior to the screening of a film.

The deployed bScanners provide the tools for the cinema or film distributor to associate individual audio (ScanTones) and visual media (ScAnimations) to be rendered on the bScanner or other suitable device as the consumer presents her bToken. Some of these media associations are more rare than others, providing the holder of a “rare” ticket an additional incentive.

Additional embodiments of movie ticket redemption are provided in FIG. 40. (FIGS. 41 and 33 provide examples of a mass transit system and a derivatives market system).

For example, in FIG. 42, a retailer may publish several offers based on one or more bTemplates. The offers may be used to create bCode coupons that are introduced into a bMarket for creation of bContracts. Potential customers may then be identified by any of a variety of means including, but not limited to, bIntermediaries. The terms of the bContract may be negotiated and the modified bContracts may then be distributed to a plurality of users. As illustrated in FIG. 42, the user may then visit a casino, for example, to redeem the bCode contained within the bContract. Although FIG. 42 illustrates that the user arrives at the casino after receiving the bCode, in embodiments the bCode may be distributed to user within the casino. Further, in certain embodiments, the bCodes may be distributed to users based on a triggering event, such as by registering for a poker table. The bCodes may be redeemed, cancelled, traded, combined, divided, etc. as described in other embodiments. Additionally, the bCodes may be stored in a bWallet. In some embodiments, demographic information may be used to provide users with specially tailored bCodes. In some embodiments, the user may be entitled to further bCodes based on any number of different events. These bCodes, in certain embodiments, may be saved for use during future visits.

Additionally, in this and other embodiments of the present invention, a mobile device may use text messaging to make request for information or for a bToken for goods and services. The same method may also enable the service provider to accurately interpret what the mobile user meant with the request.

Text messaging based services are prevalent in global markets. Such a service may enable mobile users to order ring-tones, check bank balances, book air-tickets, receive movie session times and use plenty of other services. However most services use the “Keyword” method for requesting and interpreting transaction requests. The keyword method requires the user to remember some sort of pre-defined keywords, in a pre-defined arbitrary syntax. The time it requires to input the information is short, but the onus of having to remember different keywords and different syntaxes across the broad range of services is ineffective, and stifling the growth of these services.

Accordingly, text messaging (e.g., SMS messaging) that utilizes a customized subset of natural language inputs that can be made common across different services, and at the same time intuitive enough for mobile users not to have to remember specific syntax, and easy enough to be input via the mobile phone, may be provided. Such a method actually allows the mobile user to type in more keystrokes corresponding to more parameters than the commonly-used Keyword method, in return for intuitiveness and ease of use.

In certain embodiments, the messaging method may include a method of using a customized subset of natural language input for requesting and interpreting transaction requests via mobile text messaging which allows users, among other things, to: use domain-specific information that is tied to a destination address number (e.g., 1999-FILM for movies) to create an overlapped area between possible meanings and possible outcomes, and use this area to limit the domain information to a minimum and restrict the Agent in Active Voice to be I (the mobile user), and the purpose of the message to be either a WH-Question or a Verb or Action. So the typical syntax becomes: <WH-Question or Verb><Domain-Specific Data Words><Stop Words><Domain-Specific Data Words><Stop Words>, etc.

The service provider can easily advertise and instruct the users of this common and intuitive format. For example: in the request “When is Bad Santa showing at Fox Studios tomorrow?”, “When” is the WH-Question, “Bad Santa”, “Fox Studio” and “Tomorrow” are Domain-Specific Data Words that the method will recognize, and “Is” and “At” are Stop-Words that the method may be configured to ignore.

One difference between this method and a general NLP (Natural Language Processing) is that this does not need to understand the meaning or semantics of the sentence. It is using NLP syntax as an easy way for mobile users to remember how to request a bToken. The interpretation aspect of this method is actually using a “Recursive Best-Match” matching algorithm to predict the intended meaning.

Specifically, the method first finds the action word, which is either a WH-Question or Verb. This is almost always in the beginning of the sentence, with the exception that certain stop words might stand in the way and need to be eliminated, e.g. “I like to”

With regards to “Recursive Best-Match”, specifically, best-match uses different matching algorithms to match domain-specific lexicon words to the Domain-Specific Data Words in the sentence, including Exact, SoundEx (and SoundEx variants), Mobile Phone Keypad Mapping, and Starts-Of, Contains and Contained-In varieties of Partial Matching.” At each input there might be matches to multiple Domain-Specific Data Words, which are recursively evaluated within the invention to get the set of possible matches to the input. The method may prescribe a specific preference order to the possible matches to determine the best match (e.g., use this order “Exact, 2-way Part of Word, SoundEx, Phone Keypad Mapping). The method may also use relationship between the Domain-Specific Data Words to further determine the best match (e.g., “Syd” and “Mel” will probably indicate that “Mel” is Melbourne and not Melon, in certain contexts).

The method may further be configured to avoid having to use complex NLP techniques such as Stemming, Statistical Parsing, Tagging, etc. since the method described herein uses keyword-matching techniques to natural language input to deliver a transaction request medium via mobile text messaging, and the method may also avoid dealing with complex natural language elements, including but not limited to Abstract nouns, Adjectives, Adverbs, Pronouns, Auxiliary Verbs, Conjunctions, Disambiguation, Grammar, etc, all because of Domain-restriction and Keyword-Matching.

Further examples of requests may include, but are obviously not limited to, “Check my savings accounts balance”, “Fly from Syd to Mel on 3Sep to 6Sep”, “When is JQ123 arriving”, “Where can I see Bad Santa”, “Order super supreme meal with Pepsi and 4 chicken wings”, “Book Bad Santa at Fox today at 2:30 for two”,

According to additional features of this methods, a matching method Exact, where words containing the same sequence letters are matched, ignore casing and punctuation, may be implemented or a matching method, “2-Way Part of Word”, where word contain a combination of three varieties of Partial Matching may also be implemented. Examples of such features may include, but are not limited to:

(Input) Start-Of (domain-word), e.g. “Hell” Start-Of “Bellboy”=match

(Input) Contains (domain-word), e.g. “BadSanta” Contains “Bad”=match

(Input) Part-Of (domain-word), e.g. “boy” Part-Of “Hellboy”

This may also give weight to the length of the partial match (e.g., The match “Hellboy” Starts-With “H” is not a strong match). Additionally, this matching method may be configured to catch concatenation errors (when words that should be concatenated are not, and words that should not be concatenated are)

In certain embodiments, a matching method, “Soundex” that uses the commonly known SoundEx matching algorithm as a component of the overall matching method may be utilized. Additionally, in certain embodiments, a matching method, “Phone Keyword Matching”, which maps alphabets into the numeric equivalents on the dialing pad of phones may be utilized, so, for example,

QZ maps to 1;

ABC maps to 2;

DEF maps to 3;

GHI maps to 4;

JKL maps to 5;

MNO maps to 6;

PRS maps to 7;

TUV maps to 8; and

WXY maps to 9.

Accordingly, Bad Santa would map to 22372682. If the mobile user accidentally typed “Baf Santa”, which is a common mistake for phone-typing when the Predictive Text is Off (d became an f because of the same key), or “Ace Santa” which is a common mistake for phone-typing when the Predictive Text is On, both “Baf Santa” and “Ace Santa” still map to 22372682, which will return a match.

In additional embodiments, a matching method that uses a pre-defined domain-specific logical lexicon to return a match, e.g., “Moore Park” as a suburb, “2032” as a postcode will both match to “Fox Studios” as the name of the cinema.

Additionally, in certain embodiments, a method of defining properties for items in a lexicon to enhance matching and parsing performance may be provides so that, for example, the following features could also be provided:

(1) Stop-Word part of Domain data—in the case where a Stop-Word is also a Domain-Specific Data Word, then it is matched recursively to both options, and the best match is then chosen; (2) Restricted Matching Method. “LAX”—Only return a match with the “Exact” method, and not the other 3 matching methods; (3) Matching Priority so that “Tomorrow” in “The Day After Tomorrow” is of a higher priority than “Tomorrow” as a date; and (4) Default Meaning such that these are the words that are assumed if it was not found across a concept, e.g., “Today” is assumed for movie session times if not given, “1” is assumed for number of passengers for a booking if not supplied, etc.

A method of expanding the Domain-Specific Data Words may also be provided to cover a wider area than only those where the service provides data such as:

If a match was previously valid, and is not longer valid, i.e., the status has changed over time, rather than returning an invalid match, return with user-friendly information, e.g., “Sorry that movie is no longer showing at this cinema”;

If a match has valid individual Domain-Specific Data Words, but does not have an overall match, return with user-friendly information, e.g., “Sorry there is no direct flight from Sydney to Brisbane”; or

If a match requires additional information to complete a match, and contain partial matching, return with user-friendly information, e.g., “Can you confirm the quantity of chicken wings you require?”

Additional features of this SMS (or more generally text) messaging should be apparent to a person of ordinary skill in the art and it should also be obvious that this feature could be used in other areas outside of the present invention or in other aspects of the present invention.

In another embodiment, a method of profiling and associating data using keyword indices may be provided. In certain embodiments, the method may be provided between people who would like to meet, transact or just socialize. For example, profile description of one market participant in words (e.g., “30 year old accounting professional. Enjoys kayaking and skiing”); profile description of a member's desired connection in words (e.g., “Seeking new role in Commercial Accounting”); record of communication with proposed connections with counterparties such as an employer or a friend, including its responses to initial bContract negotiation phase, and participant to participant direct communication such as email or instant messaging; record of communication, bContract negotiations, in-progress and complete transactions with all participants of the bMarket; all other types of content that the bMarket has access to about its participants, whether they are through interaction within bMarket human and machine user interfaces, or external (Blogs, Ebay, other electronic markets, or any other publicly available information source); and gathering feedback periodically about how good the bMarket matched market participants to each other, about how bContracts and relationships between market participants evolved, for the purposes of optimizing it's performance.

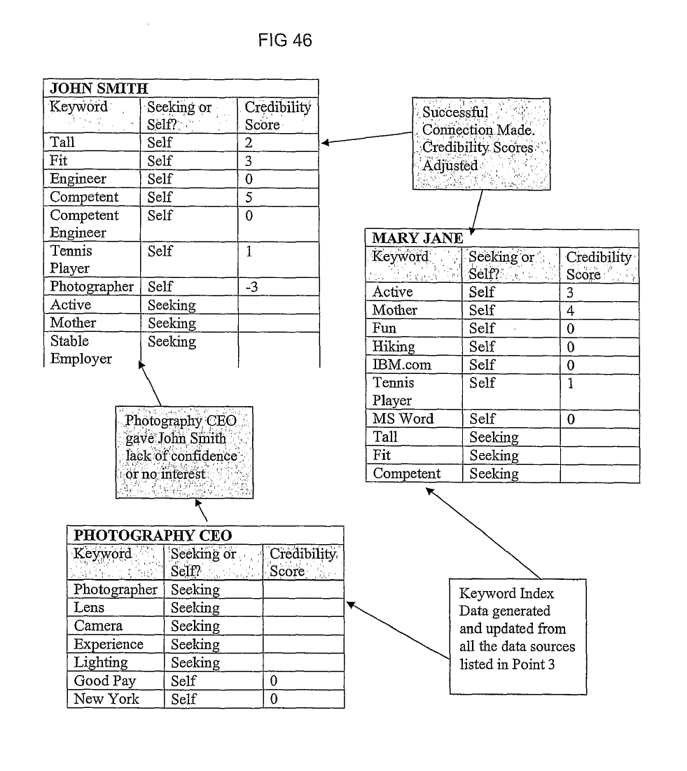

In embodiments, the method may then index all of the text content pertinent to complete or incomplete bContracts, and create a dictionary of important words and terms that belong to the particular bMarket participant or bIntermediary. The method may be a unique method that profiles any information such as people, contracts, parties in contracts, buyers & sellers, products & services and transactions by keywords. See, for example, FIG. 46 (The “SELF” or “SEEKING” tag in this Figure provides a mechanism for a bMarket participant to specify whether it is looking for a bContract counterparty, or is it looking for other similar parties to itself to form a buyer or seller group). The method may also index double words, triple words and mini phrases. For example, “provides horse riding venue” or “3 years experience in UNIX” are far more meaningful mapped as grouped words rather than individual. The method may also allow for a bMarket user to use drop-down boxes or check-boxes to pre-select content via a user interface such as the web, to enter structured content. For example, the user can checkbox a series of product attributes, or service descriptions, and the bMarket's UI could automatically convert them into words and insert them into the bContract marked-up offers as words and keywords This profiling of bContract offers and bMarket participants using an associative keyword dictionary may enable the bMarket to search, match, categorize and analyse the data, and their relevance, association, relationship and suitability for matching with other data.

A method of assessing the potential suitability of proposed connections between items in the bMarket (item being parties, products, services, bContracts & bOffers, etc.), and to analyze the results and continually improve the connection proposal and matching process, using a unique rating system for the keyword-index dictionaries of bContracts and bMarket participants including bIntermediaries may be provided. This will allow the bMarket itself, as well as participants and bIntermediaries to propose connections between parties for trade within the bMarket. For example, in the context of bMarket participants seeking to trade, keyword matching may be done by matching a participant's required match keywords in its dictionary, whether it'd be a “desired connection” or just keyword about itself, with the potentially suitable proposed connection. For example:

Participant A may have keywords AAA, BBB, CCC, EEE, FFF

Participant B may have keywords AAA, MMM, NNN, QQQ, RRR

Participant C may have keywords BBB, CCC, EEE, QQQ, ZZZ

Then a Participant A-Participant C match would return a higher “affinity” score between them, and that connection would rank ahead of Participant A-Participant B and Participant B-Participant C. Additionally, more intelligent algorithms are detailed below.

The simplistic model above assumes that the keywords supplied by the participant itself, whether through their advertised information, or through their proposed bContract offers, are genuine and deemed correct and useful by other participants. However, verification of content by the rest of the bMarket may introduce a scoring system for those keywords to measure credibility of a bMarket participant. The content may be verified market wide to reduce the chance of the bMarket or bIntermediary making bad matches because of statistical fluctuations in small sample sets. In the above example, if after Participant-A and Participant C interacted, it turns out that the proposed connection was successful, i.e. a completed bContract transaction has taken place, then the following may happen to the keywords:

For Participant A, Keyword BBB, CCC and EEE, which are the overlap keywords used to determine the proposed connection, might receive positive scoring.

For Participant B, Keyword BBB, CCC and EEE might also receive the same positive scoring.

If, however, the connection was only deemed successful by Participant A, then only Participant B might be receiving the scoring, and vice versa.

The score could, in certain embodiments, be further qualified by the extent of endorsement from the approving party. For instance, it could be divided into:

“Yes, I would like to trade with Participant B” and

“Yes, I will endorse Person B for its trading credibility” This can, in certain embodiments, create different score levels for fine-tuning of the scoring system. For example, applying mass feedback to participant-specific keywords, which might be used by Internet search engines for websites, e.g. Google Page-Rank, and Internet Social Networks, e.g. LinkedIn Endorsements, as a way to use the general population to perform a level of due diligence on the credibility of the advertised content about a participant and its trading records within the bMarket or otherwise, might allow that feedback to become useful in identifying the most relevant matches for users. Additionally, the mass-feedback process may be applied to keywords that belong to individual people, to validate those keywords about the individual, in a background process that is not known to the participants, and then used to create adaptive intelligent by the bMarket to perform progressively better matching, all in the background.

In embodiments, the algorithm may use the amount of endorsed keywords as a sign of credible context-specific content about persons. A person might profess to be tall, a successful entrepreneur and a supplier of accurate stock predictions. But if he's actually short, knows nothing about stocks but a successful entrepreneur in medical science, then the method, with the help of other members, will find that out using the algorithm. This algorithm, when applied generically, may seek and extract credible information about bMarket participants rapidly and precisely, and then use that information in a context-specific manner to propose the most appropriate connections between participants for bMarket trading. In certain embodiments, the keyword dictionary may be formed from a variety of data sources about the persons and is therefore extremely powerful. From the participant's personal information, to trading history, to trading credibility, to access to other participants and bIntermediaries, to knowledge, to professional history, to political opinion, to hobbies, technology skills, product knowledge, etc.

Additionally, the method leaves open the ability for human and organizational users, in addition to just the bMarket matching engine itself, to perform searches for participants, intermediaries and bContract offers using this data, even though those features may never be implemented commercially for privacy reasons. This precise catalogue of people, and intimate information about these people, may be best inaccessible by external entities to the bMarket.

Additional Scoring Considerations may also be provided in certain embodiments. Additional scoring considerations may include, but are not limited to:

(1) Negative scoring (devaluing Keywords based on unsuccessful matches).

(2) Inter Keyword Linkages (Consider Participant A's keywords of “Panoramic Views, High Class Restaurant, Exclusive Bar”. If High Class Restaurant receives a match, then create Inter Keyword Linkage records between High Class Restaurant and Panoramic Views and High Class Restaurant and Exclusive Bar, even though there is no direct match. When the adaptive engine apply regressive analysis on those, it may find that certain Inter-Keyword Linkages will contribute to greater connection success, i.e. “Exclusive Bar” and “High Class Restaurant” will return a “weak” match, creating a successful match between two otherwise no-match persons. However, since this is applied generically, this could lead to the bMarket making propositions that tall people might be better at business, etc, when it may be statistically spurious. This means that, in certain embodiments, this scoring consideration should only be considered once a large sample size is obtained or periodically reviewed by a human or artificially intelligent expert.

(3) Different endorsement levels, as explained earlier

(4) Frequency of word

(5) Where is the word found? (Apply different ratings to Completed bContracts, Peer credibility feedback, Advertised Profile, Web Blog, Email Messages, etc)

(6) Any other matching criteria that the bMarket will discover from continual data mining of the bPlatform database and adaptive reasoning that is statistically significant

Additionally, in certain embodiments, mandatory and negative keywords may be provided. Within the criteria definition process by each member, i.e. what they are seeking, they may be allowed to specify Mandatory Keyword criteria, i.e. keywords that must be present in the target within a specific context, e.g. for provision of a therapeutic massage service, the provider must live in Sydney, Australia, or negative keyword, e.g. smoker is not acceptable under any circumstance. These criteria may, in certain embodiments, be best selected as pull-down menu items as the system can control the format of the precise text so not to have confusion, for instance: “Been to Australia” and “Live in Australia” cannot be mixed up with a separation of keywords. So the bMarket can use [Live In Australia] as a delimited keyword for residence; Non-Smoker might also return “Smoker” so in this case, space delimiters before and after Smoker are required to correctly match these; and the multi-word indices will also assist in eliminating these logical problems within the algorithm

Overall affinity score and matching process may also be provided in certain embodiments. For example, using the matching basis above, there is a total of (n)*(n−1) potential connections recommendations by the bMarket from a period-to-period basis where (n) is the total number of participants in the bMarket. In this case, the Engine may use the information from each participant about how many maximum proposed connections it likes to receive on a period-to-period basis, then derive the highest affinity-scored pairs for each member, where the affinity score is the highest keyword overlap between 2 persons, adjusted by the credibility score. Then the engine may propose connections and bContract offer negotiations between participants, and then allow the negotiations to progress from there, and then after a time period, collect feedback from the members, and then file and analyse the information, to apply this adaptive intelligence repeatedly.

Another feature, the may be present in certain embodiments, is the second-degree and third-degree affinity. In this process proposed connections between a participant, say Participant A, with other participants that have high affinity scores with people that are one, two, or more degrees away from Participant A via existing proposed connections may be created, e.g., Participant A is connected to Participant B and Participant C. Participant C is connected to Participant D. So second-degree Affinity means that Participant A will be proposed to connect with High-Affinity prospects for Participant B and Participant C, and third-degree Affinity means that Participant A will be proposed to connect with High-Affinity prospects for Participant D. This method is a commonly used method in social networking sites such as LinkedIn. In this present invention, this method is used to make proposed connections to allow them to perform trade and create complete bContracts between them.

Second-degree Affinity may be useful for Like-Attract aggregation (Buyer and seller groups). So if Participant A works at the Docks, and Participant B also work at the Docks, then second-degree affinity makes sense because they are “Likes” and should be linked to more “Likes” to create a union of Dock Workers to negotiate better trades for themselves against shipping companies.

Third-degree Affinity is useful for Opposite-Attract aggregation (Male-Female Dating, Entrepreneur and Venture Funds, Jobs and Seekers, etc). So if Male A is linked to Female B, who is in turned linked to Male C, then Male A being linked to Females with high Affinity with Male C may make sense. Likewise with Entrepreneur and Venture Funds, Jobs and Seekers, etc. Second-degree Affinity and Third-degree Affinity commonly take place in real-life social networking such as networking functions. The present invention performs these electronically and in real-time, and additionally provide an environment for actual trading and execution of bContracts.

Although this example is used for connection between humans in a social situations, this word-based affinity information and determination method can be used to determine the associative relationship between items of the bMarket for the benefit of the machine or human user performing the searching, browsing or subscription of bContract offer data in the market or in any other part of the present invention individually or in combination with other features.

Retail Voucher System

A retail voucher system may be a component of the above cinema ticket system. The retail voucher system may also be deployed as a stand-alone system providing retail voucher token issuing, redemption and associated services for retail merchants.

The retail voucher system may employ a bScanner with an optional second screen facing service staff to provide a list of voucher scans to be fulfilled. The retail staff members may be issued with bTokens encoded as a bCodes for administrative operations, such as positive/negative acknowledgement of a voucher fulfillment, and to indicate availability/unavailability of items being offered. The staff bCodes may be printed on laminated cards.

Game System

Computer games played by consumers on personal computers, video game consoles, portable game consoles and cellular phones are a popular form of entertainment. Vendors of computer games wish to provide incentives for consumers to buy the games and pay online game subscriptions. Vendors of consumer products and services often promote their products, service and brand by paying for advertising placements within consumer media, such as computer games.

In certain embodiments, a bCode game system may provide a reward to the game player, and at the same time the opportunity for a consumer-products company to promote a product and brand.

FIG. 33A shows the game system as implemented for an electronic game console that does not provide network communications. In this case the software embedded in the console or supplied on other media renders a visual or audio encoding of a bToken. With reference to the numerals shown in FIG. 33A: 1 represents that a consumer plays a game on a game console; 2 represents that a bCode and description of the prize that may be redeemed by using the bCode token that is displayed during game play which may be designed as a reward for achieving a game play goal or other prize point; 3 represents that subsequently the consumer can recall the image of the bCode on the game console screen for redemption; 4 represents that the consumer orients the screen for scanning by a bScanner embedded as part of a vending machine; and 5 represents that the vending machine dispenses a prize, such as a soft drink for example.

FIG. 33B displays the game system as implemented for a network connected game console or cellular phone game. With reference to the numbering shown in FIG. 33B: 1 represents that during online game-play the player reaches a prize point in the game; 2 represents that the online game server notifies a bPlatform server that a bToken is to be issued to the player; 3 represents that the player receives the bToken on a nominated device, which may be the game console, cellular phone or other bClient device; 4 represents that the player presents the bToken to a bScanner vending machine; and 5 represents that the vending machine dispenses a prize.

The game system embodiment can be readily generalized to issue prizes, vouchers or other bTokens in the course of other activities, such as Internet web browsing, orienteering or other sports activity, location based services offered on cellular handsets and so on.

bMarket System

Tickets, vouchers, keys and other bTokens may be transferred and traded by providing the appropriate functionality as part of the underlying bContracts. A transfer may duplicate a bToken or revoke an existing bToken and issue a fresh bToken to the new owner.

Often transfer of ownership events may require approval or acknowledgement by multiple parties. bTokens that provide an acknowledge bFunction may be employed for such purposes.

Typically bContracts with appreciable value will implement a “valuation” bFunction, which returns a monetary value from the point of view of the party holding the requesting bToken. In the embodiments of a contractual promise, the value returned for the beneficiary may be positive, whereas the value for the promisor may be negative. An entire bWallet or collection of bWallets may be valued by aggregating the valuations of all constituent bTokens.

In addition to the above object-level trading functionality, more powerful electronic trading services can be constructed using the meta-bContract technology described above. Meta-contracts enable trading in sell-side and buy-side offers, composite contracts and other derivatives. As examples of buy-side offers and derivatives: Tender for services on given terms (e.g. I want a $7 movie ticket for 7 pm); Tender for services with variable terms (e.g., I want movie tickets); Derivatives, including futures, options, short, forward, cap, ratchets and so on; Title to property and assets; Title to intellectual property; Agency/power of attorney; and voting.

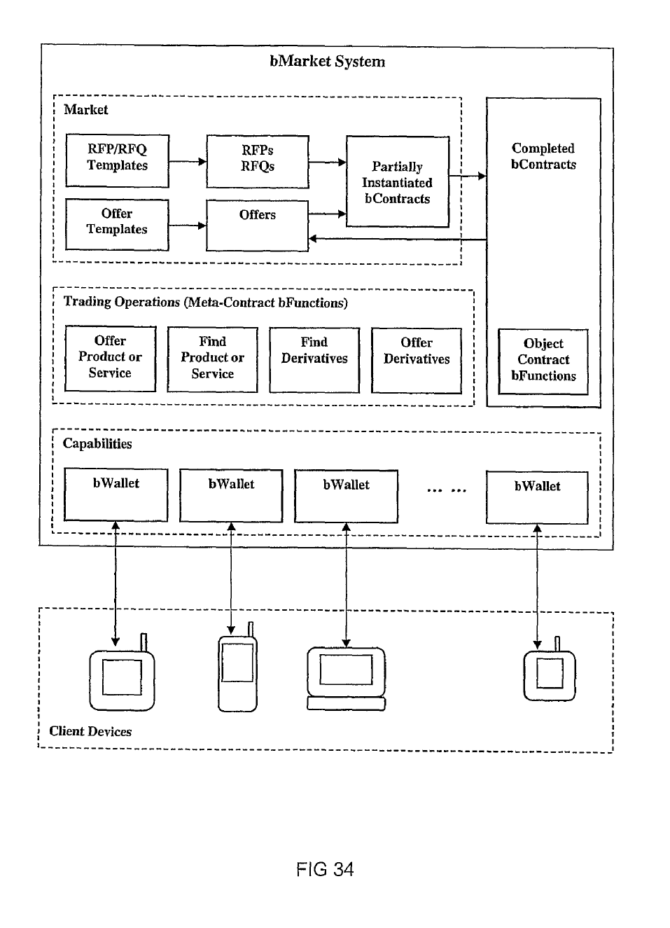

Another bMarket embodiment architecture is shown in FIG. 34. As indicated in the figure, the relationship between a customer (trader) and the bMarket operator is best represented as a meta-bContract that provides bFunctions that manipulate the object-bContracts being traded. Exemplary trading operations are shown in this figure.

The object-bContracts follow a lifecycle, starting as bContract templates, which are instantiated by meta-bFunctions to become offers. Offers are converted into completed bContracts by way of “accept” meta-level bFunctions. Optionally additional functions that implement other aspects of deal negotiation may be implemented. Optionally completed transferable contracts may be converted back into offers individually or as bundled offers.

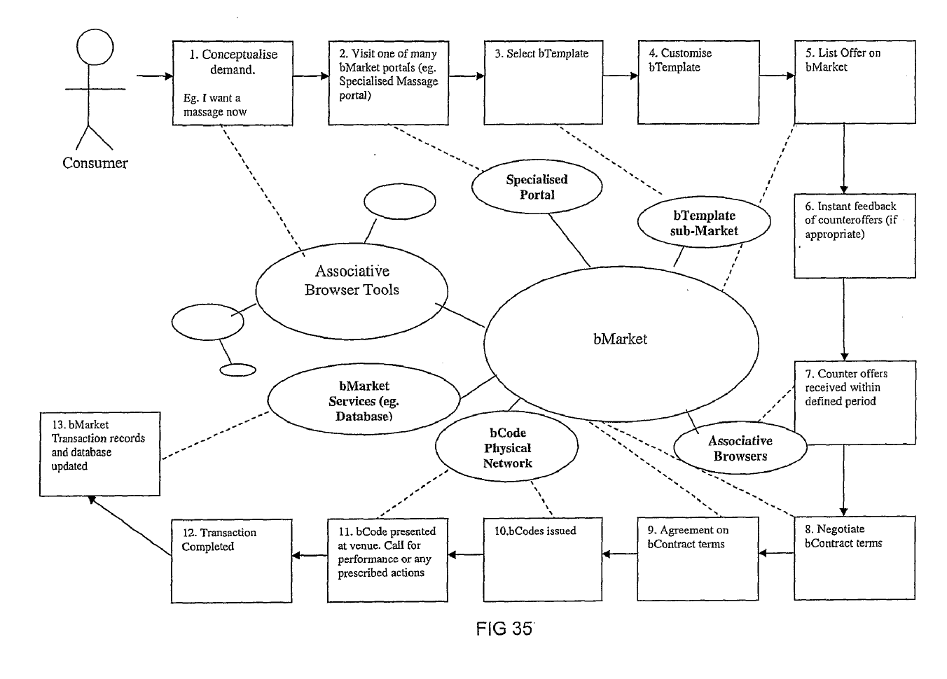

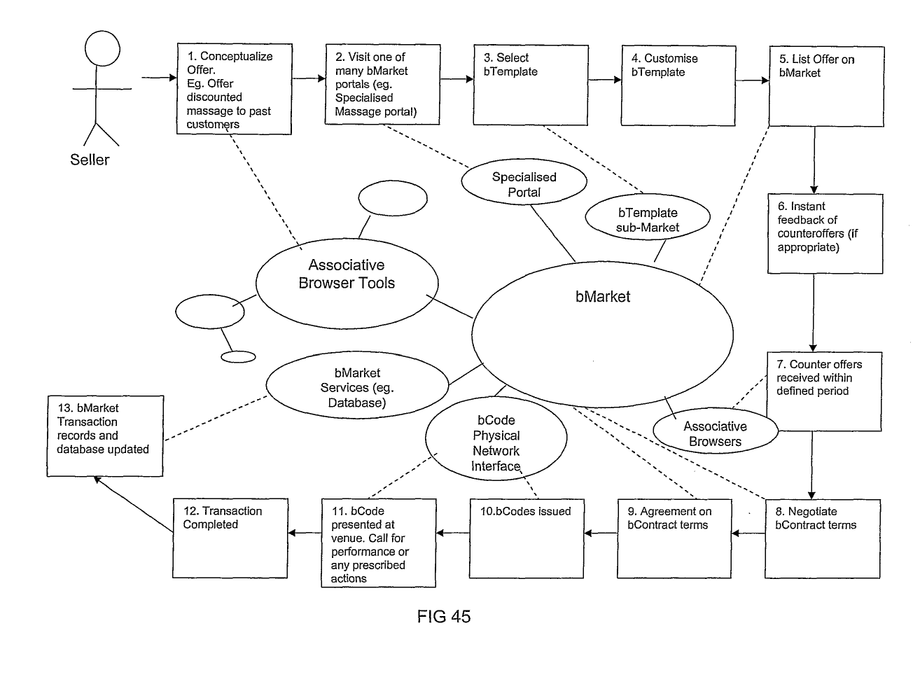

The bMarket is a new way of constructing an electronic marketplace that is superior to existing electronic markets in terms of reach, speed, breadth of products and services, mobility and efficiency. FIG. 35 illustrates the bMarket platform discussed above from a consumer point of view and FIG. 45 illustrates the same bMarket platform from a seller's point of view.

As discussed above, the present invention relates to a new platform for hyper-efficient digital/electronic commerce, utilizing real-time capabilities afforded by mobile portable devices. The invention deals with a number of novel and innovative components, that separately and in combination, enables a novel real-time mobile commerce platform based on transmission of bit data across enabling devices and machines. Details of each of these components was provided above and is summarized below.

The bDataFormat is a collection of standard data formats for the transmission of bit data to enable real-time digital trade across a diverse number of devices and machines (e.g., bDevices and bMachines). bDataFormat may be a superset of independent data formats including, but not limited to: i) bCode data format ii) Normal numeric representation, with or without checksums and redundancy iii) 1-dimensional barcodes, 2-dimensional barcodes, and 3-dimensional barcodes, including holographic and 3-D graphical, numeric or textual representations iv) RFID identification numbers v) other hardware-based identification numbers for radio frequency transmissions (Bluetooth) and vi) waveform representation (Audio, Magnetic, Infrared or any representation using the Electromagnetic wave spectrum).

Backwards and Forwards compatibility of the bDataFormat for the existence of a collection of data formats may enable real-time translation between those formats for integration into legacy and future infrastructure that do not support one or more of the formats listed e.g., existing point-of-sale scanners may recognize 1-dimensional barcodes only, and the existence of this bDataFormat class, will enable the same bToken to be successfully recognized for function invocation.

In another example, a mobile device that supports RFID transmission may receive a bToken in bCode data format. Upon recognition of the bCode and the RFID capability, the device may then issue a pull request to a central server, after receipt of the bCode bToken may push to acquire additional metadata for an RED presentation of the bToken to an RFID-enabled scanner. The bDataFormat collection also enables this type of translation to take place to ensure backwards and forwards compatibility.

In a further example, a user with a bToken that is in bCode or numeric representation may want to present a bToken to a remote merchant that do not have any fixed line or mobile internet capability. The user then simply reads the bToken over the phone to the merchant, and the merchant will manually type in or handwrite the information into its own system. In this instance, the bDataFormat class allows translation into audio waveform presentation for successful invocation.

In-line code recognition allows certain text-based formats such as bCode and numeric presentation to be incorporated in-line in paragraph text. For example, “Do you consent to the transfer of =AMMKJ=MKL2P=to Mr. Joe Smith?” or “Your ticket number is 01293090”. The nature of these bDataFormat sub-classes allow for recognition and invocation of the bTokens even within paragraph text, when optically scanned or when read by humans, using pattern and text recognition techniques.

In-pattern code recognition allows certain graphical-based formats such as 1-D, 2-D and 3-D barcodes to be incorporated into other graphical elements such as pictures, art and photos, and can still be recognized as a bToken electronically using various pattern recognition techniques.

In-waveform code recognition allows certain waveform-based formats such as audio and electromagnetic, to be incorporated into a larger waveform such as human speech and radio broadcast, and can still be recognized as a bToken electronically using pattern recognition techniques.

The bCode, discussed above is a particular bDataFormat that resolves interoperability issues between the 2 billion, and growing, existing mobile devices in the market.

As covered above, the bCode is a character-based data format that uses the particular patterns of a string of alphanumeric characters, in English or other languages, to represent bit-based data.

The bCode is a unique format that is easily transmitted across analog and digital channels, using translation or native form: It can be optically scanned from the screen of a displaying device with high reliability and data redundancy (e.g. Mobile phone, Game console, Notebook computer) and can also be digitally scanned using radio frequencies such as RFID, Bluetooth and Infrared. The bCode can be read by a human, and spoken to another over voice. It can also be ready by a human, and typed into a keypad. This feature overcomes the limitations of graphical barcodes. The bCode format enables reliable and efficiency optical scanning, by using features of text-based characters to allow an optical scanning device to recognize the code, its orientation, and isolation from its surroundings, using one or more of the following techniques: i) optical character recognition (OCR). Use OCR techniques to identify the symbols displayed, and once they are identified, translate the symbols to their underlying bit value. These can be any symbols that are displayed on the devices, or pattern of symbols or dots that can be recognized for data encoding purposes; ii) marker characters (e.g., Using an equal “=” sign to mark various parts of the bCode; iii) directional patterns (e.g., Use a directional pattern in any of the axis to recognize orientation and location of the code, such as “B will always precede X in the y-axis”); iv) other geometric methods such as frequency of symbols, symbol groups, line segments, symbol sequences, symbol differentials, constellation symbol maps; and v) directional data encoding (e.g., Use a directional pattern in any of the axis to encode data, such as “The distance between a certain angled strokes in the x-axis is used to encode bit-based data. So characters are chosen on that basis to represent code).

The bCode can use preceding, succeeding or surrounding text to identify rotational orientation of the code. If the bCode contains header text “bCode Ticket”, that additional information can be used to find out the exact direction of the text, or give the scanning apparatus additional information about the underlying bCode, such as seat assignment for a stadium ticket, as a cross-check to the server held content. In addition, if this requirement is built into an algorithm or chipset in the apparatus, it can be used to prevent counterfeit bCode tickets from being issued without the authorized brand that will be attached to the bCode. If “Company X” is a pre-requisite in the decoding algorithm, then it's difficult for a rogue provider to issue their own “Company Rogue” bCodes with “Company Rogue” headers, as they could be prevented from working.

The bCode can use a range of techniques to customize and optimize data encoding techniques for specific channels. For example, certain screen type could mean that some of the techniques in section above, optical recognizability, are more effective than others, and that the exact method parameters can be adjusted (e.g., for screens with large and same-size character layouts, directional patterns might be particularly effective) and certain font size will have characters that resemble each other to more or less extent (e.g. 5 and S), in this case, constellation type symbol mapping where data is encoded in differential between characters, and only certain sequences are logical, will help optimize encoding efficiency for particular channel characteristics (e.g., An “S” cannot possibly in the spot where the 5 was supposed to be).

A bToken enables any type of instrument or contract representation (bContract). A bToken is encoded in a bDataFormat, and is thus presentable and invocable across a diverse number of devices, machines, medium, parties and communication channels. It can be adapted to interoperate with all existing electronic representatives. A bToken is instantiated and then stored at the central authority on the server-side, as well as on the client device side to allow remote invocation. This architecture allows the creation of a universal bToken labeling and numbering system, enabling it to benefit from a diverse number of bServices. A bToken, due to its efficient and compact encoding in bDataFormat, allows itself to be stored on many different types of client devices (e.g., Mobile phones, PDAs, game console, music players, watches). Some of these devices will be smart devices, and will be able to additionally store metadata on the underlying contract (e.g., actual graphical ticket design for a bToken ticket, a photo of a physical good, contract extract for financial or other instruments). With the exception of anonymous bTokens, bToken ownership and authority information may be stored in the central authority, or delegated equivalent, so that upon each invocation, proper authority can be checked to ensure security of transactions.

A bContract, unlike the syntactic and unstructured nature of traditional contracts, enable its content and terms to be labeled, structured, categorized and valued in systematic ways, and allows it to be machine-sorted, processed, interpreted, valued, analyzed and marketed.

Fields of the bContract can be dynamically changed if the terms of the contract allows. Its dynamic nature, unlike static electronic or paper contracts, allow changes to be made in real-time. This is a key characteristic of a bContract that enables it to operate in real-time markets. The bContract contains persistent state of performance and contract statuses—the most current status of each aspect of a bContract is stored as persistent states within the bContract itself. This enables the bContract to be traded in real-time, because there are generally no externalities that will affect its status and value. This feature, combined with the executed program code, further enables bContracts to be self-policing and self-representing. Functions within bContracts can be called upon for execution by presentation of bTokens, instead of the cumbersome process of manual external performances and policing in ordinary contracts. A bToken, which is coded in bDataFormats, can be presented to a bContract through a variety of medium, to invoke functions that the bContract is pre-defined to perform. The bContract generally contains executable program code that can be automatically executed to perform operations in the contract. Traditional contracts require external functions and actions to happen, in order for compliance with the contract. This means that there are non-real-time elements which in turns means that it cannot execute and operate in real-time. bContracts may have the additional capability of having the functions locally defined within the contract, so that the bContract can make a decision to directly and automatically execute those as program code. The program code can be in scripting language or variants, and can be integrated with external systems for performances outside the host system of the bContract Through valuation services, bContracts can be summated to give individual and aggregate book values and market values, therefore easily return net-worth of its controlling entities and parties. The deliverables, when delivered, performed or operated on, such as cancellation and transfer, can give the flow value (profit and loss, change in net-worth) of its controlling entities and parties.

With these attributes, bContracts can deliver functions that paper, or static-electronic counterparts cannot currently deliver within reasonable timeframes. As a result bContracts can help deliver real-time digital trade.

bContracts can optionally contain a resident constitution, which enables it to be self-policing and self-representing. This also enables it to become an independent entity that parties can rely on for the most efficient execution of functions. Generally, bContracts are functionally more broad than what a conventional contract is capable of A bContract is an instrument that prescribes future functional performances, these performances could include physical acts, exchanges, recitals of fact, delivery of services, production and presentation of physical goods, transfer of titles, creation of intellectual property, discovery of information, completion of projection tasks, teaching to actions, etc.

bContracts can be partially or fully completed. Incomplete contracts (some of which fall under the conventional interpretation of “Offers”) are also supported by bContracts. In some cultures (such as Korea), the meaning of “contract” is quite different to the western world, in the sense that any signed or executed contract is still a running document of prescribed future functional performances. This notion blurs the line between Offer, Contract and Performance, as it is essentially a single object at different points in time. bContracts supports all of these states

Existing non-digital and e-commerce markets only allow trading of near-complete or complete contracts, e.g., financial instruments that are traded are typically contracts that have fixed parameters. There is no efficient market for the trade of incomplete contracts. bContracts, on the other hand, can be traded even in incomplete form. bContract due to its marked-up, machine-readable and dynamic format, provide markets with structured information about itself, enabling the market to objectively value it, and allow it to be traded.

bTemplates are types of bContracts that are used as reference designs of bContracts to enable rapid instantiation of bContracts. bTemplates may be manipulated by meta-bContracts. bTemplates may contain one or more of the following types of information: i) terms template, ii) design information, iii) teaching, iv) project and future actions plan, v) methods, vi) system design, vii) apparatus design, viii) schematics, ix) business plan, x) program code, and xi) constitution. bTemplates can be selected from a library, subject to access levels by the user, in order to instantiate bContracts without having to create each of the bContract components from scratch and bTemplates may contain important synthesis data for productivity and economic output by the associated bContract entities.

bTemplates can carry aliases that enables parties to quickly identify the underlying terms and design information. For example, two parties that would like to enter a Non-Disclosure-Agreement (NDA), can ask each other whether they are happy to comply to the “USNDA1008” bTemplate.

bDevices are client devices that contain bTokens that are acting as Transaction Artifacts to invoke bContract operations. Through the innovations from bDataFormats and bCodes, bDevices operate on a single common platform, and in addition provide backwards and forwards compatibility into existing systems to maintain a single interoperable platform for digital trade. This resolves interoperability issue of traditional Transaction Artifacts. Exemplary device include, but are not limited to, cellular phones, PDAs, mobile game consoles, smartcards that have on-board processor and user interface music and multimedia players and notebook and portable computers;

bMachines are machines that act as either an electronic representative and/or a performer of bContract functions. These machines provide user interface and/or execution mechanism and may provide persistent memory to hold part or whole of bContracts. These can be ticket scanner plus turnstiles, point-of-sale terminals, multi-purpose kiosks, networked kitchen appliances, computer servers, etc. These resolve the interoperability problems encountered by traditional electronic representatives by responding to common invocation capabilities such as bTokens.

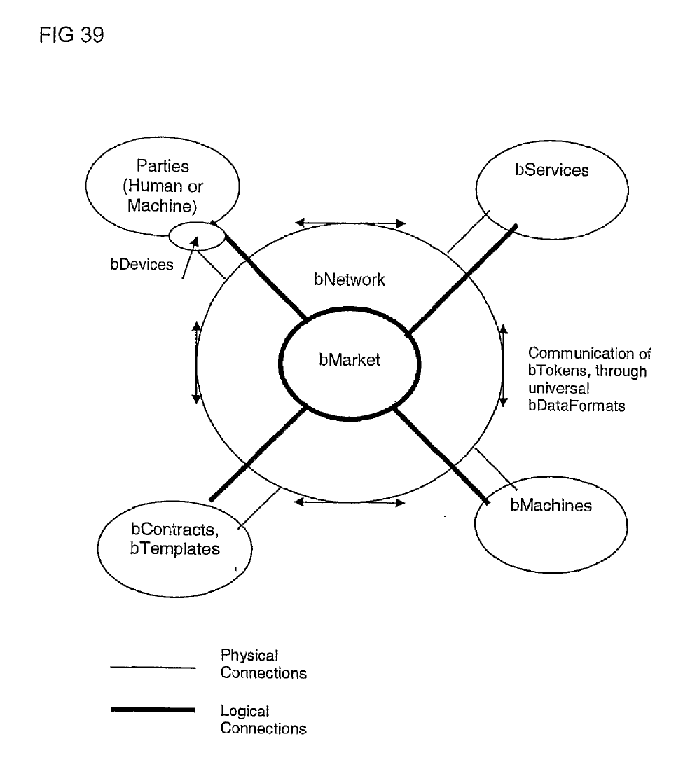

bNetworks are the physical communication networks that are created to enable presentation and communication of bTokens. These are the network backbones that support the existence and operation of bMarkets (see, for example, FIG. 39). bNetworks may be created over one or more networks to enable transmission of bTokens using bDataFormats. Examples of customary network types includes, but is not limited to, i) GSM Network, ii) CDMA Network, iii) GPRS Network, iv) 3G Network, v) WiMax Network, vi) Mobile Broadband Internet, vii) REED frequencies, viii) Infrared Frequencies, ix) Fixed Line Phone Networks, x) Fixed Line Narrowband Internet, and xi) Fixed Line Broadband Internet.

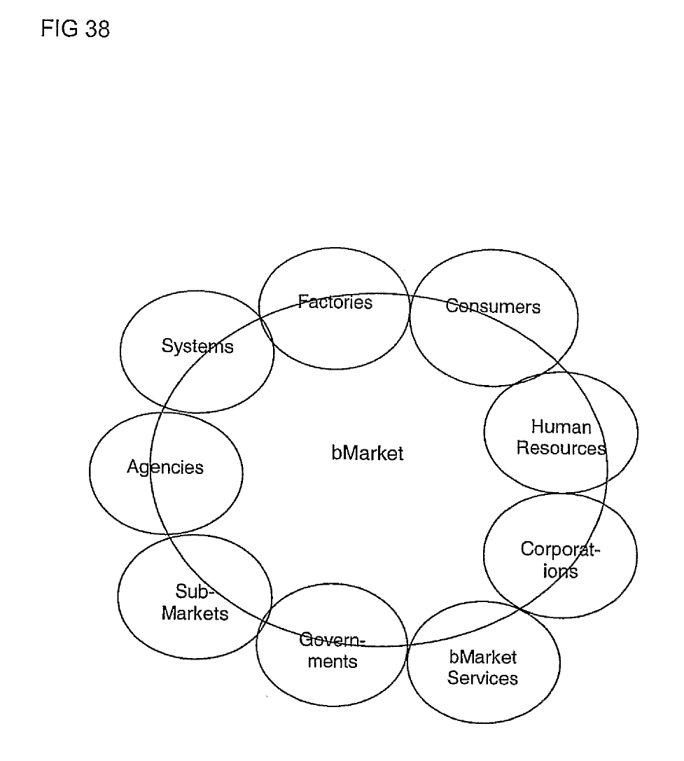

The nature of bContracts allow the creation of bMarkets, which is a digital and dynamic market for trade of all goods and services. The machine-marked up and persistent state nature of bContracts enable real-time complete information access for the status and properties for all goods and services, enabling market mechanisms such as valuation and agencies to function. Traditional non-digital and e-commerce markets lack bContracts, and as a result, the cost and time required for digital trade of any good or service becomes prohibitive. The construction of a bMarket is based on information transparency and real-time access by all participants, including human agents, machine agents, bDevices and bMachines. This resolves traditional time and cost efficiencies, and more importantly, the problems of Reach, Common Protocol and Interoperability and Marketability of economic units. bMarkets allow proprietary entities and systems to open its internal functions and operations into the open market, create a system of hyper-efficiency. Traditional barriers such as factory doors, application programmable interfaces are eliminated. (see, for example, FIG. 38). bMarkets allow trade of bContracts in all stages, whether all the fields are completed or otherwise. This allows any participant (examples in FIG. 16) to access, accept, trade, aggregate, vary, divide any of the bContracts in the bMarket, creating a new level of efficiency, flexibility and diversity in trade.

As an example, a consumer may want to buy a ticket to a specific football game this weekend. This consumer can use bServices such as bSearch or bBrowse to find such a game, and then buy the ticket from the venue directly.

Alternatively, this consumer may want to issue a broader offer, using a bTemplate to create a general offer for sporting entertainment dated this Saturday, that has a mandatory requirement of admission to that match. This way, the consumer will be privy to special promotional bundles, such as Ticket plus Meal, Ticket plus Drink, better seating, or discount non-refundable tickets, and so on. These bContract offers will be released into the market, and market participants may then reply to the offer, attempt to negotiate and solicit, offer alternative bundles or divided goods, value-added services, related services.

Alternatively, the consumer may want to specify alternative terms, such as maximum price, and just the football team. This way, the bContract will be marketed accordingly, and the consumer may receive tickets to that same team at alternative venues.

As another example, an employer may need access to 200 low-skill-level man-hours to clean the garden to a venue before a Xmas event. The employer may issue bContract offers that specific the requires dates and location for the labor.

Alternatively, the employer may issue an aggregated demand, and for another economic agent or market participate to source the right people, and combine them to deliver the bContract requirements.

Alternatively, the employer may draft the bContract so that it has the flexibility to accommodate both permutations above.

An entrepreneur that has conceptualized a novel business plan may want to put that into the bMarket to seek venture capital funding. Once that party of the bContract is completed, the entrepreneur may elect to keep the bContract in the current direction, and continue to source required parties and/or resources and keep the bContract as an ongoing economic entity.

Alternatively, the bContract can be traded with other parties at any point in time. The price of the transfer can be negotiated. Alternatively it can also be externally valued by bValuation services.

Unlike physical markets, bMarkets are not restricted by geographic limitations or aggregations (e.g. a retail shop). Unlike conventional e-commerce markets (e.g. Ebay), bMarkets are not restricted by syntactic groupings.

bContracts with its mark-up data structure, as well as associative meanings (refer to bSearching for more information on associative intelligence) enables participates to simply “drop” a bContract into the bMarket for trade. bMarket mechanisms and services will then pick up the item for trade, and use associative intelligence, matching and listing bServices to find potential counterparties.

bMarketListing is based on a combination of associative and conventional syntactic groupings to allow market participants to trade in real-time, with maximum reach and marketability. It overcomes market inefficiencies that result from natural language descriptions (e.g. Google search for products) and syntactic groupings used in convention e-commerce (e.g. E-Bay) because those language structures do not enable buyer and seller to find each other easily. For example, a buyer that is listing “I want to rent a green mouse” and a seller listing “I want to rent out a green mouse” will not be automatically matched because there are no syntactic relationships between those syntactic sequences in the eyes of the e-commerce markets. bMarket and bMarketListing overcomes this by understanding those associative relationships. (Refer to bSearching for more information).

bServices are enhanced market services that are made possible by the bMarket. These are services offered by market participants such as human users, machine users, human and machine agents, bMachines and a combination of these. These services may include, but are not limited to: i) valuation services (of bContracts), ii) market makers, iii) arbitragers, iv) resellers, v) re-buyers, vi) matchers, vii) participant analysts (e.g. credibility, size, economic capabilities), viii) other analysts, ix) simulators, x) financiers, xi) advertisers and marketers, xii) contract lookup, xiii) policing, xiv) template libraries, xv) escrows, xvi) information traders, xvii) relationship traders, xviii) browsers/search, and xix) accounting services.

These functions exist in traditional commerce. However, bServices contain unique design elements that enable these functions to operate in bMarkets and bCommerce environments. In particular, they all need to be real-time enabled interoperable, be operable in markets with tremendous reach, contain electronic interfaces, and operable with bMarkets and bContracts.

One bServices is a search service that plays a key market-making function for helping bMarket participants find specific products, services, contract offers and instruments. Existing search services are syntactic and keyword only, and are very limited. The bSearch service utilizes marked up fields in bContracts as the data source, which is structured data and not just natural language descriptions. In addition, it has associative intelligence (discussed above) that can create associations between words, allowing the search service to deliver highly useful search results. For example, “LCD Screens” will be associated with “Monitors”, “Samsung”, “OLED” Which means that the search service will take into account these associations when searching through the marked up fields of the bContracts that are published into the bMarket(s).

The search service may derive its associative data from one or more of the following sources: i) Existing electronic literature (e.g., Websites, RSS feeds, IP broadcasts). So words that reside on same pages, same websites, and linked websites are scored accordingly; ii) bMarket transactions. Any exchange in a bMarket will generate associative relationships between words and content of bContracts; and iii) bSearch data. Actual search requests, browsing and selection activities will also generate associative relationships between words and content of bContracts

Using those data sources, bSearch services can then build a database of associated relationships, in terms of how many degrees each word or term or concept or category is associated with another category given the presence of context, with context meaning the presence of other word or term or concept or category in the same communication. For example, a bMarket request of “Find LCD screen components” will retrieve bContracts relating to “LCD Screens” “TFT screens” “12V Power Supply” “Video Adapters”, and not “Monitors” because “LCD screen” is only associated with those words in the presence of the context of “Components”

If a bSearch query contains domain-specific context (e.g., if the query is sent to 1999-FILM) then bSearch can utilize non-traditional-NLP techniques to make relevant matches, as discussed above with respect to requesting a bToken.

The efficiency, execution, and operation of bContracts and bServices in bMarkets is going to generate a large amount of highly structured, detailed and categorizable transaction data. bDataServices utilize the knowledge of the underlying protocols to effectively capture this data into repositories, and, in certain embodiments, make the information available to buyers and users of this information via a human and machine interfaced 0.

A bCommerceSystem is the holistic platform composed of all the bCommerce entities and components to deliver bMarket services. The bNetwork is a physical network that enables bMarket participants, including human users, machine users, bServices, bDevices, bMachines to communicate with each other using a common set of protocols. Through this communication, identities are authenticated, tokens are presented and functions can be invoked and performed, which will enable all types of bMarket services to execute. (see, for example, FIG. 39). In essence, when compared to traditional commerce systems: bNetwork may resolve the problems of reach and Common Protocol and bMarket may resolve the problems of interoperability and marketability. When combined into a bCommerceSystem, they deliver a real-time digital commerce platform that was previously not possible.

Many alterations and modifications of the present invention will be comprehended by a person skilled in the art after having read the foregoing description. It is to be understood that the particular embodiments shown and described by way of illustration are in no way intended to be considered limiting. Therefore, references to details of particular embodiments are not intended to limit the scope of the claims, which in themselves recite only those features regarded as essential to the invention.

The embodiments described herein are intended to be illustrative of this invention. As will be recognized by those of ordinary skill in the art, various modifications and changes can be made to these embodiments and such variations and modifications would remain within the spirit and scope of the invention defined in the appended claims and their equivalents. Additional advantages and modifications will readily occur to those of ordinary skill in the art. Therefore, the invention in its broader aspects is not limited to the specific details and representative embodiments shown and described herein.

What is claimed is:

1. An electronic commerce method comprising:
instantiating an electronic contract; storing the electronic contract on a contract server;
issuing a computer scannable token to one or more contracting parties;
transmitting, electronically, the token and a token message to the one or more contracting parties;
intercepting, by a processor, the message and contacting the server to retrieve all or part of the electronic contract associated with the token; and
downloading or uploading digital media, as referenced or instructed by the electronic contract from a media server,
wherein the computer scannable token is at least partially framed with at least one predefined symbol to make the token more easily scannable.

2. The electronic commerce method of claim 1, further comprising requesting or supplying digital media, such as text, audio, images and video by the user, and uploaded and storing the media on a media server.

3. The electronic commerce method of claim 1, wherein the token is communicated to the party via a cellular short message, instant message, electronic-mail or other communication means.

4. The electronic commerce method of claim 1, further comprising collecting and storing user identification and billing information in an electronic wallet server.

5. The electronic commerce method of claim 1, wherein the communication contracting party periodically contacts the server to discover when new tokens have been issued.

6. The electronic commerce method of claim 1, wherein the token is encoded in the form of a barcode of any symbology.

7. The electronic commerce method of claim 1, wherein the contracting party invokes the token and associated electronic contract operations by operating the user interface of the party's device.

8. The electronic commerce method of claim 1, wherein the party presents the token to a scanner device and in response to a token scan or other operation, the electronic contract instructs the presentation or capture of audio, visual or other media for the user.

9. The electronic commerce method of claim 1, wherein service that may be expressed as electronic contracts include, ticket purchases, promotional vouchers, club memberships, digital media download rights, bets and wagers, as well as any other service that involves contractual and contract-like expression.

10. The electronic commerce method of claim 1, wherein instantiation involves the consumer uploading media, such as audio, images or digital video, that will be associated with the electronic contract service and referred to and rendered or otherwise operated on by the server interpreting the electronic contract.
